(19) United States
(12) Patent Application Publication
(10) Pub. No.: US 2026/0349972 A1
(43) Pub. Date: Nov. 5, 2026

(54) METHOD AND APPARATUS FOR ARCHITECTING AND IMPLEMENTING INDEPENDENT AND DEPENDENT PEER DATASETS

(71) Applicant: Robert Francis Mack, Leola, PA (US)

(72) Inventor: Robert Francis Mack, Leola, PA (US)

(21) Appl. No.: 19/738,021

(22) Filed: Jul. 10, 2026

Related U.S. Application Data
(63) Continuation of application No. 18/889,124, filed on Sep. 18, 2024.
Application No. 18/889,124 is a continuation-in-part of application No. 18/235,964, filed on Aug. 21, 2023, now abandoned.

(51) Int. Cl. G06F 16/21; G06F 16/22; G06F 16/23; G06F 16/28

(52) U.S. Cl. CPC G06F 16/212; G06F 16/2282; G06F 16/2365; G06F 16/288

(57) ABSTRACT

A method, an apparatus, and a system for configuring, and implementing a data architecture schema composed of independent peer datasets along with related multiple dependent peer datasets. Using data architecture modeling methods, multiple peer physical data model diagrams can be produced from a logical entity relationship diagram. In addition, peer data architecture maps can be produced to depict how peer datasets can be joined. These peer physical data model diagrams are joined together by peer key constraints that enforce peer dataset commonality. When the peer physical data model diagrams are dataset instantiated, directly interoperable peer datasets result. Within the datasets instantiated from a data architecture model, the data architecture schema can contain some reusable independent peer datasets, which provide master data content to multiple dependent peer datasets. The dependent peer datasets can use instantiated peer dataset connectors as a method to connect peer datasets while removing master data content redundancy.

### CROSS REFERENCE TO RELATED APPLICATION(S)

The present application is a continuation of, and claims the prior of, U.S. patent application Ser. No. 18/889,124, filed on Sep. 18, 2024, inventor and applicant Robert Francis Mack, which is a continuation in part of, and claims the priority of, U.S. patent application Ser. No. 18/235,964, filed on Aug. 21, 2023, inventor and applicant Robert Francis Mack, such that the present application claims the priority of both U.S. patent application Ser. No. 18/889,124, and U.S. patent application Ser. No. 18/235,964.

### FIELD OF THE INVENTION

This invention relates to new methods and apparatus for architecting, developing, implementing, and maintaining directly interoperable datasets with some dependent datasets that share master data from independent datasets.

### BACKGROUND OF THE INVENTION

In 1976, the concept of entity-relationship diagramming, and data modeling was developed to architect datasets such as databases. When data integration became important in the late 1980s, the datasets configured with prior art data modeling methods became characterized as disparate data silos. As such the data content or information of each disparate dataset was difficult to combine with the data content of any other disparate datasets.

Enterprise data models became popular in the 1990s as a method to architect multiple datasets within a single data model. It was hoped that enterprise data models would architect datasets to be more interoperable and perhaps integrate data distributed across multiple datasets. Enterprise data models were architected and/or configured using established data modeling methods of the time. Enterprise data models usually include logical Entity Relationship Diagrams (logical ERDs) that represent multiple datasets for an organization. The logical ERD became a foundation for structural metadata commonality among the set of multiple datasets represented. In addition to the logical ERD within the enterprise data model, each dataset for the organization was further architected in a Physical Data Model Diagram (PDMD) that was an analog of the enterprise logical ERD.

The data vault form of data modeling was developed around the year 2000. However, data vault modeling and dataset instantiation still resulted in disparate datasets. Data mesh was later developed as another architecture method where disparate datasets exchange data using programmed interfaces.

There are several methods of prior art data integration: transformative data consolidation, and data virtualization for example. Transformative data consolidation methods involve extracting data content from multiple disparate source datasets and transforming and loading that source data content into a target consolidated dataset. This method is also known as Extract, Transform, and Load (ELT). Data virtualization methods attempt to “virtually” combine data content from two or more disparate datasets. However, prior art datasets, as configured, are not architected to support this combining of data content across disparate datasets. These data virtualization methods are a “quick and dirty” approach to dataset integration when compared to transformative data consolidation methods.

Master Data Management (MDM) is another prior-art attempt to integrate data and improve data quality. MDM is an after-the-fact approach to correct the disparity in reference and master data of multiple disparate datasets. In MDM, an MDM dataset is established to collect master data from two or more disparate datasets. Through the MDM process, a single consolidated version of the master data is established. Sometimes the single consolidated version of the master data content is distributed to any requesting dataset. Unfortunately, distributing the consolidated version of the master data content alone does not make disparate datasets directly interoperable.

It was determined that disparate datasets result from conventional data modeling methods. These disparate datasets are often characterized as data silos since disparate datasets are not data integrated and are not directly interoperable. Disparate datasets lack the peer identifying metadata commonality and the peer dataset content commonality required to form collaborative peer datasets.

Introduced in the 2010s, common data entities and common entity relationships were developed to allow logical ERDs to be combined and consolidated. In this case, each logical ERD produces a single dataset. The addition of common data entities and common entity relationships convert multiple disparate logical ERDs into integrated logical ERDs. Integrated logical ERDs can be consolidated to form a single integrated logical ERD or distributed to form federated logical ERDs. When integrated logical ERDs are dataset instantiated, these integrated logical ERDs form entire integrated datasets. Through working with these entire integrated datasets, it was discovered that further additions were needed to accommodate more types of datasets and more agile dataset configurations and implementations.

U.S. Pat. No. 10,417,263 B2 (hereinafter '263 patent) to Robert Mack, deals with manipulating multiple logical ERDs. More specifically the '263 patent, which is incorporated by reference herein, deals with linking multiple logical ERDs using common entity relationships and then federation and consolidation of logical ERDs. For example, the '263 patent refers to consolidated logical ERDs at col. 10, lines 14-43 of the '263 patent; federated logical ERDs at col. 10, lines 5-13 of the '263 patent; and common entity relationships at col. 5 Lines 34-47 of the '263 patent, and these portions of the '263 patent are all incorporated by reference herein.

US Reissue Patent RE48,312 (hereinafter '312 reissue patent) to Robert Mack, deals with relationships between logical ERDs, and the '312 reissue patent is incorporated by reference herein. The '312 reissue patent deals with common entity relationships and refers to a logical data model object used to relate across logical ERDs at col. 4, lines 5-10 of the '312 reissue patent, and this portion of the '312 reissue patent is incorporated herein.

### SUMMARY OF THE INVENTION

One or more embodiments of the present invention include a method of architecting and/or configuring a group of peer datasets that have direct dataset interoperability, where data from any peer dataset may be directly and dynamically combined with data from any other peer dataset. The methods used to architect and/or configure a group of datasets having direct dataset interoperability are based on new enhanced data modeling methods referred to as data architecture modeling.

To support the formation of directly interoperable datasets, prior art data modeling methods are enhanced by adding the ability to implement and enforce peer dataset content commonality among datasets. It is the inventor's belief that the expression “peer dataset content commonality” has not been used in the prior art, and that expression is defined in the present application. Peer dataset content commonality combined with peer identifying metadata commonality among peer datasets provides direct dataset interoperability.

A computer processor may be programmed by computer software programs stored in computer memory to define PDMDs automatically or in response to a computer user's inputs through a computer interactive device, such as a computer keyboard, a touch screen monitor, or a computer mouse.

In at least one embodiment of the present invention, a method is provided comprising: using a computer processor to access a first data architecture model from a plurality of data architecture models stored in a computer memory; using the computer processor to store a first logical entity relationship diagram in the first data architecture model in the computer memory; wherein the first logical entity relationship diagram includes a plurality of data entities and a plurality of data entity relationships stored in the computer memory, such that each of the plurality of data entity relationships of the first logical entity relationship diagram relates one of the plurality of data entities of the first logical entity relationship diagram with only one of the plurality of data entities of the first logical entity relationship diagram; and wherein the first logical entity relationship diagram includes a first data entity from the plurality of data entities included in the first logical entity relationship diagram; wherein the first data entity has a first data entity name and a first plurality of data attributes.

In at least one embodiment the first data entity name of the first data entity is a unique data entity name within the plurality of data entities of the first logical entity relationship diagram; wherein the first data architecture model in computer memory includes a plurality of analog PDMDs that were formed from the first logical entity relationship diagram; wherein the plurality of analog PDMDs includes a first PDMD and a second PDMD; wherein the first PDMD includes a plurality of analog data table representations formed from the plurality of data entities of the first logical entity relationship diagram; and wherein the plurality of analog data table representations of the first PDMD includes a first data table representation.

In at least one embodiment the second PDMD includes a plurality of analog data table representations formed from the plurality of data entities of the first logical entity relationship diagram; wherein the plurality of analog data table representations of the second PDMD includes a first data table representation; wherein each of the first data table representation within the first PDMD and the first data table representation within the second PDMD is an analog of the first data entity of the first logical entity relationship diagram; wherein the first data table representation within the first PDMD receives a first data table name from the first data entity name of the first data entity contained in the first logical entity relationship diagram; wherein the first data table name of the first data table representation contained in the first PDMD is a unique data table name within the first PDMD; and wherein the first data table representation within the first PDMD receives a first plurality of data table columns as analogs of the first plurality of data attributes of the first data entity included in the first logical entity relationship diagram.

In at least one embodiment the first data table representation within the second PDMD receives a first data table name from the first data entity name of the first data entity contained in the first logical entity relationship diagram; wherein the first data table name of the first data table representation contained in the second PDMD is a unique data table name within the second PDMD; and wherein the first data table representation within the second PDMD receives a first plurality of data table columns as analogs of the first plurality of data attributes of the first data entity included in the first logical entity relationship diagram.

The method may further include: adding a first peer key constraint to the first data table representation of the first PDMD; adding the first peer key constraint to the first data table representation of the second data architecture model; wherein the first data table representation within the first PDMD is constrained by the first peer key constraint; wherein the first peer key constraint constrains the first data table representation within the second PDMD; and wherein the first peer key constraint indicates an intent to provide peer dataset content commonality among the first data table representation of the first PDMD and the first data table representation of the second PDMD.

In at least one embodiment, the first data entity of the first logical entity relationship diagram has a first unique key; wherein the first data table representation within the first PDMD contains a first unique key, which is an analog formed from the first unique key of the first data entity of the first logical entity relationship diagram; wherein the first data table representation within the second PDMD contains a first unique key, which is an analog formed from the first unique key of the first data entity of the first logical entity relationship diagram; and wherein the first unique key of the first data table representation within the first PDMD and the first unique key of the first data table representation within the second PDMD are constrained by the first peer key constraint.

In at least one embodiment, the plurality of data table representations in the first PDMD includes a second data table representation; wherein a first foreign key constraint representation is added to the first PDMD to join the first data table representation and the second data table representation contained in the first PDMD; wherein the second data table representation then inherits the first unique key of the first data table representation as a first foreign key of the second data table representation in the first PDMD; and wherein the first unique key of the first data table representation of the first PDMD is constrained by both the first foreign key constraint representation of the first PDMD and the first peer key constraint.

In at least one embodiment, the first data entity of the first logical entity relationship diagram has a second unique key; wherein the first data table representation within the first PDMD contains a second unique key which is an analog formed from the second unique key of the first data entity of the first logical entity relationship diagram; wherein the first data table representation within the second PDMD contains a second unique key which is an analog formed from the second unique key of the first data entity of the first logical entity relationship diagram;
wherein the first unique key of the first data table representation of the first PDMD and the second unique key of the first data table representation of the first PDMD are coupled to form a first unique coupled key of the first data table representation of the first PDMD; wherein the first unique key of the first data table representation of the second PDMD and the second unique key of the first data table representation of the second PDMD are coupled to form a first unique coupled key of the first data table representation of the second PDMD; and wherein each of the first unique coupled key of the first data table representation of the first PDMD and the first unique coupled key of the first data table representation of the second PDMD are constrained by the first peer key constraint configured to provide peer dataset content commonality.

In at least one embodiment, a first non-identifying data table column of the first data table representation contained in the first PDMD is an analog of a first non-identifying data attribute of the first plurality of data attributes of the first data entity from the first logical entity relationship diagram; wherein a first non-identifying data table column of the first data table representation contained in the second PDMD is an analog of a first non-identifying data attribute of the first plurality of data attributes of the first data entity from the first logical entity relationship diagram; and wherein each of the first non-identifying data table column of the first data table representation of the first PDMD and the first non-identifying data table column of the first data table representation of the second PDMD is constrained by the first peer key constraint.

In at least one embodiment, the first data table representation of the first PDMD is a first peer data registry representation; wherein the first peer data registry representation is configured to enforce peer dataset content commonality for the first peer key constraint; wherein the first data table representation of the first PDMD is configured to contain a first set of unique data instances; and wherein the first data table representation of the second PDMD is configured to contain a subset of the first set of unique data instances in the first data table representation of the first PDMD.

In at least one embodiment, the plurality of analog PDMDs formed from the first logical entity relationship diagram includes a third PDMD; the third PDMD includes a plurality of analog data table representations formed from the plurality of data entities of the first logical entity relationship diagram; the plurality of data table representations of the third PDMD includes a first data table representation; wherein the first data table representation within the third PDMD is an analog of the first data entity of the first logical entity relationship diagram; wherein the first data table representation within the third PDMD receives a first data table name from the first data entity name of the first data entity contained in the first logical entity relationship diagram; wherein the first data table name of the first data table representation contained in the third PDMD is a unique data table name within the third PDMD; wherein the first data table representation within the third PDMD receives a first plurality of data table columns as analogs of the first plurality of data attributes of the first data entity included in the first logical entity relationship diagram; and wherein the method further includes adding the first peer key constraint to the first data table representation of the third PDMD; wherein the first data table representation within the third PDMD is constrained by the first peer key constraint; wherein the first data table representation within the third PDMD contains a first unique key, which is an analog formed from the first unique key of the first data entity of the first logical entity relationship diagram; wherein the first peer data registry representation of the first PDMD is configured to enforce peer dataset content commonality of the first data table representation of the third PDMD; and wherein the first data table representation of the third PDMD is configured to contain a subset of the first set of unique data instances in the first data table representation of the first PDMD.

In at least one embodiment, the first logical entity relationship diagram includes a second data entity from the plurality of data entities included in the first logical entity relationship diagram; wherein the plurality of data table representations of the first PDMD includes a second data table representation; wherein the plurality of data table representations of the second PDMD includes a second data table representation; and wherein each of the second data table representation within the first PDMD and the second data table representation within the second PDMD is an analog of the second data entity of the first logical entity relationship diagram.

In at least one embodiment, the method further includes adding a second peer key constraint to the second data table representation of the first PDMD; and adding the second peer key constraint to the second data table representation of the second PDMD; wherein the second data table representation within the first PDMD is constrained by a second peer key constraint; wherein the second data table representation within the second PDMD is constrained by the second peer key constraint; and wherein the second peer key constraint indicates an intent to provide peer dataset content commonality among the second data table representation of the first PDMD and the second data table representation of the second PDMD.

In at least one embodiment, the second data entity of the first logical entity relationship diagram contains a plurality of data attributes; wherein the second data table representation within the first PDMD contains a plurality of data table columns; wherein the second data table representation within the second PDMD contains a plurality of data table columns; and wherein each of the plurality of data table columns within the second data table representation of the first PDMD and the plurality of data table columns within the second data table representation of the second PDMD is an analog of the plurality of data attributes of the second data entity of the first logical entity relationship diagram.

In at least one embodiment, the second data entity of the first logical entity relationship diagram has a first unique key declared on one or more data attributes of the plurality of data attributes of the second data entity; wherein the second data table representation within the first PDMD has a first unique key declared on one or more data table columns of the plurality of data table columns of the second data table representation within the first PDMD; wherein the second data table representation within the second PDMD has a first unique key declared on one or more data table columns of the plurality of data table columns of the second data table representation within the second PDMD; wherein each of the first unique key of the second data table representation within the first PDMD and the first unique key of the second data table representation within the second PDMD is an analog of the first unique key of the second data entity of the first logical entity relationship diagram; wherein the first unique key of the second data table representation within the first PDMD is constrained by the second peer key constraint; and wherein the first unique key of the second data table representation within the second PDMD is constrained by the second peer key constraint.

In at least one embodiment, the method is further comprised of: adding a first data file with a first set of unique data content records to the computer memory; wherein the first data file is configured to ensure peer dataset content commonality for the second peer key constraint; wherein each of the second data table representation within the first PDMD and the second data table representation within the second PDMD is constrained by the first set of unique data content records of the first data file.

In yet another embodiment, a method is provided which includes: using a computer processor to access a first data architecture model stored in a computer memory; using the computer processor to store a first PDMD and a second PDMD in the first data architecture model in the computer memory; wherein the first PDMD contains a first data table representation with a data table name and a first plurality of data table columns; wherein the first data table representation of the first PDMD contains a first unique key; wherein the first unique key of the first data table representation of the first PDMD is based on a first set of data table columns from the first plurality of data table columns of the first data table representation contained in the first PDMD; wherein the second PDMD contains a first data table representation; wherein the first data table representation of the second PDMD contains a first copy of the first plurality of data table columns of the first data table representation contained in the first PDMD; and wherein the first data table name of the first data table representation contained in the second PDMD is a first copy of the data table name of the first data table representation contained in the first PDMD.

In the yet another embodiment, the first data table representation of the second PDMD contains a first unique key; and wherein the first unique key of the first data table representation contained in the second PDMD is based on the first set of data table columns copied from the first plurality of data table columns of the first data table representation contained in the first PDMD.

The yet another embodiment may further include: adding a first peer key constraint to the first data table representation contained in the first PDMD; and adding the first peer key constraint to the first data table representation contained in the second PDMD; wherein the first data table representation contained in the first PDMD is a first peer data table representation of the first PDMD; wherein the first data table representation contained in the second PDMD is a first peer table of the second PDMD; wherein the first peer key constraint constrains the first unique key of the first peer data table representation of the first PDMD and the first unique key of the first peer data table representation of the second PDMD; and wherein the first peer key constraint indicates the intent to provide peer dataset content commonality among the first peer data table representation of the first PDMD and the first peer data table representation of the second PDMD.

The yet another embodiment may further include removing the non-identifying data table columns from the first peer data table representation contained in the second PDMD; wherein the first peer data table representation of the second data architecture model is a first peer dataset connector representation of the second data architecture model after the non-identifying data table columns have been removed from the first peer data table representation; and wherein the first peer dataset connector representation of the second PDMD is dependent on the first peer data table representation of the first PDMD for access to the entire set of the first plurality of data table columns of the first data table representation contained in the first PDMD.

In at least one yet another embodiment, the first peer data table representation of the first PDMD is a first peer data registry representation configured to provide a first set of unique data content records to enforce peer dataset content commonality in all peer dataset connector representations constrained by the first peer key constraint; wherein the peer dataset connector representations constrained by the first peer key constraint are configured to contain a subset of the first set of unique data instances in the first peer data registry representation of the first PDMD; wherein the first peer data registry representation of the first PDMD is also configured to store the first set of unique data content records for the first plurality of data table columns for the first peer data table representation in the first PDMD; and wherein the first peer dataset connector representation of the second PDMD functions as a first substitute peer data table representation for the first peer data table representation of the first PDMD.

In at least one yet another embodiment, the second PDMD is a first dependent peer PDMD since the second PDMD contains at least one peer dataset connector representation; and wherein the first PDMD is a first independent peer PDMD since the first PDMD contains at least one peer data registry representation; and wherein the first independent peer PDMD is used in conjunction with the first dependent peer PDMD to architect datasets that eliminate redundant data content from the first peer dataset connector representation of the second PDMD.

In at least one yet another embodiment, there is a first logical entity relationship diagram stored in the first data architecture model stored in the computer memory; wherein the first PDMD and the second PDMD are analogs of the first logical entity relationship diagram; wherein the first logical entity relationship diagram contains a first data entity; wherein the first peer data table representation of the first PDMD and the first peer dataset connector representation of the second PDMD are analogs of the first data entity in the first logical entity relationship diagram; and wherein the first data entity of the first logical entity relationship diagram contains a first plurality of data attributes; wherein the first plurality of data table columns of the first peer data table representation contained in the first PDMD is an analog of the first plurality of data attributes contained in the first data entity of the first logical entity relationship diagram.

In at least one yet another embodiment, the first copy of the first set of data table columns from the first plurality of data table columns of the first PDMD now contained in the first peer dataset connector representation of the second PDMD is an analog of the first plurality of data attributes contained in the first data entity of the first logical entity relationship diagram; wherein the first data entity of the first logical entity relationship diagram contains a first unique key; and wherein each of the first unique key of the first peer data table representation of the first PDMD and the first unique key of the first peer dataset connector representation of the second PDMD is an analog of the first unique key of the first data entity of the first logical entity relationship diagram.

In at least one yet another embodiment, the first logical entity relationship diagram contains a second data entity; and the first logical entity relationship diagram contains a first data entity relationship; wherein the first data entity is related to the second data entity by the first data entity relationship in the first logical entity relationship diagram; wherein the second data entity inherits a first foreign key from the first unique key of the first data entity in the first logical entity relationship diagram; wherein a second data table representation is added to the second PDMD which is an analog to the second data entity of the first logical entity relationship diagram; wherein a first foreign key constraint representation is added to the second PDMD which is an analog of the first data entity relationship of the first logical entity relationship diagram; wherein the first foreign key constraint representation causes the second data table representation of the second PDMD to inherit a first foreign key from the first unique key of the first peer dataset connector representation of the second PDMD; wherein the first foreign key constraint representation of the second PDMD uses the first unique key of the first peer dataset connector representation to constrain the first foreign key of the second data table representation of the second PDMD; and wherein the first unique key of the peer dataset connector representation constrains both the first foreign key constraint representation of the second PDMD and the first peer key constraint.

In at least one yet another embodiment, the first logical entity relationship diagram contains a third data entity; wherein the first logical entity relationship diagram contains a second data entity relationship; wherein the first data entity is related to the third data entity by the second data entity relationship in the first logical entity relationship diagram; wherein the third data entity inherits a first foreign key of the third data entity from the first unique key of the first data entity in the first logical entity relationship diagram; wherein a third PDMD is contained in the first data architecture model in the computer memory; wherein the third PDMD is an analog of the first logical entity relationship diagram; wherein a first peer dataset connector representation is contained in the third PDMD; and wherein the first peer dataset connector representation is an analog of the first data entity of the first logical entity relationship diagram.

In at least one yet another embodiment, a first unique key is added to the first peer dataset connector representation of the third PDMD; wherein the first unique key of the first peer dataset connector representation contained in the third PDMD is an analog of the first unique key of the first data entity of the first logical entity relationship diagram.

In at least one yet another embodiment the method may include: adding the first peer key constraint to the first peer dataset connector representation of the third PDMD; wherein the first peer key constraint constrains the first unique key of the first peer dataset connector representation of the third PDMD; wherein a first data table representation is added to the third PDMD which is an analog to the third data entity of the first logical entity relationship diagram; wherein a first foreign key constraint representation is added to the third PDMD which is an analog of the second data entity relationship of the first logical entity relationship diagram; wherein the first data table representation of the third PDMD inherits a first foreign key from the first unique key of the first peer dataset connector representation of the third PDMD; and wherein the first foreign key of the first data table representation of the third PDMD is an analog of the first foreign key of the third data entity of the first logical entity relationship diagram.

In at least one yet another embodiment, the first foreign key constraint representation uses the first unique key of the first peer dataset connector representation contained in the third PDMD to constrain the first foreign key of the first data table representation of the third PDMD; wherein the first peer data table representation of the first PDMD is configured to provide the first set of unique data content records to enforce peer dataset content commonality for the first peer dataset connector representation contained in the third PDMD; wherein the first peer dataset connector representation contained in the third PDMD functions as a second substitute peer data table representation for the first peer data table representation in the first PDMD; wherein the second substitute peer data table representation enforces the first peer key constraint in the third PDMD; wherein the third PDMD is a second dependent peer PDMD since the third PDMD contains at least one peer dataset connector representation; and wherein the first independent peer PDMD is used in conjunction with the second dependent peer PDMD to architect datasets that eliminate redundant data content from the first peer dataset connector representation in the third PDMD.

In at least one yet another embodiment, the first logical entity relationship diagram contains a fourth data entity; wherein the fourth data entity contains a first plurality of data attributes; wherein the fourth data entity of the first logical entity relationship diagram has a first unique key and a second unique key; wherein the first unique key of the fourth data entity is based on a first set of data attributes from the first plurality of data attributes contained within the fourth data entity; wherein the second unique key of the fourth data entity is based on a second set of data attributes from the first plurality of data attributes contained within the fourth data entity; wherein a second peer data table representation with a first unique key and a second unique key and the first plurality of data table columns is contained within the first PDMD; and wherein the second peer table contained in the first PDMD is an analog of the fourth data entity of the first logical entity relationship diagram.

In at least one yet another embodiment, a second peer dataset connector representation with a first unique key and a second unique key is contained within the second PDMD where the second peer dataset connector representation contained within the second PDMD is an analog of the fourth data entity of the first logical entity relationship diagram; wherein a second peer dataset connector representation with a first unique key and a second unique key is contained within the third PDMD where the second peer dataset connector representation contained within the third PDMD is an analog of the fourth data entity of the first logical entity relationship diagram.

In at least one yet another embodiment, the method further includes adding a second peer key constraint to the second peer data table representation of the first PDMD; adding the second peer key constraint to the second peer dataset connector representation of the second PDMD; and adding the second peer key constraint to the second peer dataset connector representation of the third PDMD; wherein the second peer key constraint constrains the first unique key and the second unique key of the second peer data table representation of the first PDMD; wherein the second peer key constraint constrains the first unique key and the second unique key of the second peer dataset connector representation of the second PDMD; wherein the second peer key constraint constrains the first unique key and the second unique key of the second peer dataset connector representation of the third PDMD; and wherein the second peer data table representation of the first PDMD is a second peer data registry representation configured to provide a second set of unique data content records to enforce peer dataset content commonality in all peer dataset connector representations constrained by the second peer key constraint.

In at least one yet another embodiment, the first logical entity relationship diagram contains a third data entity relationship and a fourth data entity relationship; wherein the fourth data entity is related to the second data entity by the third data entity relationship in the first logical entity relationship diagram; wherein the fourth data entity is related to the third data entity by the fourth data entity relationship; wherein the second data entity inherits a second foreign key of the second data entity from the first unique key of the fourth data entity in the first logical entity relationship diagram; wherein the third data entity inherits a second foreign key of the third data entity from the first unique key of the fourth data entity in the first logical entity relationship diagram; wherein the second PDMD contains a second foreign key constraint representation where the second data table representation inherits a second foreign key from the first unique key of the second peer dataset connector representation contained within the second PDMD; wherein the second foreign key constraint representation contained within the second PDMD is an analog of the third data entity relationship of the first logical entity relationship diagram; wherein the third PDMD contains a second foreign key constraint representation where the first data table representation inherits a second foreign key from the first unique key of the second peer dataset connector representation contained within the third PDMD; and wherein the second foreign key constraint representation contained within the third PDMD is an analog of the fourth data entity relationship of the first logical entity relationship diagram.

In at least a further embodiment of the present invention, a method is provided which includes: using a computer processor to access a first data architecture model stored in a computer memory; and using the computer processor to store a first PDMD in the first data architecture model in the computer memory; wherein the first PDMD contains a first plurality of data table representations and a first plurality of foreign key constraint representations; wherein each foreign key constraint representation constrains at most two data table representations; wherein the first PDMD contains a first data table representation with a first plurality of data table columns; and wherein the first data table representation within the first PDMD has a data table name.

In the at least further embodiment of the present invention, the data table name of the first data table representation contained in the first PDMD is a unique data table name among the data table names of the first plurality of data table representations within the first PDMD; wherein the first data table representation of the first PDMD contains a first unique key; and wherein the first unique key of the first data table representation is based on one or more data table columns of the first plurality of data table columns contained in the first data table representation of the first PDMD.

In at least the further embodiment of the present invention, the method may include adding a second PDMD to the first data architecture model stored in the computer memory;
wherein the second PDMD contains a first data table representation which is a first copy of the first data table representation of the first PDMD; wherein the first data table representation of the second PDMD has a data table name that is a copy of the data table name of the first data table representation contained in the first PDMD; wherein the first data table representation of the second PDMD contains a first copy of the plurality of data table columns of the first data table representation contained in the first PDMD; and wherein the first data table representation of the second PDMD contains a first unique key that is a first copy of the first unique key of the first data table representation contained in the first PDMD.

In the at least further embodiment of the present invention, the method may further include adding a first peer key constraint to the first data table representation of the first PDMD; and adding the first peer key constraint to the first data table representation of the second PDMD; wherein the first peer key constraint constrains the first unique key of the first data table representation contained in the first PDMD; wherein the first peer key constraint constrains the first unique key of the first data table representation contained in the second PDMD; wherein the first peer key constraint indicates the intent to provide peer dataset content commonality among the first data table representation of the first PDMD and the first data table representation of the second PDMD; and further comprising: removing any data table columns from the first plurality of data table columns contained in the first data table representation of the first PDMD, that are not the basis of the first unique key of the first data table representation contained in the first PDMD; wherein the first data table representation of the first PDMD is a first peer dataset connector representation after the non-identifying data table columns have been removed from the first data table representation; and wherein the first PDMD is a first dependent peer PDMD since the first PDMD contains at least one peer dataset connector representation.

In at least the further embodiment of the present invention, the first data table representation of the second PDMD is a first peer data registry representation configured to provide a first set of unique data content records to enforce peer dataset content commonality in all peer dataset connector representations constrained by the first peer key constraint; wherein the first peer dataset connector representation of the first PDMD functions as a first substitute peer data table representation for the first data table representation in the second PDMD; wherein the second PDMD is a first independent peer PDMD since the second PDMD contains at least one peer data registry representation; and wherein the first independent peer PDMD is used in conjunction with the first dependent peer PDMD to architect datasets that eliminate redundant data content from the first peer dataset connector representation of the first PDMD.

In at least the further embodiment of the present invention a second data table representation of the first plurality of data table representations is contained in the first PDMD; wherein a first foreign key constraint representation of the first plurality of foreign key constraint representations contained in the first PDMD constrains the first peer dataset connector representation and the second data table representation contained in the first PDMD; wherein the second data table representation contained in the first PDMD inherits the first unique key from the first peer dataset connector representation as a first foreign key in the second data table representation contained in the first PDMD; and wherein the first unique key of the first peer dataset connector representation contained in the first PDMD joins the first data table representation contained in the second PDMD with the second data table representation in the first physical data table representation.

In at least the further embodiment of the present invention, the method may further include: using the computer processor to store a third PDMD in the first data architecture model in the computer memory; and wherein the third PDMD contains a second plurality of data table representations and a second plurality of foreign key constraint representations; wherein each foreign key constraint representation constrains at most two data table representations; wherein the third PDMD contains a first data table representation that is a first peer dataset connector representation which is a first copy of the first peer dataset connector representation of the first PDMD; wherein the third PDMD is a second dependent peer PDMD since the third PDMD contains at least one peer dataset connector representation; wherein the first peer dataset connector representation of the third PDMD contains a first unique key that is a second copy of the first unique key of the first peer dataset connector representation contained in the first PDMD; and further comprising; and wherein the first peer dataset connector representation of the third PDMD functions as a second substitute peer data table representation for the first data table representation in the second PDMD.

The at least further embodiment of the present invention may include: adding the first peer key constraint to the first peer dataset connector representation of the third PDMD; and wherein the first unique key of the first peer dataset connector representation of the third PDMD is constrained by the first peer data registry representation of the second PDMD.

In the at least further embodiment of the present invention a second data table representation of the second plurality of data table representations is contained in the third PDMD; wherein a first foreign key constraint representation of the second plurality of foreign key constraint representations in the third PDMD constrains the first peer dataset connector representation and the second data table representation contained in the third PDMD; wherein the second data table representation contained in the third PDMD inherits the first unique key from the first peer dataset connector representation contained in the third PDMD as a first foreign key in the second data table representation contained in the third PDMD; wherein the first unique key of the first peer dataset connector representation contained in the third PDMD joins the first data table representation contained in the second PDMD and the first peer dataset connector representation contained in the first PDMD with the second data table representation in the third PDMD.

In the at least further embodiment of the present invention, the first PDMD contains a second data table representation with a second plurality of data table columns; wherein the second data table representation of the first PDMD contains a first unique key and a second unique key; wherein the first unique key of the second data table representation is based on one or more data table columns of the second plurality of data table columns contained in the second data table representation of the first PDMD; and wherein the second unique key of the second data table representation is based on one or more data table columns of the second plurality of data table columns contained in the second data table representation of the first PDMD.

The at least further embodiment of the present invention may include adding a fourth PDMD to the first data architecture model stored in a computer memory; wherein the fourth PDMD contains a first data table representation which is a first copy of the second data table representation of the first PDMD; wherein the first data table representation of the fourth PDMD contains a first copy of the plurality of data table columns of the second data table representation contained in the first PDMD; wherein the first data table representation of the fourth PDMD contains a first unique key that is a first copy of the first unique key of the second data table representation contained in the first PDMD; and wherein the first data table representation of the fourth PDMD contains a second unique key that is a first copy of the second unique key of the second data table representation contained in the first PDMD.

The at least further embodiment of the present invention may further include: adding a second peer key constraint to the second data table representation of the first PDMD; adding the second peer key constraint to the first data table representation of the fourth PDMD; wherein the second peer key constraint constrains the first unique key and the second unique key of the second data table representation contained in the first PDMD; and wherein the second peer key constraint constrains the first unique key and the second unique key of the first data table representation contained in the fourth PDMD.

The at least further embodiment of the present invention may include: removing any data table columns from the second plurality of data table columns contained in the second data table representation of the first PDMD, that are not the basis of the first unique and the second unique key of the second data table representation of the first PDMD; wherein the second data table representation of the first PDMD is a second peer dataset connector representation of the first PDMD; wherein the first data table representation of the fourth PDMD is a second peer data registry representation configured to provide a second set of unique data content records to enforce peer dataset content commonality in all peer dataset connector representations constrained by the second peer key constraint; and wherein the fourth PDMD is a second independent peer PDMD since the fourth PDMD contains at least one peer data registry representation.

The at least further embodiment of the present invention may include: adding a first copy of the second peer dataset connector representation of the first PDMD to the third PDMD as a second peer dataset connector representation contained in the third PDMD; and wherein the second peer dataset connector representation contained in the third PDMD has a first unique key and a second unique key that was copied from the second peer dataset connector representation of the first PDMD.

The at least further embodiment of the present invention may further include adding the second peer key constraint to the second peer dataset connector representation of the third PDMD; wherein the second peer key constraint constrains the first unique key and the second unique key of the second peer dataset connector representation contained in the third PDMD; wherein the second peer dataset connector representation of the first PDMD functions as a first substitute peer data table representation for the first data table representation in the fourth PDMD; and wherein the second peer dataset connector representation contained in the third PDMD functions as a second substitute peer data table representation for the first data table representation in the fourth PDMD.

In the at least further embodiment of the present invention the first PDMD contains a third data table representation with a third plurality of data table columns; wherein the third data table representation of the first PDMD contains a first unique key; wherein the first unique key of the third data table representation is based on one or more data table columns of the third plurality of data table columns contained in the third data table representation of the first PDMD; wherein the fourth PDMD contains a second data table representation which is a first copy of the third data table representation of the first PDMD; wherein the second data table representation of the fourth PDMD contains a first copy of the plurality of data table columns of the third data table representation contained in the first PDMD; and wherein the second data table representation of the fourth PDMD contains a first unique key that is a first copy of the first unique key of the third data table representation contained in the first PDMD.

The at least further embodiment of the present invention may include: adding a third peer key constraint to the third data table representation of the first PDMD; and adding the third peer key constraint to the second data table representation of the fourth PDMD; wherein the third peer key constraint constrains the first unique key of the third data table representation contained in the first PDMD; and wherein the third peer key constraint constrains the first unique key of the second data table representation contained in the fourth PDMD.

The at least further embodiment of the present invention may include: removing any non-identifying data table columns from the third plurality of data table columns contained in the third data table representation of the first PDMD; and wherein the third data table representation of the first PDMD is a third peer dataset connector representation of the first PDMD.

In the at least further embodiment of the present invention there is a first logical entity relationship diagram stored in the first data architecture model stored in the computer memory; wherein a first data entity that contains a first plurality of data attributes is contained in the first logical entity relationship diagram; wherein the first data entity contains a first unique key based on one or more data attributes of the first plurality of data attributes contained in the first data entity of the first logical entity relationship diagram; wherein a second data entity that contains a first plurality of data attributes is contained in the first logical entity relationship diagram; wherein the second data entity contains a first unique key based on one or more data attributes of the first plurality of data attributes contained in the second data entity of the first logical entity relationship diagram; wherein the second data entity contains a second unique key based on one or more data attributes of the first plurality of data attributes contained in the second data entity of the first logical entity relationship diagram; wherein a third data entity that contains a first plurality of data attributes is contained in the first logical entity relationship diagram; and wherein the third data entity contains a first unique key based on one or more data attributes of the first plurality of data attributes contained in the third data entity of the first logical entity relationship diagram.

In the at least further embodiment of the present invention the first PDMD, the second PDMD, the third PDMD, and the fourth PDMD are analogs of the first logical entity relationship diagram; wherein the first data table representation of the second PDMD, the first peer dataset connector representation of the first PDMD, and the first peer dataset connector representation of the third PDMD are analogs of the first data entity contained in the first logical entity relationship diagram; wherein the first data table representation of the fourth PDMD, the second peer dataset connector representation of the first PDMD, and the second peer dataset connector representation of the third PDMD are analogs of the second data entity contained in the first logical entity relationship diagram; and wherein the second data table representation of the fourth PDMD and the third peer dataset connector representation of the first PDMD are analogs of the third data entity contained in the first logical entity relationship diagram.

### BRIEF DESCRIPTION OF THE DRAWINGS

FIG. 1 shows a block diagram of an apparatus in accordance with an embodiment of the present invention;

FIG. 2 depicts a prior art logical ERD of a country data entity, a state data entity, and a data entity relationship joining the two data entities together that can be displayed on a display device of the apparatus of FIG. 1 or stored in a computer memory of the apparatus of FIG. 1;

FIG. 3 depicts a prior art PDMD of a country data table representation and a state data table representation, and a foreign key constraint representation directly joining the two data table representations, where all PDMD objects are derived analogs from the antecedent logical ERD shown in FIG. 2;

FIG. 4 depicts a prior art pair of database tables in a single database schema directly joined by a foreign key constraint representation that was dataset instantiated from the PDMD shown in FIG. 3. These database tables were also populated with data content records while internal referential data integrity was enforced and where the database tables with their data content records can be displayed on a display device of the apparatus of FIG. 1 or stored in a computer memory of the apparatus of FIG. 1;

FIG. 5 depicts a flow chart for a typical prior-art data modeling process for creating and updating data model components such as the logical ERD shown in FIG. 2 and the PDMD depicted in FIG. 3;

FIG. 6 depicts a data architecture model that contains a logical ERD and the logical ERD's three analog PDMDs joined by a peer key constraint in accordance with an embodiment of the present invention;

FIG. 7 depicts three peer database tables, each in a separate database schema, populated with residential address-related data content records that exhibit both peer identifying metadata commonality and peer dataset content commonality to form a peer dataset access path;

FIG. 8 depicts a flow chart for a process of architecting peer PDMDs, such as peer PDMDs 630, 660, and 680 as shown in FIG. 6, and dataset instantiating, from these peer PDMDs, peer database schemas 730, 760, and 780, respectively as illustrated in data architecture schema 700 of FIG. 7;

FIG. 9 depicts a prior art logical ERD in a single data architecture model that can be displayed on a display device of the apparatus of FIG. 1 or stored in a computer memory of the apparatus of FIG. 1;

FIG. 10 depicts two complete analog PDMDs that can be derived, in accordance with an embodiment of the present invention from the antecedent logical ERD shown in FIG. 9;

FIG. 11 depicts two dependent peer PDMDs along with an independent peer PDMD that represents an enhancement derived from the two PDMDs represented in FIG. 10;

FIG. 12 depicts two dependent peer PDMDs along with two independent peer PDMDs that represent a further enhancement of the PDMDs shown in FIG. 11;

FIG. 13 represents two instantiated dependent peer datasets along with two instantiated independent peer datasets that were dataset instantiated from the PDMDs shown in FIG. 12;

FIG. 14 depicts a peer dataset architecture map of independent peer datasets and dependent peer datasets that depicts how these peer datasets can be joined using peer key constraints; and

FIG. 15 depicts a peer dataset architecture map of select independent peer datasets and dependent peer datasets joined together by peer key constraints.

### DETAILED DESCRIPTION OF THE INVENTION

In the present application, the following terms have the following definitions:

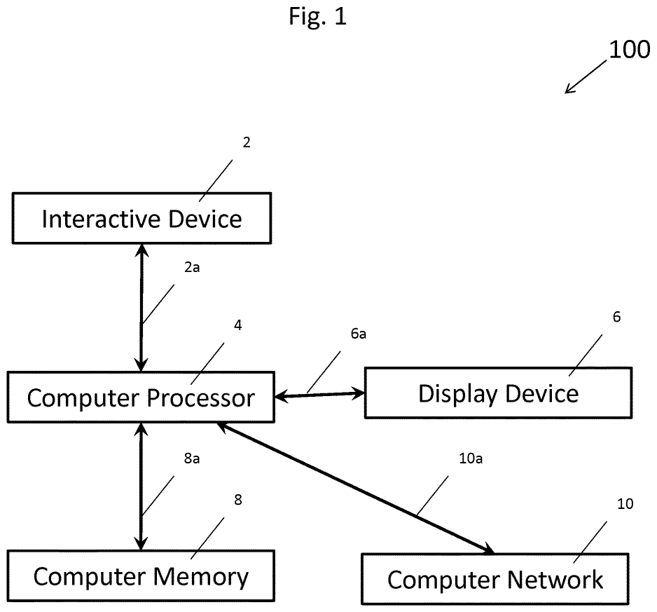

Alternate key (AK)—In a logical entity-relationship diagram (logical ERD), a data entity's alternate key is a commonly used term that provides an alternate method, different from the primary method, for uniquely identifying data instances of that data entity. In the logical ERD, the data architect designates a primary key to uniquely identify data instances for a data entity. In addition, the data architect can designate one or more alternate keys that individually uniquely identify data instances of the data entity. The alternate key in a logical ERD data entity is the antecedent of an alternate key in the analog data table representation of a PDMD. When a data table representation's alternate key columns are dataset instantiated, the resulting database table columns become a unique alternate key index. A database table's alternate key index is a unique key index associated with the database table of the database schema in one or more computer memories by the database management system (DBMS) implemented by a computer processor, such as a computer processor 4 in FIG. 1, and used to select unique data content records from the database table of the database schema.

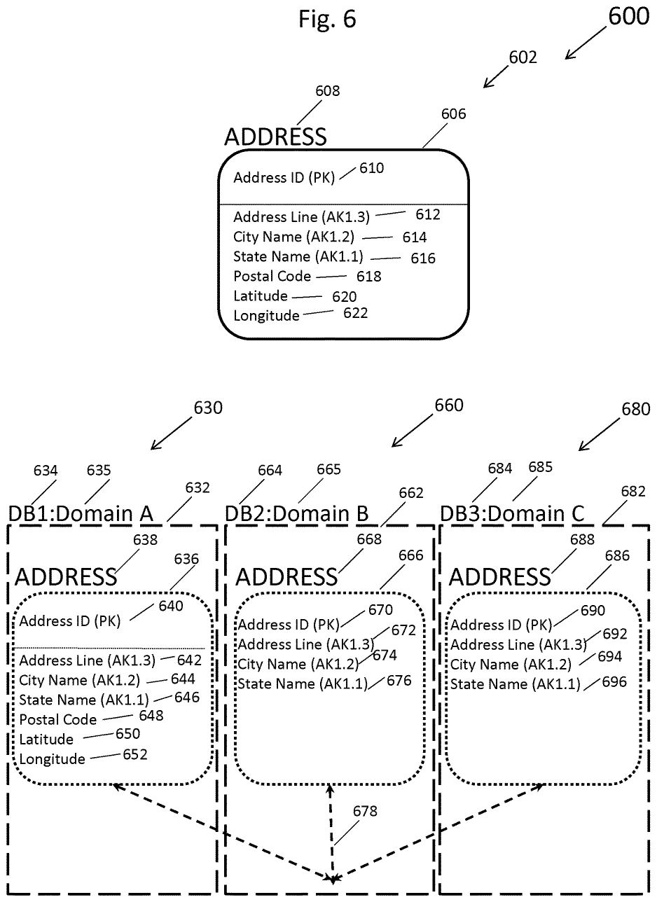

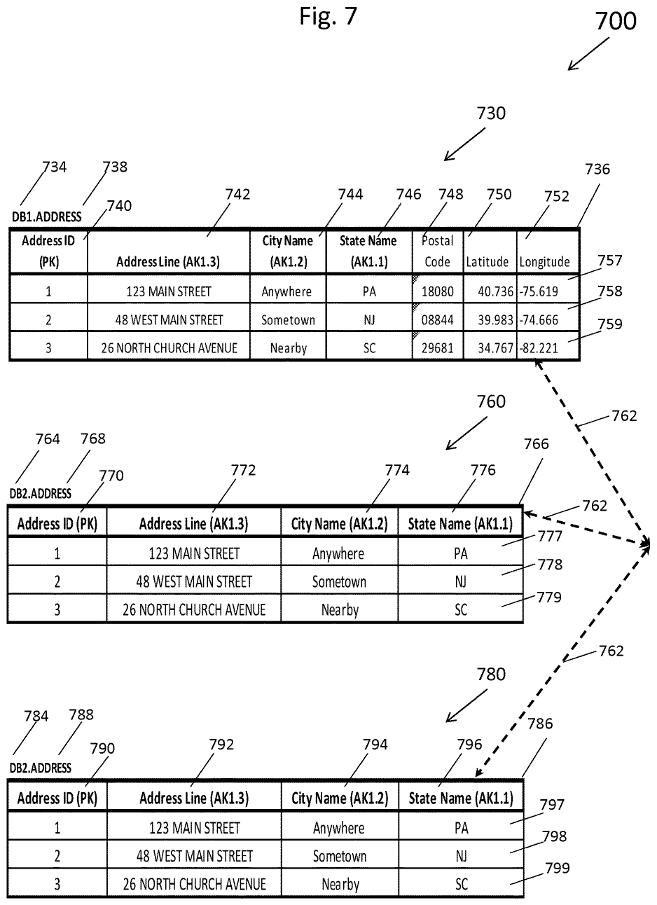

Data Attribute—A data attribute is a commonly used term that represents a single data field within a data entity of a logical ERD. For example, data attributes 610, 612, 614, 616, 618, 620, and 622 of data entity 606 each represent a single data field within logical ERD 602 of data architecture model 600 as shown in FIG. 6. Typically, each data attribute of a data entity is the antecedent of a data table column in a data table representation of a PDMD. For example, data attributes 610, 612, and 614 of data entity 606 in logical ERD 602 shown in FIG. 6 are the antecedents to data table columns 640, 642, and 644 respectively in data table representation 636 of PDMD 630 within data architecture model 600 as illustrated in FIG. 6. When dataset instantiated, data table columns such as data table columns 640, 642, and 644 of data table representation 636 shown in FIG. 6, become database table columns 740, 742, and 744 of peer database table 736 in peer database schema 730 depicted in FIG. 7.

Data attributes can be classified as identifying or non-identifying data attributes within a data entity. For example, data attributes 610, 612, 614, and 616 are all classified as identifying data attributes of data entity 606 because each data attribute is used as all or part of a unique key of the data entity as depicted in data architecture model 600 of FIG. 6. Data attribute 610 alone is the primary key of data entity 606 while data attributes 612, 614, and 616 compose the composite first alternate key of data entity 606. Data attributes 618, 620, and 622 are classified as non-identifying data attributes in data entity 606 as shown in FIG. 6 because these data attributes are not used in any unique keys of their data entity. Likewise, analog data table columns 640, 642, 644, and 646 are identifying data table columns in data table representation 636 which is the analog of data entity 606 as shown in FIG. 6. Analog data table columns 648, 650, and 652 are classified as non-identifying data table columns in data table representation 636.

Data architecture model—The data architecture model is an enhancement of the traditional data model. While traditional data modeling focuses on the design of individual datasets, data architecture modeling focuses on designing the interactions of multiple datasets. A data architecture model is a computer-implemented repository of metadata that is developed as a method to architect, implement, and maintain one or more datasets using a data architecture modeling software program. For the purposes of this patent, a data architecture model is used to architect and dataset instantiate data architecture schemas and database schemas. A data architecture model is typically divided into a high-level conceptual data architecture model, a mid-level logical data architecture model, and a low-level, detailed, physical data architecture model. The conceptual data architecture model is not addressed in this patent application. The logical data architecture model normally includes one or more logical ERDs that are developed to reflect the logical business requirements of an organization independent of the actual physical data environments to be utilized for data content management and storage. The physical data architecture model is the most detailed level of the data architecture model. The physical data architecture model includes one or more PDMD and the associated metadata that can be displayed on display device 6 of apparatus 100 of FIG. 1 or stored in the computer memory 8 of apparatus 100 of FIG. 1. Each PDMD is configured for a specific actual physical data environment and is derived from a single logical ERD. A major purpose of the data architecture model is to produce instantiated datasets, such as data architecture schema 700 shown in FIG. 7. When multiple database schemas are dataset instantiated from a data architecture model, these database schemas are part of a data architecture schema.

Data architecture modeling software program—Data architecture modeling is an enhancement of traditional data modeling. While traditional data modeling focuses on the design of individual datasets, data architecture modeling focuses on designing interactions for multiple datasets. A data architecture modeling software program is a computer software program, executing on a computer processor such as computer processor 4 in FIG. 1, wherein the data architecture modeling software program is computer software used to define and maintain data architecture models. In addition, a data architecture modeling software program is also used to dataset instantiate PDMDs into one or more datasets or database schemas using one or more DBMSs. A database schema is forward engineered from a PDMD of the data architecture model using the data architecture modeling software program and typically dataset instantiated as a database schema by a DBMS software program. When a group of PDMDs are dataset instantiated, a data architecture schema is formed by one or more DBMS software programs.

Data consolidation, transformative—For the purposes of this patent application, transformative data consolidation is a prior art data integration method where data from one or more disparate datasets are extracted and transformed into a form consistent with a data consolidation dataset into which the transformed data content is then loaded. This transformative data consolidation method is also referred to as an Extract, Transform, and Load (ETL) data integration method. For transformative data consolidation, the data sources are disparate. As such, the extracted data content needs to be transformed into a form consistent with the target dataset before that disparate target dataset is loaded with the data content consolidated from disparate data sources.

Data content record—A data content record is typically a single row of data values in a database table of a database schema or a dataset file that is stored in computer memory, such as computer memory 8. The term data content record is used to focus on the data values of the data record and not focus on the structural metadata such as the database table column names. Each data content record will usually include a primary key index data value for uniquely identifying that data content record. In addition, a data content record can include alternate key index data values to provide alternative methods for identifying unique data content records in a computer memory, such as computer memory 8 in FIG. 1. A data content record may also include foreign key index values to allow joining of data content records from multiple database tables within a single database schema or from multiple dataset data files. Also, peer data content records are data content records in two or more peer database tables, that provide peer dataset content commonality for a peer dataset access path.

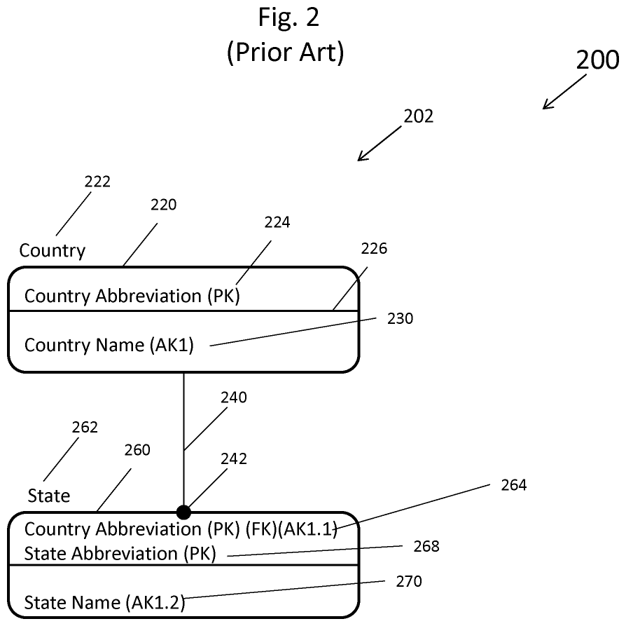

Data entity—A data entity is a commonly used basic data modeling component of a logical ERD (entity relationship diagram) that can be displayed on a display device 6 of apparatus 100 of FIG. 1, and that is stored in a computer memory such as the computer memory 8 of apparatus 100 shown in FIG. 1. A data entity is also a data architecture model object in a logical ERD. The data entity can be used to derive multiple analog data table representations and peer dataset connector representations where each analog data table representation and each peer dataset connector representation is normally in a separate PDMD. The data entity from which the analog data table representation is derived is referred to as the antecedent data entity. For example, in data architecture model 600 shown in FIG. 6, antecedent data entity 606 of logical ERD 602, is used to derive analog data table representation 636 of PDMD 630. Antecedent data entity 606 is also used to derive peer dataset connector representations 666 and 686 of PDMDs 660 and 680 respectively. Each data entity of the logical ERD will be given a name to uniquely identify that data entity from all other data entities of the logical ERD. In addition, a data entity includes a list of data attributes, which are components of the data entity. For example, data entity 220 of logical ERD 202 shown in data model 200 of FIG. 2, has data entity name 222, and data attributes 224 and 230. Each data entity generally has a primary key declared based on one or more of the data attributes listed for that data entity. Each data entity can also have alternate keys declared that are based on one or more of the data attributes listed for that data entity.

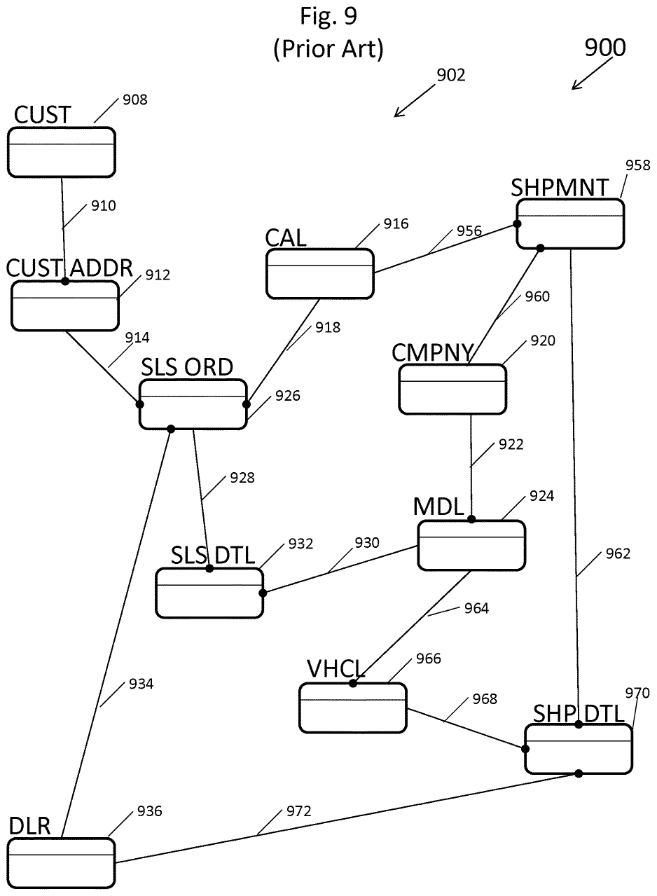

Typically, logical ERDs contain a group of independent border data entities upon which all other data entities are dependent. Independent border data entities typically do not inherit foreign keys from other data entities and represent a master data domain such as a person, place, time, or thing. For example, logical ERD 902, shown in FIG. 9, has independent border data entities 908, 916, 920, and 936 as they each represent a master data domain. The logical ERD data architect can designate which data entities are border data entities and can designate the associated master data domain. A logical ERD normally includes data entities that can be classified as header data entities. Typically, a header data entity is a dependent data entity to two or more border data entities. Examples of header data entities would be sales order headers, purchase order headers, bill of lading headers, recipe headers, and many other data entities that are directly dependent on multiple border data entities. Normally, each header data entity is a parent data entity to at least one facts and measures type of data entity. Examples of facts and measures data entities would be sales order details, purchase order details, bill of lading details, recipe details, and many other data entities.

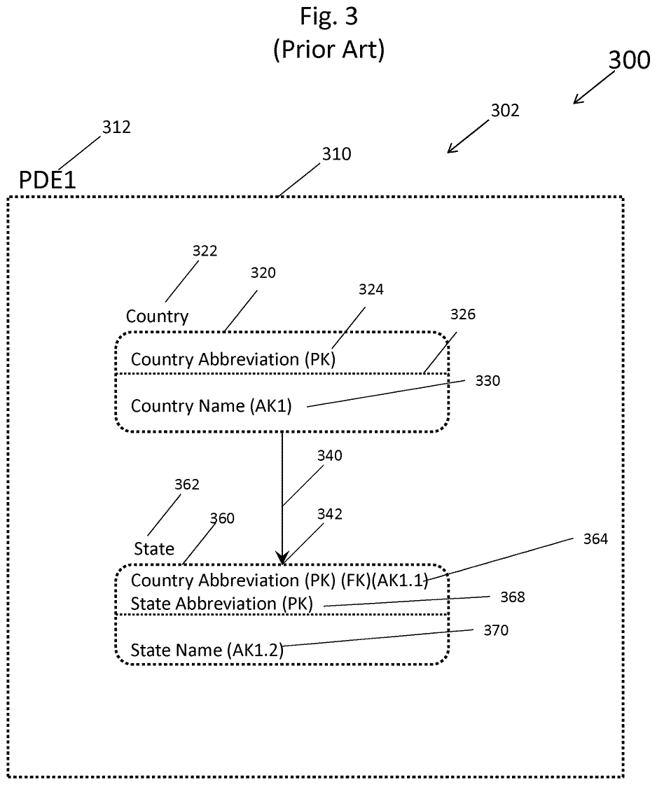

Data entity relationship—A data entity relationship is a commonly used data modeling object used to relate at most two data entities in a logical ERD. One data entity becomes the parent data entity, and the second data entity becomes the child data entity. For each data entity relationship, the data attributes of a unique key from the parent data entity are inherited into the child data entity as a non-unique foreign key. Data entity relationships are also in data architecture models. A data entity relationship joining a data entity with itself is often referred to as a recursive data entity relationship. When a logical ERD is converted into one or more PDMDs, each data entity typically becomes one or more data table representations. Each data entity relationship from the logical ERD is converted into a foreign key constraint representation that joins the data table representations within a PDMD. For example, data entity relationship 240 that relates parent data entity 220 to child data entity 260 of logical ERD 200 as shown in FIG. 2, is converted into foreign key constraint 340 that relates parent data table representation 320 to child data table representation 360 of PDMD 302 as shown in FIG. 3.

Data table representation—A data table representation is a data architecture modeling object used with PDMDs. A data table representation is typically derived from its antecedent data entity of the associated logical ERD of a data architecture model. The name of the PDMD data table representation is derived from the name of the antecedent data entity of the logical ERD. Each column of the analog data table representation in the PDMD is normally derived from each data attribute in the logical ERD's antecedent data entity. Likewise, the primary key, alternate keys, and foreign keys of an analog data table representation in a PDMD are typically derived from the primary key, the alternate keys, and the foreign keys of the antecedent data entity of the logical ERD. The intent to enforce internal referential data integrity among analog data table representations in the PDMDs is designated by the analog foreign key constraint representations derived from the antecedent data entity relationships of the logical ERD contained in the same data architecture model.

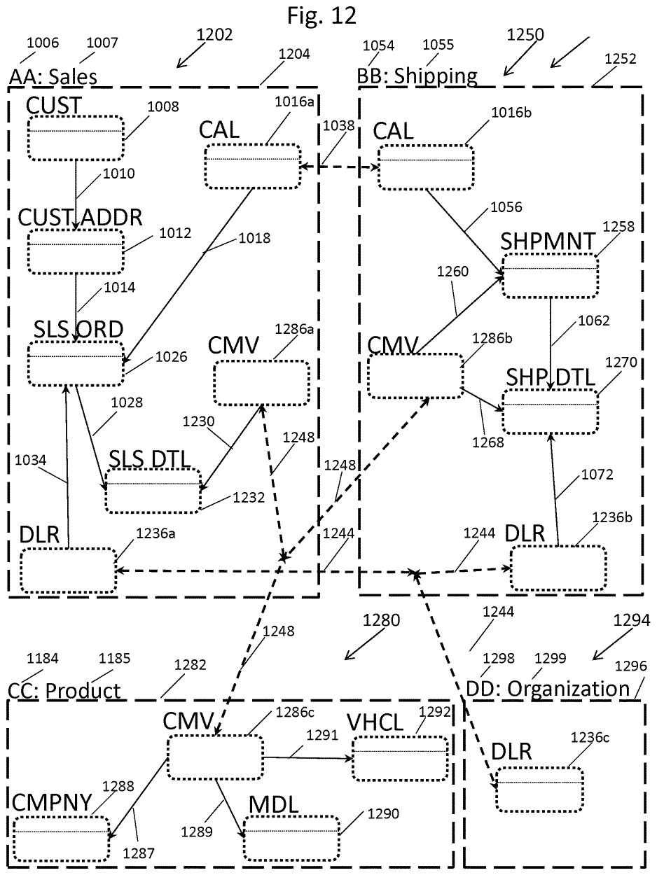

Data table representation, peer—A peer data table representation is a new phrase or term, coined by the inventor and introduced by this patent application and was not used in the prior art. Peer data table representations are two or more data table representations each in a PDMD and related by a peer key constraint, where each data table representation was derived from a single antecedent data entity of a logical ERD. The peer key constraint that relates peer data table representations details the peer dataset content commonality enforcement methods used to ensure peer data content commonality. A peer data table representation in a PDMD can be architected to function as a peer data registry representation, as a peer dataset connector representation, or simply as a peer data table representation. For example, PDMDs 1202 and 1250 contain peer data table representations 1016a and 1016b, respectively, joined by peer key constraint 1038 as shown in data architecture model 1200 in FIG. 12. Peer data table representations 1016a and 1016b function as simple peer data table representations. Also, in FIG. 12, peer data table representation 1236c of PDMD 1294 is designated to function as a peer data registry representation for peer dataset connector representations 1236a and 1236b in PDMDs 1202 and 1250 respectively. When dataset instantiated, each peer key constraint from a PDMD becomes a peer dataset access path between instantiated peer datasets or instantiated peer database schemas.

Data value—A data value is a common term for an alphanumeric string stored in a specific location in a computer memory such as a named data field. For example, a data value may be stored in a data field of a data entry form in a computer memory or in a specific cell of a spreadsheet, or in a specific data column of a specific data content record of a database table of a database schema in computer memory. The interpretation of the actual value of the alphanumeric string is dependent upon the data type of the data field. For example, if the data type of a data field is numeric, only valid numeric values will be accepted into the data field. If the data type of a data field is a date, only valid date alphanumeric strings will be accepted into the data field.

Database management system (DBMS)—A DBMS is a prior art computer software application or software program stored in one or more computer memories, such as one or more of computer memory 8, and executed by a computer processor such as processor 4 of FIG. 1 for creating and maintaining database schema objects, such as the database schema, database tables, database table indexes, and instantiated foreign key constraints as well as database data content records that are populated into the database tables. The DBMS manages every aspect of a database schema including data access security, database backup and recovery, database stored procedures, and database event triggers to name a few.

Database schema—A database schema for this patent application is a declared data storage area defined and managed by a database management system (DBMS) computer software program. This declared data storage area is generally a structured grouping of data values typically stored in computer memory and organized for convenient data value access by a DBMS. More specifically, a database schema is a defined data structure, generally stored in computer memory, comprised of multiple database tables, peer database tables, database table columns, database table indexes, database constraints, and other database objects defined using a computer-based DBMS. A database schema is typically architected in a data architecture model using a data architecture modeling software program. The data architecture modeling software program uses the data architecture model to forward-engineer SQL DDL (Standard Query Language-Data Definition Language). The generated SQL DDL is then used by a DBMS software program to dataset instantiate the database schema which typically contains thousands of database objects and each database table can contain many millions of data content records.

Database table—A database table is a common database schema object used to store sets of data values, in one or more computer memories. Each set of data values represents a horizontal row of the database table often referred to as a database table's data content record. Each data value of these data content records is represented as a labeled vertical column of the database table. Each data value, of a specific data content record, may be addressed, in one or more computer memories by using the label of the vertical column. A peer database table and a peer dataset connector are special types of database tables.

Database table index—A database table index is a common type of database schema object associated with a database table stored in computer memory using a DBMS. A database table index may be comprised of a single database table column of data values or be comprised of multiple database table columns of data values from the same database table. A database table index may be configured to be a unique database table index in the sense that the database table index uses a data value only once per database table index or configured as a nonunique database table index, which may repeat data values in that database table index. The DBMS software program is used to maintain the data integrity of all database table indexes, which are stored in one or more computer memories. Database table indexes are used to maintain the data integrity of the database table's data content records as well as to aid in the rapid retrieval of specific data content records from an indexed database table.

Dataset—For the purposes of the present patent application, a dataset is any digital collection of information comprised of both metadata and data content in a computer-based system. Instantiated datasets can take the form of structured datasets, semi-structured datasets, and unstructured datasets. These instantiated datasets can include databases, and computerized data files, such as digitized picture data files, audio data files, and video data files. One or more instantiated datasets may be architected in a data architecture model using a data architecture modeling software program. Typically, a software application is associated with an instantiated dataset for the purposes of creating, updating, deleting, or reading the data content records of the instantiated dataset. In the case where the instantiated dataset is a database schema, a DBMS software program manages the database schema.

Datasets, Disparate—A disparate dataset is a commonly used term to represent an instantiated dataset that lacks peer dataset commonality needed to make multiple datasets directly interoperable.

Dataset Granularity Conflict—A dataset granularity conflict is a new phrase or term, coined by the inventor and introduced by this patent application and was not used in the prior art. A dataset granularity conflict can occur between any two or more instantiated peer datasets connected by a peer dataset access path. When the data granularity of facts and measures data is stored at a first level of data granularity in a first instantiated peer dataset but stored at a different level of data granularity in a second instantiated peer dataset, a dataset granularity conflict occurs. Possible dataset granularity conflicts can be spotted in PDMDs or revealed in instantiated peer datasets. Dataset granularity conflicts must be resolved in order to mathematically combine facts and measures from the first instantiated peer dataset with the facts and measures from the second instantiated peer dataset. The resolution of a dataset granularity conflict uses a combination of a peer dataset access path to join the instantiated peer datasets and an instantiated foreign key constraint in the first or second instantiated peer dataset to change the level of granularity of the facts and measures.

Dataset instantiation—For this patent, dataset instantiation is a commonly used process of creating and updating a dataset from a data architecture model of the dataset, such as a PDMD. Typically, a dataset is dataset instantiated from a PDMD and other associated metadata managed by a data architecture modeling software program in a data architecture model. The data architecture modeling software program usually creates the dataset instantiation instructions that are then executed by a data management software program such as a DBMS. These instantiated datasets are created, maintained, and deleted by computer software programs, which may be executed within computer processor 4 and stored in computer memory 8.

Direct dataset interoperability—Direct dataset interoperability is a new phrase or term, coined by the inventor. Direct dataset interoperability is the ability to directly access, and process data content from multiple peer datasets that collectively function in a manner indistinguishable from a single consistent dataset. In at least one embodiment of this invention, two or more peer datasets are architected to be directly interoperable using peer key constraints to connect multiple PDMDs in a data architecture model. When the architected peer datasets are dataset instantiated, and the peer dataset content commonality enforced, reliable peer dataset access paths will form to support direct dataset interoperability. Direct dataset interoperability does not use data transformation software or other transformation-based software such as APIs (Application Program Interfaces).

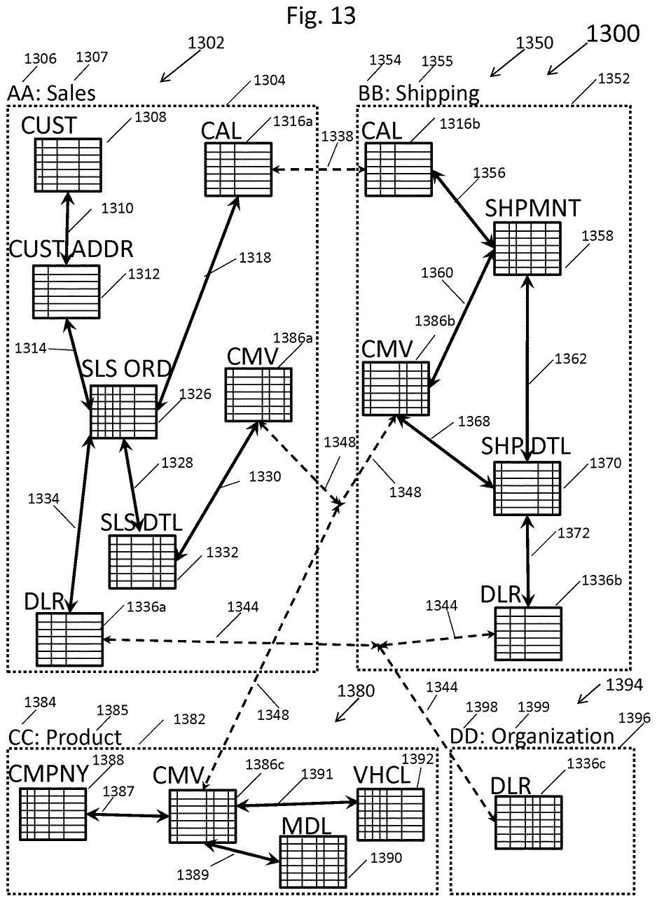

Peer data table representations connected by peer key constraints in multiple PDMDs of a data architecture model are examples of the external referential data integrity used to configure direct dataset interoperability into peer datasets. In instantiated peer database schemas, any data content records, directly or indirectly related to peer database tables, become related to each other. For example, in data architecture schema 1300 of FIG. 13, data content records from database table 1326 in dependent peer database schema 1302 is directly interoperable with data content records from database table 1358 in dependent peer database schema 1350. Since database table 1326 is directly related to peer database table 1316a by instantiated foreign key constraint 1318, and database table 1358 is directly related to peer database table 1316b by instantiated foreign key constraint 1356, the data content records of database tables 1326 and 1358 are related as shown in FIG. 13. Beyond the external referential data integrity enforced by peer data table representations, mathematical dataset consistency standards are also a requirement for direct dataset interoperability. For example, mathematical dataset consistency standards need to ensure consistent units of measurement systems, such as metric measures, and monetary currency units of measure consistently use US dollars.

Entity-Relationship Diagram (ERD), Logical—A logical ERD is a prior art graphical depiction of one or more dataset representations composed from data entities and data entity relationships that can be displayed on the display device 6 of the apparatus 100 of FIG. 1 or stored in computer memory 8 of the apparatus 100 of FIG. 1. A logical ERD, in at least one embodiment of the present invention, is always stored within a repository of metadata, commonly referred to as a data architecture model. Typically, a logical ERD represents a high-level data configuration for one or more datasets. The logical ERD, however, lacks the details required for dataset instantiation of a dataset. For this reason, the logical ERD is architected independently of any physical data environment into which one or more datasets will eventually be dataset instantiated. Typically, a logical ERD can be the antecedent to one or more analog PDMDs. When the logical ERD is antecedent to two or more analog PDMDs, peer key constraints need to be used to architect peer datasets or else disparate datasets will be architected.

Foreign key—In a logical ERD, a foreign key is a commonly used term for a non-unique key in a data entity, where the foreign key is composed of data attributes inherited from unique key data attributes of a “parent” data entity. The foreign key is inherited into the “child” data entity and results from a data entity relationship, which provides a join between two data entities. The data attributes from the primary key or a selected alternate key of a first data entity are duplicated into a second data entity which is now dependent upon the first data entity. These duplicated data attributes are referred to as foreign key data attributes in a logical ERD.

Foreign key constraint—A foreign key constraint representation is a prior art PDMD object that relates at most two data table representations within a single PDMD. The foreign key constraint representation is normally architected and/or configured in a logical ERD as a data entity relationship between at most two data entities. When the PDMD is derived from a logical ERD, each data entity relationship in the logical ERD typically becomes a foreign key constraint representation in the PDMD. Each foreign key constraint representation of a PDMD designates that internal referential data integrity should be established between the data table representations joined by the foreign key constraint representation. In a database schema's dataset that was dataset instantiated from a PDMD, instantiated foreign key constraints are stored in computer memory and are used by the DBMS to enforce internal referential data integrity rules for creating, updating, and deleting data content records in the two constrained database tables of a single database schema. Each dataset instantiated foreign key constraint in a database schema provides a bidirectional data access path for combining the data content records from at most two foreign key-constrained database tables within that database schema.

Identifying metadata—for the present patent application, identifying metadata exists in data architecture models as well as in dataset instantiated database schemas. In a logical ERD of a data architecture model, each data entity of the logical ERD includes identifying metadata such as the unique data entity name, the primary key data attributes, and the alternate key data attributes. For example, in logical ERD 202 of data model 200 shown in FIG. 2, the identifying metadata of data entity 220 includes unique data entity name 222, primary key data attribute 224, and alternate key data attribute 230.

In a PDMD of a data architecture model, each data table representation of the PDMD includes identifying metadata such as the unique data table, the primary key columns, and the alternate key columns of the data table representation. For example, in PDMD 302 of data model 300, shown in FIG. 3, the identifying metadata of data table representation 320 includes unique data table name 322, primary key data table column 324, and alternate key data table column 330.

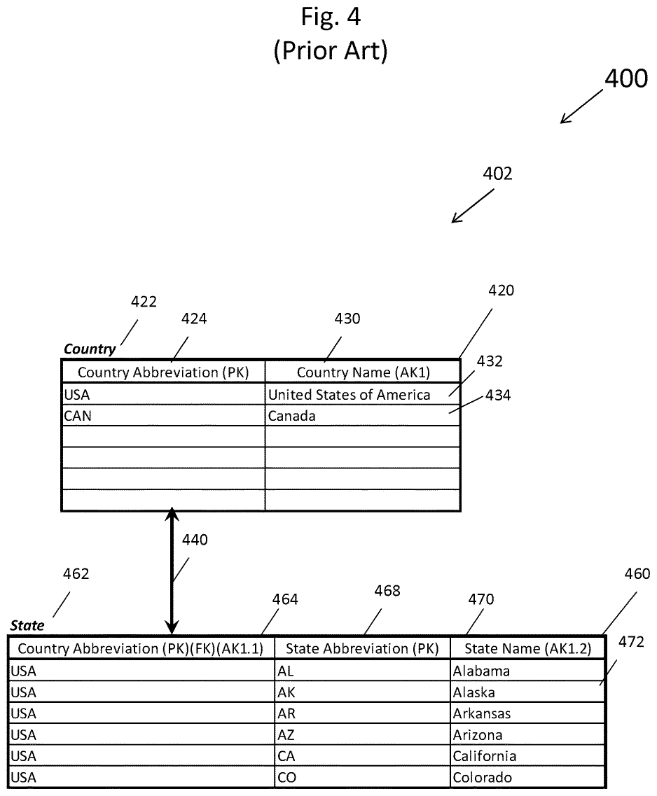

For instantiated database schemas, each database table normally has a set of identifying metadata that includes the unique database table name, the primary key index database table columns, and the alternate key index database table columns for any alternate key indexes. For example, in database schema 402 illustrated in FIG. 4, instantiated database table 420 includes identifying metadata unique database table name 422, primary key index database table column 424, and alternate key index database table column 430.

Master data domain—A master data domain is a single subject area of master data typically found at the border of a dataset. Each dataset has several master data domains that identify people, places, things, and time for example.

Peer data registry—A peer data registry is a new phrase or term, coined by the inventor and introduced by this patent application and was not used in the prior art. A peer data registry representation can be defined in a peer data table representation of a peer PDMD as the architected single source of data content records for use in the peer data table representations in other peer PDMDs. The peer data registry representation provides a architectural plan for a unique set of data content records to enforce peer dataset content commonality among peer data table representations and peer dataset connector representation representations joined by a single peer key constraint. For example, in PDMD 630 shown in FIG. 6, peer data table representation 636 is a peer data registry representation. Peer data registry representation 636 is architected to enforce peer dataset content commonality among peer dataset connector representation 666 of PDMD 660, and peer dataset connector representation 686 of PDMD 680, which are joined by single peer key constraint 678.

An instantiated peer data registry is typically dataset instantiated from a peer data table representation of the data registry in the peer PDMD of a data architecture model. The main function of the instantiated peer data registry is to be the central repository of both identifying and non-identifying data content records for the peer database tables that are related by the peer dataset access paths. For example, in peer database schema 730 shown in FIG. 7, peer database table 736 is the instantiated peer data registry for enforcing external referential data integrity for peer dataset access path 762. Peer database table 736 is the central repository of both identifying and non-identifying data content for peer database tables 766 and 786. Instantiated peer dataset connectors only contain identifying data content needed to support both instantiated foreign key constraints and peer dataset access paths. Beyond the unique identifying database table columns, the instantiated peer data registry is also the single source of non-identifying database table columns data content that is architected to be shared across instantiated peer datasets.

Peer database table—A peer database table is a new phrase or term, coined by the inventor. A peer database table of a peer database schema is a database table that is specifically architected to be used in multiple database schemas to provide peer dataset access paths between the multiple database schemas. A set of peer database tables have identifying metadata commonality as they are derived from a common antecedent logical ERD data entity of a data architecture model. Also, an instantiated peer dataset connector is a special type of peer database table where only the identifying database table columns are used. For example, peer database tables 736, 766, and 786 of FIG. 7 are a set of peer database tables as they were dataset instantiated from data table representation 636 along with peer dataset connector representations 666 and 686 of PDMDs 630, 660, and 680 respectively, shown in FIG. 6. Data table representation 636 and peer dataset connector representations 666, and 686 were all derived analogs from data entity 606 of logical ERD 602 shown in FIG. 6. When a set of peer database tables are populated with data content records, peer dataset content commonality is enforced typically by using a peer database table as an instantiated peer data registry for the other peer database tables. In this example, the peer database table 736 of FIG. 7 functions as the instantiated peer data registry for other peer database tables 766 and 786. Peer dataset access path 762 connects peer database tables 736, 766, and 786 of FIG. 7, which provides direct dataset interoperability among peer database schemas 730, 760, and 780 respectively. Peer dataset access path 762 of FIG. 7 was architected, forward-engineered, and dataset instantiated from peer key constraint 678 of FIG. 6.

Peer dataset—A peer dataset is a new phrase or term, coined by the inventor. A peer dataset is architected and implemented to support direct dataset interoperability with other instantiated peer datasets. A peer dataset is configured to support peer dataset commonality where both peer identifying metadata commonality and peer dataset commonality are architected typically using a data architecture model and a data architecture modeling software program.

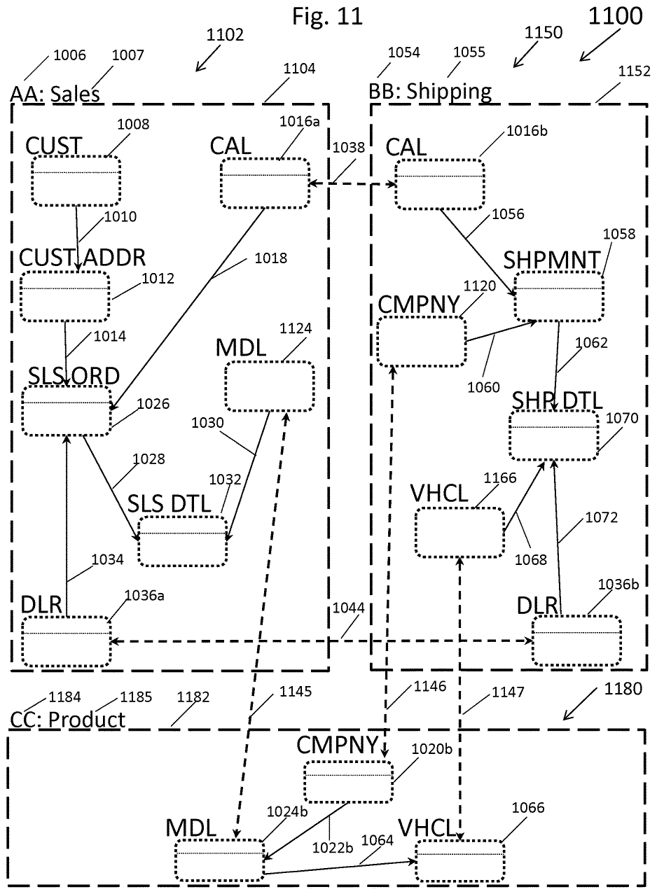

When the peer dataset of a data architecture model are dataset instantiated, as peer database schemas, for example, data content records from a first peer database schema may be directly joined, using peer dataset access paths, with data content records from any other peer database schema. With the addition of peer dataset connector representations to PDMDs, dependent peer dataset representations, and independent peer dataset representations can be dataset instantiated by a DBMS software program as peer database schemas. These instantiated datasets may then be connected by peer dataset access paths to form complete datasets. For example, in FIG. 11, the independent peer PDMD 1180 is architected to be shared by dependent peer PDMDs 1102 and 1150. In this example, a complete dataset is formed by combining the instantiated peer dataset, which is dataset instantiated from independent peer PDMD 1180, with the instantiated dependent peer dataset which is dataset instantiated from dependent peer PDMD 1102. A second complete dataset is formed by combining the instantiated independent peer dataset, which was dataset instantiated from independent peer PDMD 1180, with the instantiated dependent peer dataset which is dataset instantiated from dependent peer PDMD 1150. Complete datasets are formed when an instantiated dependent peer dataset has been connected by peer dataset access paths with its instantiated independent peer datasets.

Peer dataset, dependent—A dependent peer dataset is a new phase or term coined by the inventor, introduced in this patent application, and was not used in the prior art. A dependent peer dataset is a single-use peer dataset component that is often used in conjunction with one or more independent peer datasets. The dependent peer dataset is architected in a dependent peer PDMD in conjunction with independent peer PDMDs. For example, dependent peer database schema 760 shown in FIG. 7 is an example of a dependent peer dataset. Dependent peer database schema 760 shown in FIG. 7, was dataset instantiated from dependent peer PDMD 660 shown in FIG. 6. Instantiated peer dataset connectors are used to directly join a dependent peer dataset to its related independent peer datasets for access to share master data content records. For example, in data architecture schema 700 of FIG. 7, peer dataset connector representation 766 of dependent database schema 760 is joined with peer database table 736 of independent peer database schema 730 by peer dataset access path 762.

Peer dataset, independent—An independent peer dataset is a new phrase or term, coined by the inventor and introduced by this patent application and was not used in the prior art. An independent peer dataset is a reusable peer dataset component that functions as a single shared source of unique data content records for a group of two or more dependent peer datasets. The independent peer dataset is typically architected as an independent peer PDMD for a specific master data domain and is often referred to as an instantiated peer data registry. For example, independent peer database schema 730, shown in FIG. 7, is the instantiated peer data registry for dependent peer database schemas 760 and 780. Independent peer database schema 730 of FIG. 7 was architected and dataset instantiated from independent peer PDMD 630 shown in FIG. 6. Instantiated peer dataset connectors are used to directly join an independent peer dataset to dependent peer datasets that often need to share master data content records from that specific master data domain. For example, in data architecture schema 700 of FIG. 7, peer database table 736 of independent peer database schema 730 is joined with peer dataset connector representation 766 of dependent database schema 760 by peer dataset access path 762.

Peer dataset access path—A peer dataset access path is a new phase or term coined by the inventor. A peer dataset access path is a configured join between two or more peer datasets. Peer dataset access paths are architected in peer PDMDs as peer key constraints joining two or more peer data table representations or peer dataset connector representations. Each peer key constraint must be architected to enforce peer dataset content commonality when the peer PDMDs are dataset instantiated. Peer data content commonality is typically enforced using an instantiated peer data registry. With peer dataset commonality, peer dataset access paths provide a reliable join for combining data content records from two or more directly interoperable datasets.

A peer dataset access path is much different from a foreign key data access path. For example, a foreign key data access path joins at most two database tables within a database schema using a primary key index in the parent database table and a foreign key index in the child database table. In contrast, a peer dataset access path joins two or more peer database schema using peer database tables and instantiated peer dataset connectors. A peer dataset access path uses only unique key indexes such as primary key indexes and alternate key indexes. Foreign key indexes are used with foreign key data access paths and not with peer key dataset access paths.

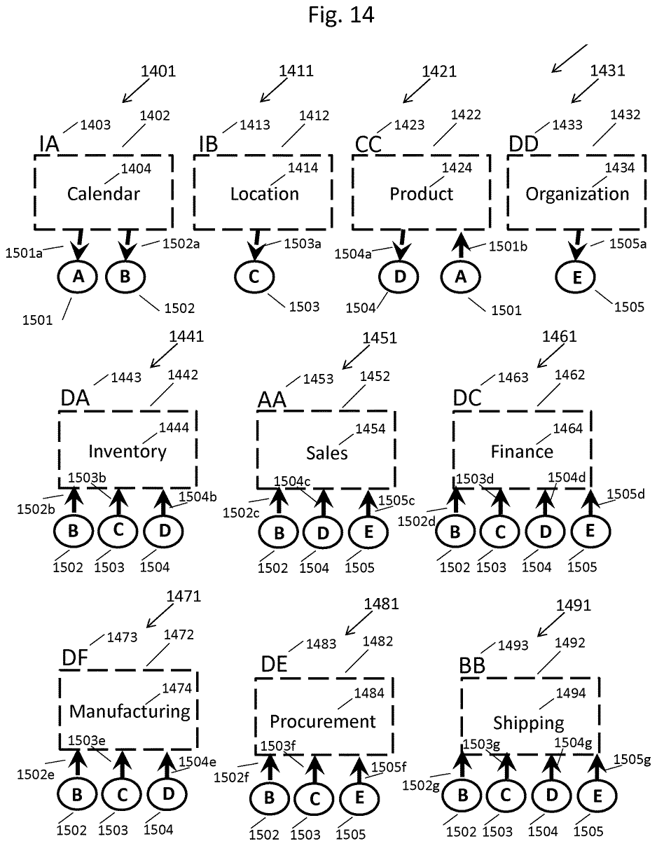

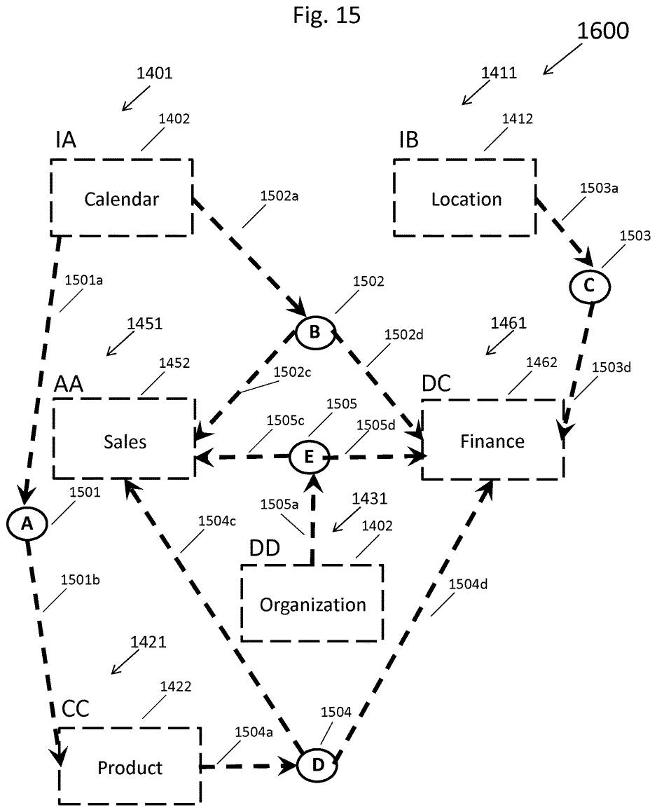

Peer dataset architecture map—A peer dataset architecture map is a diagram of independent and dependent peer PDMD representations used to map how peer PDMDs can be joined using their associated peer key constraints. For example, in FIG. 14, a series of peer PDMD representations are shown along with their associated peer key constraint representations. Each peer key constraint representation is assigned an identifier such that only peer key constraint representations with the same identifier may be joined together. A possible result of joining peer PDMD representations is depicted in FIG. 15.

The peer dataset architecture map is also useful for dataset instantiated peer datasets that were instantiated from the data architecture model. Instantiated peer datasets can be joined using established peer dataset access paths that result from the peer key constraints of the peer PDMD that are represented in the peer dataset architecture map.

Peer dataset commonality—Peer dataset commonality is a new phrase or term, coined by the inventor and introduced by this patent application and was not used in the prior art. Peer dataset commonality is a permanent combination of peer identifying metadata commonality and peer dataset content commonality among a set of instantiated peer datasets. It is the peer dataset commonality that enforces external referential data integrity among a group of instantiated peer datasets while forming peer dataset access paths to join the group of instantiated peer datasets.

Peer dataset commonality is architected in the PDMDs of a data architecture model. In PDMDs, peer dataset commonality is represented in the PDMD as peer key constraints that join peer data table representations and peer dataset connector representations. The joined peer data table representations and peer dataset connector representations must be analogs of a single data entity from a logical ERD. For example, in data architecture model 600 of FIG. 6, peer dataset commonality is architected for PDMDs 630, 660, and 680. Peer data table representation 636, and peer dataset connector representations 666, and 686 of PDMDs 630, 660, and 680 respectively, are analogs of data entity 606 of logical ERD 602 as shown in FIG. 6. Peer key constraint 678 joins peer data table representation 636 and peer dataset connector representations 666 and 686.

When peer datasets are dataset instantiated, it is the peer dataset commonality that enforces external referential data integrity between peer datasets and produces and maintains peer dataset access paths among instantiated peer datasets such as peer dataset access paths 1338, 1344, and 1348 that exist among instantiated peer database schemas 1302, 1350, 1380, and 1394 of data architecture schema 1300 as represented in FIG. 13.

Peer dataset connector—A peer dataset connector is a new phrase or term, coined by the inventor and introduced by this patent application and was not used in the prior art. A peer dataset connector representation is a PDMD object that is the derived analog of a logical ERD data entity, but that only includes data architect-selected unique key data table columns. A peer dataset connector representation in a dependent peer PDMD is normally used in combination with a peer data table representation, in an independent peer PDMD, where the peer data tables have the complete set of data table columns. A peer dataset connector representation typically functions as a substitute for a peer data table representation within a dependent peer PDMD. The peer dataset connector representation is a reusable dependent peer PDMD object, typically used to enforce peer key constraints without the overhead of non-identifying data table columns that would carry redundant data content. The peer dataset connector representation is used as the substitute for a parent data table representation to support foreign key constraint representations within a dependent peer PDMD. The same peer dataset connector representation also supports peer key constraints that connect peer PDMDs. Peer dataset connector representations can be used in accordance with one or more embodiments of the present invention in conjunction with a peer data table representation that is an analog of the same data entity in the antecedent logical ERD. For example, peer data table representation 1020b in independent peer PDMD 1180 in FIG. 11 is used in conjunction with peer dataset connector representation 1120 in dependent peer PDMD 1150 of FIG. 11. Peer data table representation 1020b and peer dataset connector representation 1120 are both analogs of data entity 920 of logical ERD 902 which is shown in FIG. 9. Peer dataset connector representation 1120, the substitute peer data table representation for peer data table representation 1020b, is the parent data table representation to foreign key constraint representation 1060 in dependent peer PDMD 1150 while also supporting peer key constraint 1146 as illustrated in FIG. 11.

When a peer dataset connector representation is dataset instantiated, the instantiated peer dataset connector typically becomes a peer database table in a dependent peer database schema. For example, peer database table 766 of dependent peer database schema 760 in data architecture schema 700 shown in FIG. 7, results from the dataset instantiation of peer dataset connector representation 666 of dependent peer PDMD 660 as shown in data architecture model 600 of FIG. 6.

Peer dataset content commonality—Peer dataset content commonality is a new phrase or term, coined by the inventor and introduced by this patent application and was not used in the prior art. Peer dataset content commonality ensures that multiple peer datasets share a common set of data content records. Peer dataset content commonality is configured in peer PDMDs of a data architecture model. When a peer key constraint is added to a group of peer data table representations that are analogs of a single data entity, the peer key constraint indicates that the group of peer data table representations needs to ensure peer dataset content commonality when the data table representations are dataset instantiated.

Peer dataset content commonality is a constraint on data content records across instantiated peer datasets, such as peer database schemas, to ensure that peer data content records have equivalent data values for the identifying metadata of the peer database tables where needed. For example, peer database tables 766, and 786 of peer database schemas 760, and 780 respectively, as shown in FIG. 7, have peer dataset content commonality. Data content records 777, and 797 of peer database tables 766, and 786 respectively are equivalent as represented in FIG. 7, for example. Peer dataset content commonality depends upon the consistent unique identification of data content records among instantiated peer datasets.

Peer identifying metadata commonality—Peer identifying metadata commonality is a new phrase or term, coined by the inventor. Peer identifying metadata commonality can be architected in data architecture models and can be dataset instantiated in multiple datasets such as database schemas. Peer identifying metadata commonality can be architected in multiple logical ERDs where each logical ERD contains a data entity with the same identifying metadata and are linked by a peer data entity relationship. Peer identifying metadata commonality is also architected in multiple PDMDs as depicted in PDMDs 630, 660, and 680 shown in FIG. 6. For example, data table representation 636 along with peer dataset connector representations 666 and 686 of PDMDs 630, 660, and 680 respectively have equivalent identifying metadata as shown in FIG. 6. Since data table representation 636, peer dataset connector representation 666, and peer dataset connector representation 686 are all analogs of data entity 606 of logical ERD 602, they share peer identifying metadata commonality.

When peer data table representations and peer dataset connector representations are dataset instantiated within their peer database schemas, the resulting peer database tables have peer identifying metadata commonality as illustrated in FIG. 7. Peer database table 736 of peer database schema 730 of FIG. 7 results from dataset instantiation of peer data table representation 636 of PDMD 630 shown in FIG. 6. Instantiated peer dataset connector 766 of peer database schema 760 of FIG. 7 results from dataset instantiation of peer dataset connector representation 666 of PDMD 660 shown in FIG. 6. Peer database table 736 of peer database schema 730 and instantiated peer dataset connector 766 of peer database schema 760 have peer identifying metadata commonality as shown in FIG. 7.

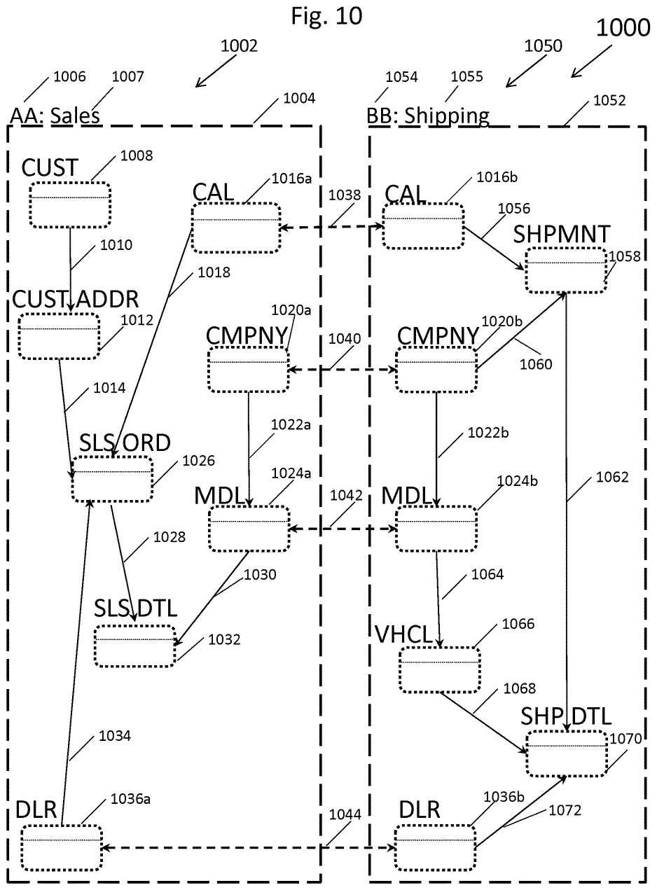

Peer key constraint—A peer key constraint is a new phrase or term, coined by the inventor and introduced by this patent application and was not used in the prior art. A peer key constraint is a data architecture modeling object used with multiple peer PDMDs to represent the peer dataset commonality in the peer PDMDs. For example, peer key constraint 1038 of peer PDMDs 1002 and 1050 depicted in FIG. 10, indicates that peer dataset commonality is architected for peer data table representations 1016a and 1016b in peer PDMDs 1002 and 1050, respectively. Each peer key constraint is associated with the identifying metadata specific to each peer data table representation in a set of peer data table representations. A peer key constraint is used in peer PDMDs to join data table representations that are analogs of a single data entity from a logical ERD.

There are at least three classes of peer key constraints that depend on which types of peer data table representations are constrained. When a peer key constraint constrains multiple peer data table representations, the peer key constraint is balanced. For example, peer key constraint 1038 shown in FIG. 12 is a balanced peer key constraint since it constrains peer data table representations 1016a and 1016b. When a peer key constraint constrains a combination of peer data table representations and peer dataset connector representations, that peer key constraint is unbalanced. For example, peer key constraint 1244 of FIG. 12 is an unbalanced peer key constraint as it constrains peer data table representation 1236c along with peer dataset connector representations 1236a and 1236b. When a peer key constraint constrains a set of peer dataset connector representations, that peer key constraint is classified as complex. For example, complex peer key constraint 1248, constrains only peer dataset connector representations such as peer dataset connector representations 1286a, 1286b, and 1286c.

A dataset instantiated peer key constraint from peer PDMDs results in a peer dataset access path that constrains the data content records of multiple datasets in instantiated peer database tables of multiple peer database schemas. For example, in data architecture schema 700 shown in FIG. 7, peer dataset access path 762 constrains peer database tables 766 and 786. That is, peer database tables 766, and 786 of dependent peer database schemas 760 and 780 respectively, have their data content records constrained by the data content records of peer database table 736 of independent peer database schema 730.

Peer key constraint rules—Peer key constraint rule is a new phrase or term, coined by the inventor and introduced by this patent application and was not used in the prior art. A peer key constraint rule is architected in the peer PDMDs to indicate which unique keys from each set of peer data table representations are needed to support the peer key constraint that relates to these peer data table representations. For example, peer data table representation 636 along with peer dataset connector representations 666 and 686 in peer PDMDs 630, 660, and 680 respectively, are related by peer key constraint 678 as depicted in FIG. 6. Each peer data table representation and peer dataset connector representation contain both a primary key (PK) and a composite first alternate key (AK1.x). The peer key constraint rule for this example is that both the primary and the first alternate unique keys are needed, as a couple, to support peer key constraint 678. However, in some cases, only the primary key is required, while in other cases, only an alternate key is required. There can be cases where more than two unique keys are used in the peer key constraint rule.

When the peer PDMDs are dataset instantiated, the peer key constraint rule must be enforced to ensure peer dataset commonality across instantiated peer datasets for both the instantiated peer dataset connectors and their associated peer database tables.

Physical Data Model Diagram (PDMD)—A PDMD is a commonly used term to represent a graphical depiction of a dataset configuration that includes data table representations and foreign key constraint representations that can be displayed on the display device 6 or stored in computer memory 8 of the apparatus 100 of FIG. 1. Typically, a PDMD is derived from a single logical ERD and stored in the same data architecture model as that logical ERD. Each PDMD is associated with a physical data environment into which the architected dataset will be dataset instantiated. In at least one embodiment of this invention, there are several types of PDMDs. A peer PDMD type represents a complete dataset that includes the independent master data along with the dependent facts and measures data. A dependent peer PDMD type typically contains peer dataset connector representations. An independent peer PDMD type normally contains reusable peer data table representations that directly connect to peer dataset connector representations of dependent peer PDMDs. For example, peer PDMDs 1002 and 1050 shown in FIG. 10 are both complete peer PDMDs as neither peer PDMD 1002 nor 1050 contain peer dataset connector representations. All peer key constraints, such as peer key constraints 1038, 1040, 1042, and 1044, join peer data table representations. As shown in FIG. 11, dependent peer PDMDs 1102 and 1150 are both dependent peer PDMDs because each contains at least one peer dataset connector representation; peer dataset connector representations 1124 and 1120 of dependent peer PDMD 1102 and 1150 respectively. Independent peer PDMD 1180, shown in FIG. 11, is an independent peer PDMD because it only contains border data table representations 1020b, 1024b, and 1066. The goal of the dependent peer PDMDs and the independent peer PDMDs is to limit the data redundancy across multiple PDMDs.

Physical data environment specification—A physical data environment specification is a data architecture model object used in PDMDs. In this patent application, a physical data environment specification is graphically depicted by a rectangle composed of dashed lines, such as physical data environment specifications 1004 and 1052 represented in FIG. 10. The physical data environment name is displayed above the upper left corner of the dashed line rectangle, such as physical data environment name 1006, which is “AA” and 1054, which is “BB” of physical data environment specification 1004 and 1052 respectively also depicted in FIG. 10. Each PDMD may have only one physical data environment specification. The physical data environment specification contains metadata stored in the data architecture model that details the specific hardware and software environment into which a PDMD will be dataset instantiated. This metadata includes details such as the computer hardware specifics, the operating system specifics, and the application software program specifics that adequately define the actual physical data environment. While each physical data environment specification is typically associated with one PDMD, the physical data environment specification may contain multiple dataset representations. For simplicity in this patent application, each physical data environment specification contains only one dataset representation.

Primary key (PK)—In the logical ERD of a data architecture model, the prior art primary key of a given data entity is the architected primary method of uniquely identifying data instances within that data entity. A primary key is comprised of one or more data attributes within a data entity that are declared by a data architect in a data architecture model of a data architecture modeling software program executing on computer processor 4 which is programmed to store the declared primary key in computer memory, such as computer memory 8 of FIG. 1. In a PDMD, the primary key of the antecedent data entity becomes a primary key in the analog data table representation. The primary key of a data table representation analog is used as a means of rapidly selecting unique data content records. When the primary key of a first data table representation in a PDMD is dataset instantiated, it becomes the primary key index which is a unique key index placed on a database table, where the database table was dataset instantiated from the first data table representation of a PDMD.

Referential data integrity, internal—Enforcement of internal referential data integrity is a prior art process, often managed by the DBMS, which is used to ensure the consistency and integrity of data values stored within a computer memory. Internal referential data integrity is related to joining data content records stored in a database table of a first database schema to the data content records stored in another database table of the first database schema such as two database tables related by a dataset instantiated foreign key constraint.

Referential data integrity, external—Enforcement of external referential data integrity is introduced in this patent application. External referential data integrity is related to joining data content records stored in a database table of a first database schema to the data content records stored in another database table of a second database schema such as two database tables related by a dataset instantiated peer dataset access path. External referential data integrity is enforced between multiple peer database tables where each peer database table is from a different database schema. For example, in data architecture schema 700 shown in FIG. 7, peer dataset access path 762 is used to enforce external referential data integrity between peer database table 736 of database schema 730, and peer database table 766 of database schema 760, and peer database table 786 of database schema 780.

Unique key index—A unique key index is a prior art data object used to constrain the set of data values for a database table of a database schema or for a dataset data file stored in one or more computer memories, wherein no duplicate data values are allowed in the unique key index. For each unique key index, the combination of indexed data values for each data content record must form a unique key index entry for that database table of a database schema or dataset data file. Any attempts to form a duplicate combination of data values for any unique key index will be rejected by the computer software programmed to reject duplicate data values, such as executed by the computer processor 4. Unique key indexes are architected as unique keys in the logical ERD and in the PDMD of the data architecture model. When a unique key of a data table representation is forward-engineered and dataset instantiated, the unique key forms a unique key index in the resulting database table in the database schema. Unique key indexes are typically enforced by the DBMS software program that manages the database table components of the database schema.

Unique Key—A unique key, such as a primary key or an alternate key, is declared in a logical ERD on one or more data attributes of a data entity. When the data entity is used to derive a data table representation in a PDMD, the unique keys of the antecedent data entity of the logical ERD will be declared as unique keys in the analog data table representation of the PDMD as well. When the unique keys of a data table representation of a PDMD are dataset instantiated, the unique keys will be instantiated as unique key indexes in the resulting database table of the database schema. For example, in data architecture model 600 shown in FIG. 6, data entity 606 of logical ERD 602 contains two unique keys. The two unique keys are the primary key comprised of data attribute 610 and the first alternate key comprised of data attributes 612, 614, and 616 of data entity 606. In PDMD 630 of data architecture model 600, data table representation 636 is an analog of data entity 606 of logical ERD 602. In data table representation 636, two unique keys are shown. The first unique key is the primary key comprised of data table column 640 which is the analog of data attribute 610 of data entity 606 of logical ERD 602. The second unique key of data table representation 636 is comprised of data table columns 642, 644, and 646, which are analogs of data attributes 612, 614, and 616 respectively of data entity 606 as shown in FIG. 6. Database table 736 of database schema 730 shown in FIG. 7, is dataset instantiated from data table representation 636 of PDMD 630 shown in FIG. 6. Database table 736 has two unique key indexes as shown in FIG. 7. The first unique key index is the primary key index comprised of database table column 740, which was dataset instantiated from data table columns 640 of data table representation 636 shown in FIG. 6. The second unique key index of database table 736, shown in FIG. 7, is comprised of database table columns 742, 744, and 746 which were dataset instantiated from data table columns 643, 644, and 646 respectively of data table representation 636 shown in FIG. 6.

FIG. 1 shows a block diagram of apparatus 100 in accordance with an embodiment of the present invention. Apparatus 100 includes an interactive device 2, a computer processor 4, a display device 6, a computer memory 8, and a computer network 10. Computer memory 8 may include any type of computer memory, including long-term memory such as disk memory, in addition to computer random access memory which may lose its values when power is removed. The computer memory 8 may include one or more computer memories. Computer network 10 is used to provide a communication link to one or more other computer processors and their associated devices and computer memory. The interactive device 2, the display device 6, the computer memory 8, and the computer network 10 communicate with the computer processor 4 via communications links 2a, 6a, 8a, and 10a, respectively, which may be electronic, computer software, optical, wireless or any other type of communications links. The computer processor 4 may be programmed by computer software to implement the method of data model development and peer dataset instantiation in accordance with one or more embodiments of the present invention to produce data models and instantiated peer datasets in the computer memory 8, such as shown in FIG. 1.

FIG. 2 shows logical ERD (entity-relationship diagram) 202 of data model 200. Logical ERD 202 can be created by a computer user using a data modeling software program, and the logical ERD can be stored within data model 200 in computer memory 8 of FIG. 1. The logical ERD 202 contains two data entities, data entities 220 and 260, related by a single data entity relationship 240 that connects these two data entities. In this representation of a logical ERD, logical ERD 202, each of data entities 220 and 260 are represented by a rounded-corner rectangle. In contrast, the data entity relationship 240 is represented by a line terminated with a filled circle 242. Each data entity requires a unique data entity name. For example, data entity 220 has data entity name 222 with a unique value, within logical ERD 202, of ‘Country,’ while data entity 260 has data entity name 262 with a unique value of ‘State.’ Each data entity, such as data entities 220 and 260, represents a group of related data attributes, such as data attribute 230, labeled “Country Name”, and data attribute 224, labeled “Country Abbreviation”, for data entity 220. In this notation of data entities, the data attributes above a line in the rounded-corner rectangle, for example, above line 226 for data entity 220, are declared to be the primary key of the data entity. Each data entity's primary key data attributes are also denoted by the (PK), which follows the name of the data attribute. This primary key is a declared unique identifier for the data entity. In data entity 220, data attribute 224 is denoted by the (PK) as the primary key of data entity 220. In addition to the data entity's declared primary key, each data entity may have zero, one or more alternate keys defined. In FIG. 2, data entities 220 and 260 each contain a single alternate key denoted by the (AK) following the alternate key's data attributes. In data entity 220, the alternate key is declared by a computer user using a data modeling software program upon the single data attribute 230, which is labeled “Country Name” and stored in computer memory 8. The designation for the single alternate key data attribute 230 is (AK1), which indicates this is the first alternate key of data entity 220. In data entity 260, the alternate key is a composite alternate key comprised of the data attribute 264, labeled “Country Abbreviation”, and data attribute 270, labeled “State Name”. The alternate key designation for data attribute 264 is (AK1.1), which indicates this is the first data attribute of the first alternate key of data entity 260. The alternate key designation for data attribute 270 is (AK1.2), which indicates this is the second data attribute of the first alternate key of data entity 260.

The data entity relationships of logical ERDs, such as logical ERD 202, depict a join, normally between two data entities, that allow data attributes from a first data entity, such as data entity 220, to be related to data attributes from the second data entity, such as data entity 260. Under some circumstances, a data entity relationship joins one data entity to itself in what is often referred to as a recursive data entity relationship. Each data entity relationship joins at most two data entities.

Data entity relationship 240, shown in FIG. 2, joins the first data entity 220 to the second data entity 260. Note that data entity 260 contains data attribute 264, denoted by (FK). Data attribute 264, of data entity 260, is inherited from the primary key of data entity 220, which is data attribute 224. The data attribute inheritance is implemented by the data modeling software program executing on computer processor 4. This inheritance of a first data entity's primary key data attributes or one of that data entity's alternate key data attributes into a second data entity is referred to as a foreign key, thus the denotation of (FK). The data entity that donates unique key data attributes, such as data attribute 224 of data entity 220, is referred to as the parent data entity, while the data entity that inherits the data attributes, such as data attribute 264 of data entity 260, is referred to as the child data entity. Prior art data entity relationships are a parent-child type of data entity relationships where unique key data attributes are always inherited by the child data entity. In the case of the recursive data entity relationship, the parent data entity and the child data entity are the same data entity, but that data entity still inherits the unique key data attributes as foreign key data attributes.

Each data entity relationship is depicted graphically in logical ERDs of this patent application as a line that begins attached to a first data entity and ends with a filled circle attached to the dependent data entity. A data entity relationship causes the data architecture modeling software program to duplicate the primary key data attributes or to duplicate alternate key data attributes from a first data entity into the data entity that is dependent on that first data entity. These duplicated key data attributes do not exist in the dependent data entity prior to adding the data entity relationship. The computer processor 4 can be programmed by data architecture modeling computer software to permit a user via interactive device 2 to make data entity relationships between data entities. The user, via interactive device 2, may select which of a first data entity's key data attributes will be duplicated by the data architecture modeling computer software program. These duplicated key data attributes are referred to as foreign key data attributes in the dependent data entity. When a PDMD is derived from the logical ERD, each data entity relationship is converted to a foreign key constraint representation.

For this patent application, we use the modifier “antecedent” for data architecture model objects to indicate the source data architecture model object and the modifier “analog” for data architecture model objects to indicate the target data architecture model objects of a transformation or derivation. For example, when a PDMD is derived from a logical ERD, the PDMD is an analog of that specific source logical ERD. The logical ERD is the antecedent of that specific analog PDMD. In some instances, a logical ERD may result in multiple PDMDs which are all analogs of the same logical ERD.

FIG. 3 shows PDMD 302 of data model 300 (wherein data model 300 of FIG. 3 and data model 200 of FIG. 2, may together make up one data model). The PDMD typically exists within the same data model (such as in this case the combination of 200 and 300) as the logical ERD from which it is derived. In this case, PDMD 302 shown in FIG. 3 is derived from logical ERD 202 shown in FIG. 2, and both the logical ERD and the PDMDs are stored in a data model which is a combination of 200 and 300. In this example, PDMD 302 is derived and therefore is referred to as analog PDMD 302 of antecedent logical ERD 202.

Each PDMD, such as PDMD 302, is typically associated with a physical data environment specification. In FIG. 3, the physical data environment specification 310 is represented by a rectangle drawn with a dashed line. The physical data environment name 312 has a metadata name value of “PDE1.” Each PDMD is architected for dataset instantiation into an actual physical data environment, such as a specific DBMS software executing on a specific computer server executing a specific operating system. In this case, PDMD 302 is architected to be dataset instantiated into an actual physical data environment designated by physical data environment specification 310.

PDMD 302 can be created by a computer user using a data modeling software program, and the PDMD 302 can be stored in computer memory 8 of FIG. 1. The PDMD 302 contains two data table representations, data table representations 320 and 360, related by a single foreign key constraint representation 340. A data table representation can be a PDMD object represented in this patent application by a rounded-corner rectangle drawn with a dashed line, such as rectangle 320. The rounded-corner rectangle includes a dashed line drawn in the upper portion, such as dashed line 326 in rectangle 320. The rounded-corner rectangle, together with the dashed line, represents the data table representation object of a PDMD. A foreign key constraint representation can be a PDMD object, represented in this patent application as a dashed line with an arrowhead pointing to the dependent data table representation. An example of the PDMD foreign key constraint representation is line 340 with arrowhead 342 pointing at dependent data table representation 360 as depicted in PDMD 302 of FIG. 3.

Data table representation 320 of PDMD 302 in FIG. 3 is derived from data entity 220 of logical ERD 202 shown in FIG. 2. In this example, analog data table representation 320 is derived from antecedent data entity 220. Data table representation 360 of PDMD 302 in FIG. 3 is derived from data entity 260 of logical ERD 202 shown in FIG. 2. Foreign key constraint representation 340 of PDMD 302 shown in FIG. 3 is derived from data entity relationship 240 of logical EDR 202 shown in FIG. 2. In this example, analog foreign key constraint representation 340 was derived from antecedent data entity relationship 240.

Typically, each data table representation, such as data table representation 320 in PDMD 302, inherits its data table name from its antecedent data entity name. For example, data table name 322 of PDMD 302 with a metadata value of ‘Country’, was derived from its antecedent data entity name 222 of logical ERD 202, shown in FIG. 2. Data table name 362 of PDMD 302 with a metadata value of “State”, was inherited from data entity name 262 of logical ERD 202 as depicted in FIG. 2. Data table names must be unique within each PDMD.

Data table columns, such as data table columns 324 and 330, compose data table representation 320 of PDMD 302 as shown in FIG. 3. The data table columns of a data table representation in a PDMD are derived from the data attributes of a data entity in a logical ERD. For example, data table columns 324 and 330 of data table representation 320 in PDMD 302 are derived from data attributes 224 and 230, respectively, of data entity 220 in logical ERD 202, shown in FIG. 2.

Data table keys of a data table representation are also designated in the PDMD. Each data table key is declared on one or more data table columns of a data table representation. The data table keys of a data table representation in a PDMD are designated as primary key (PK), alternate key (AK), and foreign key (FK). The primary key and alternate key are unique keys within the data table representation, while the foreign keys are typically nonunique keys within the data table representation. Each data table representation can have only one primary key but multiple alternate and foreign keys. For example, in PDMD 302 shown in FIG. 3, data table representation 360 has one primary key, one alternate key, and one foreign key. The one primary key is a unique composite key comprised of data table columns 364 and 368 in data table representation 360. Both data table columns 364 and 368 contain the (PK) designation indicating these are primary key data table columns of the data table representation 360. The one alternate key is also a unique composite key comprised of data table columns 364 and 370 in data table representation 360. Data table column 364 contains the (AK1.1) designation indicating that it is the first data table column of the first alternate key in data table representation 360. Data table column 370 includes the (AK1.2) designation indicating that it is the second data table column of the first alternate key in data table representation 360. The one foreign key in data table representation 360 is a nonunique single data table column key comprised of data table column 364 in data table representation 360. Data table column 364 includes the (FK) designation indicating that data table column 364 of data table representation 360 is inherited from another data table representation. In this case, foreign key constraint representation 340 indicates that the inherited data table column 364 of data table representation 360 is inherited from data table column 324, which is the primary key of data table representation 320 as shown in FIG. 3

Typically, the data table representations of a PDMD are dataset instantiated into a specific actual physical data environment where the data table representations become storage locations for the instantiated dataset within the actual physical data environment. The PDMD foreign key constraint representations, when dataset instantiated, enforce internal referential data integrity within the instantiated dataset or database schema.

FIG. 4 shows database 400 which contains database schema 402 that results from the dataset instantiation of PDMD 302 shown in FIG. 3. Database schema 402 is a part of database 400 in one or more computer memories, such as computer memory 8 of FIG. 1. Database schema 402 was designated as the database schema for dataset instantiation of PDMD 302 within physical data environment specification 310 of PDMD 302 as depicted in FIG. 3.

Dataset instantiation can be computer-user initiated using a data modeling software program where the dataset instantiation is implemented by a DBMS. Both the data modeling software program and the DBMS can be executed in one or more computer processors, such as computer processor 4 of FIG. 1, and the database schema objects are stored in one or more computer memories, such as computer memory 8 of FIG. 1.

Databases tables 420 and 460, depicted in FIG. 4, are dataset instantiated into database schema 402, in computer memory, such as computer memory 8, from data table representations 320 and 360, respectively, of PDMD 302 shown in FIG. 3. Database table columns 424 and 430 of database table 420 shown in FIG. 4, are dataset instantiated from data table representation 320 data table columns 324 and 330 respectively of DPMD 302 shown in FIG. 3. Database table name 422 “Country” for database table 420 in database schema 402, is derived from data table name 322 of data table representation 320 in PDMD 302 as shown in FIG. 3. Database table name 462 “State” for database table 460 in database schema 402 of FIG. 4, is forward-engineered and dataset instantiated from data table name 362 of data table representation 360 as shown in PDMD 302 as shown in FIG. 3.

The primary key index of database table 420 in database schema 402 is based upon database table column 424 of FIG. 4, which is dataset instantiated from primary key data table column 324 in data table representation 320 of PDMD 302 shown in FIG. 3. The primary key index for database table 460 in database schema 402 is a unique composite index based upon database table columns 464 and 468 of FIG. 4. This composite primary key index was dataset instantiated from primary key data table columns 364 and 368 in data table representation 360 of PDMD 302 shown in FIG. 3.

Beyond the database tables, instantiated foreign key constraints are another important type of database schema object that is dataset instantiated into a relational database schema. Instantiated foreign key constraint 440 of database schema 402, shown in FIG. 4, is dataset instantiated from foreign key constraint representation 340 of PDMD 302, shown in FIG. 3. Instantiated foreign key constraint 440, of database schema 402, shown in FIG. 4, is dataset instantiated to maintain internal referential data integrity between database table column 424 of database table 420 and database table column 464 of database table 460 as represented in FIG. 4. Internal referential data integrity is normally maintained by a DBMS software program executing in a computer processor such as computer processor 4 of FIG. 1. Once a foreign key constraint representation is dataset instantiated, the DBMS computer software program executed by the computer processor 4 and stored in computer memory 8 is programmed to enforce the internal referential data integrity rules for that dataset instantiated foreign key constraint.

In any relational database schema, instantiated foreign key constraints are essential. Instantiated foreign key constraints are used within a DBMS to maintain the internal referential data integrity of the data content records in the related database tables and provide bidirectional data access paths between database tables within a database schema. For example, in database schema 402, database table 420 contains two data content records 432 and 434 as depicted in FIG. 4. Database table 460 of database schema 402, contains several data content records including data content record 472 as shown in FIG. 4. Data content record 472 of dependent database table 460 has a foreign key column 464 with a data value “USA”. The data values of foreign key column 464 are dependent upon the data values of database table column 424 of database table 420 as shown in FIG. 4. Data content record 432 of database table 420 has a data value of “USA” for database column 424. Therefore, the data value “USA” is a valid data value for database column 464 of database table 460 for any data content record of database table 460 of database schema 402 from FIG. 4.

In at least one embodiment of the present invention, multiple instantiated datasets are evaluated to determine if they are disparate instantiated datasets or if they are instantiated peer datasets. Disparate instantiated datasets are often referred to as data silos as they lack referential data integrity enforcement between them. Prior art data modeling methods configure disparate dataset representations that lack identifying metadata commonality and instantiated peer dataset content commonality. When the disparate dataset configurations are dataset instantiated, the result is instantiated disparate datasets.

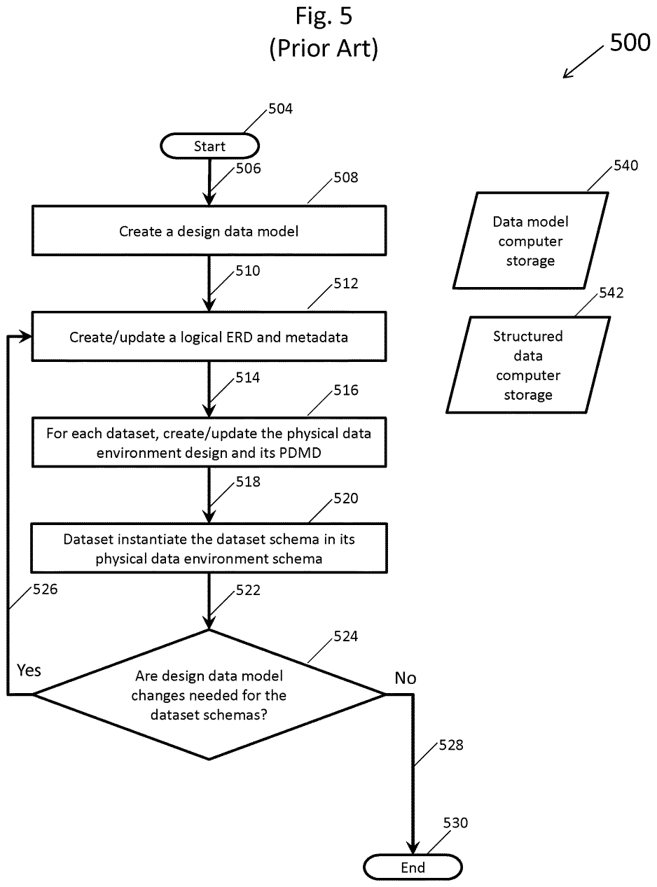

FIG. 5 represents flow chart 500 of a method for creating and updating a typical data model, such as the data model, which is a combination of 200 and 300, that includes logical ERD 202 and PDMD 302, as shown in FIG. 2 and FIG. 3, respectively. Flow chart 500 contains flow chart initiator 504, flow chart processes 508, 512, 516, and 520, flow chart decision 524, along with flow chart terminator 530. In addition, flow chart 500 depicts flow chart flows 506, 510, 514, 518, 522, 526, and 528, along with computer storage areas 540 and 542.

Computer storage areas, such as computer storage area 540, are storage areas that would be implemented in a computer memory such as computer memory 8 of apparatus 100 depicted in FIG. 1. These computer storage areas may also be accessible from other computers using a computer network such as computer network 10 depicted in apparatus 100 shown in FIG. 1. Computer storage area 540 of flow chart 500 depicted in FIG. 5, represents a storage area for the repository of metadata and data used for one or more data models. Computer storage area 540 would be managed by a data modeling software program. Computer storage area 542, of flow chart 500, depicted in FIG. 5, represents a computer storage area of structured data storage that may be used for database schema structures and for the data system data files of one or more data systems, for example. Access to computer storage area 542 for database structures could be controlled by a DBMS software executing on computer processor 4 also of apparatus 100 depicted in FIG. 1. Access to computer storage area 542 for data system data files of a specific data system would normally be controlled by computer software programmed specifically for that data system. For example, a DBMS software program can be used to manage database schemas and their database schema objects within computer storage area 542.

Flow chart 500 of FIG. 5, begins at flow chart initiator 504 which is typically started by a data architect and follows flow chart flow 506 to flow chart process 508. In flow chart process 508, the data architect using data modeling software executing on a computer processor, such as computer processor 4 of apparatus 100 depicted in FIG. 1, defines and configures a data model repository for creating and updating a data model. The data model repository is stored in computer storage area 540. Once flow chart process 508 has been completed to the satisfaction of the computer user, flow chart flow 510 is followed to flow chart process 512.

In flow chart process 512 of flow chart 500, the computer user creates or updates a logical ERD, such as logical ERD 202 shown in data model 200 of FIG. 2, and the associated logical ERD metadata. The associated logical metadata provides details for the logical ERD, such as the data content record storage requirements and the data domain values that are acceptable for specific data attributes. The data modeling software program is then used to store the architected and/or configured logical ERD and its logical ERD metadata in computer storage area 540. For example, a logical ERD, such as logical ERD 202, would be architected and modified within flow chart process 512. Once flow chart process 512 has been completed, flow chart flow 514 is followed to flow chart process 516 of flow chart 500, shown in FIG. 5.

In flow chart process 516 of flow chart 500, the computer user determines how many dataset representations should be derived from the logical ERD from flow chart process 512. A PDMD is created and maintained for each desired dataset representation, such as PDMD 302 in data model 300, shown in FIG. 3. Each PDMD is assigned to a physical data environment specification, such as physical data environment specification 310 of PDMD 302, shown in FIG. 3. Physical data environment specifications are typically defined within the data modeling software and stored in computer storage area 540. Each PDMD and its associated PDMD metadata is maintained by the computer user as needed. The associated PDMD metadata provides details for the PDMD, such as the types of indexes needed for efficient data content record retrieval. The data modeling software program is then used to store the architected and/or configured PDMD and its associated PDMD metadata in computer storage area 540. For example, PDMD 302 of FIG. 3, which is the analog of logical ERD 202 shown in FIG. 2, would be architected and modified in flow chart process 516. Once flow chart process 516 has been completed, flow chart flow 518 is followed to flow chart process 520 of flow chart 500, shown in FIG. 5.

In flow chart process 520 of flow chart 500, the computer user dataset instantiates the PDMD objects into its proper actual physical data environment. For example, PDMD 302, shown in FIG. 3, would be used to dataset instantiate the database schema 402, which is part of the database 400 shown in FIG. 4. Database 400 of FIG. 4 is architected in PDMD 302 within physical data environment specification 310, shown in FIG. 3.

The computer user typically uses the data modeling software application to generate the appropriate dataset instantiation instructions for dataset instantiation of its instantiated dataset into an actual physical data environment. For example, the computer user would select physical data environment specification 310, as represented in PDMD 302, as shown in FIG. 3. These dataset instantiation instructions can be for the entire instantiated dataset for the initial creation of the instantiated dataset or for a portion of the instantiated dataset for updates as selected by the computer user. The dataset instantiated instructions are typically forward-engineered by the data modeling software program based on the selected PDMD and its associated metadata. Typically, the computer user would then execute the dataset instantiation instructions using the software applications of the physical data environment specification to implement the desired instantiated dataset modifications. For example, a DBMS software program can execute the forward-engineered dataset instantiation instructions to create or modify a database schema. As a result, the instantiated dataset, such as physical database schema 402 shown in FIG. 4, is stored in computer storage area 542. Once flow chart process 520 has been completed, flow chart flow 522 is followed to flow chart decision 524 of flow chart 500, shown in FIG. 5.

In flow chart decision 524 of flow chart 500, the computer user decides if structural metadata changes are needed in the instantiated datasets. If structural metadata changes are required, flow chart flow 526 is followed to flow chart process 512. If the structural metadata for the instantiated datasets does not need refinement, flow chart flow 528 is followed to flow chart terminator 530.

In at least one embodiment of the present invention, any data entity from a logical ERD can be the antecedent to two or more peer data table representations or peer dataset connector representations in analog PDMDs. Each peer data table representation and peer dataset connector representation is uniquely identified within its physical data environment specification. Peer data table representations and peer dataset connector representations that are analogs of the same data entity need to be connected by a peer key constraint. When the peer key constraint is dataset instantiated, a peer dataset access path is formed.

FIG. 6 depicts data architecture model 600 with logical ERD 602 and peer PDMDs 630, 660, and 680. Logical ERD 602 contains data entity 606 with data entity name 608 with the metadata value of “ADDRESS”. Data entity 606 represents, in part, the location master data domain.

Data entity 606 contains data attributes 610, 612, 614, 616, 618, 620, and 622. Data attribute 610 is the primary key for data entity 606. Data attributes 612, 614, and 616 together comprise a first alternate key (AK1) of data entity 606. Data attribute 616 is the first data attribute of the composite alternate key (AK1.1), data attribute 614 is the second data attribute of the composite alternate key (AK1.2), and data attribute 612 is the third data attribute of the first composite alternate key (AK1.3) of data entity 606 of logical ERD 602 as illustrated in FIG. 6. In data entity 606, data attributes 610, 612, 614, and 616 are classified as identifying data attributes since they are used in unique keys such as primary key 610 and composite first alternate key 612, 614, and 616. In data entity 606 of data architecture model 600 as shown in FIG. 6, data attributes 618, 620, and 622 are classified as non-identifying data attributes of data entity 606 as they are not used in unique keys such as primary keys and alternate keys.

Peer PDMDs 630, 660, and 680 of data architecture model 600 are all derived from antecedent logical ERD 602 also of data architecture model 600 as shown in FIG. 6. The purpose of these peer PDMDs is to develop three peer dataset representations from data entity 606 that feature direct dataset interoperability through a peer key constraint.

Each peer PDMD, such as peer PDMD 630, contains a single physical data environment specification, such as physical data environment specification 632 of PDMD 630 as depicted in FIG. 6. Physical data environment specification 662 is contained in PDMD 660, and physical data environment specification 682 is contained in PDMD 680. Each physical data environment specification is uniquely identified by a physical data environment name and is further defined by the PDMD peer dataset domain. For example, PDMD 630 has a physical data environment name 634 with a metadata value of “DB1” and a PDMD peer dataset domain 635 with a metadata value of “Domain A”. The physical data environment name is separated from the PDMD peer dataset domain by a “:”. Peer PDMD 660 has a physical data environment name 664 with a metadata value of “DB2” and a PDMD peer dataset domain 665 with a metadata value of “Domain B”. Peer PDMD 680 has a physical data environment name 684 with a metadata value of “DB3” and a PDMD peer dataset domain 685 with a metadata value of “Domain C”.

Peer PDMD 630 contains peer data table representation 636, which is an analog of data entity 606 of logical ERD 602 as illustrated in FIG. 6.

Peer data table representations normally contain one data table column for each data attribute of its antecedent data entity. For example, peer data table representation 636 of PDMD 630 contains data table columns 640, 642, 644, 646, 648, 650, and 652, where each is the analog of data attributes 610, 612, 614, 616, 618, 620, and 622, respectively, of antecedent data entity 606 of logical ERD 602 in data architecture model 600 as illustrated in FIG. 6.

Peer data table representations normally contain all identifying data table columns as well as all non-identifying data table columns of its antecedent data entity as is the case in data table representation 636 of peer PDMD 630. Primary key data table column 640 and first alternate key data table columns 642, 644, and 646 of peer data table representation 636 are analog data table columns of primary key data attribute 610 and first alternate key data attributes 612, 614, and 616 respectively of antecedent data entity 606 shown in FIG. 6. Data table columns 648, 650, and 652 of data table representation 636 are non-identifying data table columns. Peer data table representation 636 is architected to function as a peer data registry representation for any peer dataset connector representations that are also analogs of data entity 606 of logical ERD 602 in data architecture model 600.

Analogs of data entity 606 of logical ERD 602 are peer dataset connector representations 666 and 686 contained in dependent peer PDMDs 660 and 680 respectively as shown in FIG. 6. Each peer dataset connector representation is represented by a dashed-lined rectangle with rounded corners. Unlike the data table representation representations, the peer dataset connector representation does not include a line to separate the primary key data table columns from the non-primary key data table columns.

Peer dataset connector representations normally contain only identifying data table columns because the non-identifying data table columns of data content are stored once in the peer data table representation and shared with any corresponding peer dataset connector representations as needed. For example, peer dataset connector representation 666 in dependent peer PDMD 660, contains primary key data table column 670 and first alternate key data table columns 672, 674, and 676 that are derived from antecedent data entity 606 primary key data attributes 610 and first alternate key data attributes, 612, 614, and 616, respectively, of logical ERD 602 shown in FIG. 6. Likewise, peer dataset connector representation 686 in dependent peer PDMD 680, contains primary key data table column 690 and first alternate key data table columns 692, 694, and 696 that are derived from antecedent data entity 606 primary key data attributes 610 and first alternate key data attributes, 612, 614, and 616, respectively, of logical ERD 602 shown in FIG. 6. In at least one embodiment of the current invention, identifying metadata in the peer PDMDs is important in architecting and instantiating peer datasets. The data table names in the peer PDMDs, such as data table name 638 of data table representation 636 in peer PDMD 630, uniquely identify each data table representation within their physical data environment specification such as physical data environment specification 632 shown in FIG. 6. The unique keys of each data table representation, such as primary key 640 of data table representation 636 in peer PDMD 630, are also identifying metadata as unique keys are architected to provide unique identification commonality of all data content records once data table representations have been dataset instantiated.

Peer data table representation 636 has a data table name 638 of “ADDRESS”, which must be a unique data table name within peer PDMD 630. Likewise, peer dataset connector representation 666 has a data table name 668 of “ADDRESS” which must be a unique data table name within peer PDMD 660. Also, peer dataset connector representation 686 has a data table name 688 of “ADDRESS”, which must be a unique data table name within peer PDMD 680.

Peer data table representations and peer dataset connector representations need to be uniquely identified within each data architecture model such as data architecture model 600 illustrated in FIG. 6. The complete unique name for peer data table representations and peer dataset connector representations is a combination of the unique environment name and the name of the peer data table representation or peer dataset connector representation. For example, the complete unique name for peer data table representation 636 is “DB1.ADDRESS” which is a combination of the physical data environment name 634, and the peer data table name 638 shown in peer PDMD 630. Likewise, the complete, unique name of peer dataset connector representation 666 is “DB2.ADDRESS” and for peer dataset connector representation 686 is “DB3.ADDRESS”.

The set of peer data table representation 636 and peer data connectors 666 and 686 in peer PDMDs 630, 660, and 680 respectively, couple both their primary key and the first alternate key to enforce peer dataset commonality. In some cases, the data architect can select to use only one unique key to enforce peer dataset commonality. In such cases, the peer dataset connector representations would only contain data table columns of the unique key selected.

Non-identifying data should only be stored once and shared across peer datasets. For example, peer data table representation 636 in peer PDMD 630 contains non-identifying data table columns 648, 650, and 652 while peer dataset connector representations 666 and 686 do not contain the non-identifying data table columns as shown in FIG. 6. Storing data content in one dataset and sharing that data content removes redundancy from the peer datasets which reduces data management costs and limits data duplication problems. Peer PDMD 630 is an independent peer PDMD since data table representation 636 has been declared the peer data registry representation associated with peer key constraint 678. Peer PDMDs 660 and 680 are both dependent peer PDMDs since they each contain a peer dataset connector representation.

When datasets are dataset instantiated from peer PDMDs, identifying metadata becomes essential to enforcing peer dataset commonality. It is the unique identifying metadata commonality architected in the peer PDMDs, combined with the enforcement of data content record commonality by the peer key constraints that creates and maintains the peer dataset access paths used for joining multiple peer datasets. Enforcement of data content record commonality for a peer dataset access path is typically achieved using a single source of data content records from an instantiated peer data registry or software applications or a combination of both.

Peer data table representation 636 and peer dataset connector representations 666, and 686, which are all analogs of data entity 606 of logical ERD 602, are constrained by peer key constraint 678. Peer key constraints are added to the peer PDMDs by the data architect as peer key constraints do not have antecedent data architecture modeling objects in the logical ERD. Typically, peer key constraints, such as peer key constraint 678, constrain a peer data table representation and peer dataset connector representations that are analogs of the same data entity from the antecedent logical ERD found within a single data architecture model such as data architecture model 600. For example, peer data table representation 636 and peer dataset connector representations 666 and 686 of PDMDs 630, 660, and 680, respectively, are all analogs derived from data entity 606 in logical ERD 602 as shown in FIG. 6.

In FIG. 6, peer data table representation 636 of independent peer PDMD 630, is a peer data registry representation for peer data connector representations 666 and 686 of dependent peer PDMDs 660 and 680 respectively. The peer data registry representation is joined to the peer dataset connector representations by peer key constraint 678. Since independent peer PDMD 630 contains a peer data registry representation, such as peer data registry representation 636, PDMD 630 is an independent peer PDMD. Peer PDMDs 660 and 680 are each considered a dependent peer PDMD since each contains a peer dataset connector representation, such as peer dataset connector representation 666 contained in dependent peer PDMD 660 and peer dataset connector representation 686 contained in dependent peer PDMD 680. Dependent peer PDMDs are dependent on their independent peer PDMDs for their peer data registry representation data content. As illustrated in FIG. 6, peer data registry representation 636 in independent peer PDMD 630 is configured to be joined with peer dataset connector representations 666 and 686 of dependent peer PDMDs 660 and 680 respectively, using peer key constraint 678. In addition, peer dataset connector representation peer dataset connector representation 666 of dependent peer PDMD 660 is configured to be joined directly with peer dataset connector representation peer dataset connector representation 686 of dependent peer PDMD 680 using peer key constraint 678.

FIG. 7 depicts data architecture schema 700 which is comprised of three different peer database schemas, peer database schemas 730, 760, and 780 that were dataset instantiated from peer PDMDs 630, 660, and 680, respectively, of data architecture model 600 as depicted in FIG. 6. Each peer database schema of 730, 760, and 780, has a unique database name such as peer database schema 730 with database schema name 734 with a metadata value of “DB1” for example. The unique database schema name 734 was derived from the unique name 634 of the physical data environment specification 632 as shown in FIG. 6. Unique database schema names 764 and 784, with metadata values of “DB2”, and “DB3”, respectively, were derived from the unique names of physical data environment specifications 662 and 682, respectively.

Peer database schemas are typically generated from peer PDMDs. Each peer database schema would normally be comprised of multiple database tables that would form each peer dataset. In this simple example, however, each of these three peer database schemas 730, 760, and 780 contains a database table such as peer database schema 730 which contains peer database table 736, peer database schema 760 which contains peer database table 766, and peer database schema 780 which contains peer database table 786.

FIG. 7 depicts a set of three database tables where identifying metadata commonality has been established in the peer PDMDs from which they were dataset instantiated. Beyond the identifying metadata commonality, the data content records were constrained by peer key constraint 678 of data architecture model 600 shown in FIG. 6 to enforce peer dataset content commonality. When both identifying metadata commonality and peer dataset content commonality are enforced for these peer database tables, peer dataset commonality is established to support peer dataset access path 762 as shown in FIG. 7. Direct dataset interoperability is characteristic of peer datasets that contain peer dataset access paths such as shown in FIG. 7.

Peer database table 736 of independent peer database schema 730 depicted in FIG. 7 was dataset instantiated from peer data table representation 636 of independent peer PDMD 630 shown in FIG. 6. Peer database table 736 has a database table name 738 with an identifying metadata value of “ADDRESS”. Within a database, the database table names are required to be unique. The complete peer database table designation for peer database table 736 of peer database schema 730 has a value of “DB1.ADDRESS”. Peer database table 736 contains database table column 740 named “Address ID”, which is the primary key index column for this database table. The database table column 740 provides the primary method to uniquely identify data content records of that peer database table. Database table columns 742, 744, and 746 combine to form the first alternate key index of peer database table 736. The first alternate key index of peer database table 736 provides an alternate method of uniquely identifying data content records of that peer database table. Peer database table 736, which functions as the instantiated peer data registry associated with peer dataset access path 762, also contains non-identifying database table columns 748, 750, and 752 as seen in data architecture schema 700 of FIG. 7.

Peer database table 766 of dependent peer database schema 760 depicted in FIG. 7 was dataset instantiated from peer dataset connector representation peer dataset connector representation 666 of dependent peer PDMD 660 shown in FIG. 6. Peer database table 766 functions as an instantiated peer dataset connector that has a database table name 768 with an identifying metadata value of “ADDRESS”. The complete database table designation for peer database table 766 of dependent peer database schema 760 has a value of “DB2.ADDRESS”. Database table column 770 is named “Address ID”, which is the primary key index for peer database table 766. Database table columns 772, 774, and 776 combine to form the first alternate key index of peer database table 766. Peer database table 766 functions as an instantiated peer dataset connector because it was dataset instantiated from peer dataset connector representation 666 of dependent peer PDMD 660 shown in FIG. 6.

Peer database table 786 of dependent peer database schema 780 depicted in FIG. 7 was dataset instantiated from peer dataset connector representation peer dataset connector representation 686 of dependent peer PDMD 680 shown in FIG. 6. Peer database table 786 functions as an instantiated peer dataset connector that has a peer database table name 788 with an identifying metadata value of “ADDRESS”. The complete database table designation for peer database table 786 of peer database schema 780 has a metadata value of “DB3.ADDRESS”. This peer database table column 790, is named “Address ID”, which is the primary unique key index for peer database table 786. The remaining peer database table columns, 792, 794, and 796, combine to form the first alternate key index (AK1) of peer database table 786. The first alternate key index of peer database table 786 provides an alternate method of uniquely identifying data content records of that peer database table. Peer database table 786 functions as an instantiated peer dataset connector because it was dataset instantiated from peer dataset connector representation 686 of dependent peer PDMD 680 shown in FIG. 6.

In at least one embodiment of the current invention, peer key constraints are architected to constrain multiple unique keys across multiple peer data table representations and peer dataset connector representations. For example, peer key constraint 678, shown in FIG. 6, constrains both the primary key and the first alternate key of peer data table representation 636 and peer dataset connector representations 666 and 686 such that the peer dataset content commonality is always consistent across peer datasets that are dataset instantiated from peer data table representation 636 and peer dataset connector representations 666 and 686.

As architected in FIG. 6, the three peer database tables from FIG. 7, peer database tables 736, 766, and 786, are directly interoperable because peer dataset commonality has been enforced. As a result of peer dataset commonality, and using peer dataset access path 762, the appropriate data content records can be easily equated by calculating which data content records have the same unique identification data values.

In FIG. 7, a first physical residential address is represented in data content records 757, 777, and 797 of peer database tables 736, 766, and 786 respectively. Each data content record, 757, 777, and 797 have the same primary key data value of “1” and the same first alternate key index data values of “123 MAIN STREET |Anywhere | PA” as shown in peer database tables 736, 766, and 786 respectively.

In FIG. 7, a second physical residential address is represented in data content records 758, 778, and 798 of peer database tables 736, 766, and 786 respectively. Each data content record, 758, 778, and 798 have the same primary key data value of “2” and the same first alternate key index data values of “48 WEST MAIN STREET |Sometown | NJ” as shown in peer database tables 736, 766, and 786 respectively.

In FIG. 7, a third physical residential address is represented in data content records 759, 779, and 799 of peer database tables 736, 766, and 786 respectively. Each data content record, 759, 779, and 799 have the same primary key data value of “3” and the same first alternate key index data values of “26 NORTH CHURCH AVENUE |Nearby | SC” as shown in peer database tables 736, 766, and 786 respectively.

The equivalent primary key index data values across peer database tables correctly indicate that these data content records represent the same physical residential address. The equivalent first alternate key index data values across peer database tables correctly indicate that these data content records represent the same physical residential address.

In at least one embodiment of the present invention, unique key indexes in a database table of a database schema are coupled to provide peer identifying metadata commonality as well as peer dataset content commonality required to enforce external referential data integrity for peer dataset access paths, such as peer dataset access path 762 shown in FIG. 7. For example, both the primary key index data value and the first alternate key index data values of data content record 757 in peer database table 736 is equal to the primary key index data value and the first alternate key index data values for data content record 777 of peer database table 766. Therefore, data content records 757 and 777 represent the same physical residential address in peer database schema 730 and peer database schema 760 respectively.

All foreign key constraint representations of PDMDs have internal referential data integrity rules for creating, updating, and deleting data instances in both the parent data table representations and the child data table representations. For example, in FIG. 3, foreign key constraint representation 340 has the internal referential data integrity rules for parent data table representation 320 and child data table representation 360 as illustrated in PDMD 302. When the data table representations of PDMDs are dataset instantiated into database tables in database schemas, the internal referential data integrity rules for each instantiated foreign key constraint are typically implemented by the DBMS software program.

Likewise, the peer key constraints have rules for creating, updating, and deleting data content records in the peer key constraint such as peer key constraint 678 shown in PDMDs 630, 660, and 680 of FIG. 6. These peer key constraint rules ensure the peer dataset content commonality is established and maintained across peer dataset tables such as peer database tables 736, 766, and 786 of peer database schemas 730, 760, and 780 respectively, as shown in FIG. 7. A foreign key constraint representation is derived from a single data entity relationship in the logical ERD of a data architecture model. Foreign key constraint representations, when dataset instantiated, enforce internal referential data integrity within a dataset such as a database schema. Peer key constraints are needed to relate peer data table representations in the peer PDMDs that are derived from a single data entity in the logical ERD of a data architecture model. Peer key constraints enforce external referential data integrity between two or more datasets such as two or more database schemas. In fact, the peer key constraints are what is missing from the prior art PDMDs that are responsible for the formation of disparate datasets that are commonly characterized as data silos.

The peer PDMDs data architect selected the coupled peer key constraint rule for peer key constraint 678 shown in FIG. 6. As such, the primary key combined with the alternate key of data table representations 636, 666, and 686 are used to ensure the external referential data integrity for peer key constraint 678 of data architecture model 600 of FIG. 6. When independent peer PDMD 630, and dependent peer PDMDs 660 and 680 are dataset instantiated, the result of dataset instantiation is illustrated in data architecture schema 700 shown in FIG. 7. Both the primary key indexes and the first alternate key indexes are used in combination to enforce peer dataset commonality among peer database tables 736, 766, and 786 of peer database schemas 730, 760, and 780 respectively as depicted in FIG. 7.

In FIG. 7, the unique key indexes are coupled, meaning that the unique key index data values work in tandem among the primary unique key index and the first alternate unique key index for each peer database table. For example, in database tables 736, 766, and 786 of data architecture schema 700, the data content record values are always consistent across unique key indexes. In at least one embodiment of the present application, computer processor 4 implements computer programming stored in computer memory 8 to make these data content record values consistent. In some embodiments of the present invention, this can be programmed in the DBMS software program. The unique key data values of data content record 757 of database table 736 are the same as data content records 777 and 797 of database tables 766 and 786 respectively. Likewise, as illustrated in data architecture 700, the unique key data values of data content record 758 from database table 736 are the same as the unique key data values of data content records 778 and 798 of database tables 766 and 786 respectively.

In FIG. 7, an example of uncoupled unique key indexes would be if the data content record 777 of database table 766, were to have a data value of “4” for database table column 770 while the remaining database table columns 772, 774, and 776 data content record values remained unchanged. This is not a violation of the primary unique key index constraint for each of the three database tables, nor a violation of the first alternate key unique key index constraint for each of the three database tables. However, it would be a violation of the peer key constraint rule, such as stored in computer memory 8, if the primary key index and the alternate key index are coupled.

In at least one embodiment of this invention, one or more peer database tables that function as instantiated peer dataset connectors can be a substitute for the peer database table that functions as an instantiated peer data registry, so long as these peer database tables have peer dataset commonality enforced. For example, in data architecture schema 700 of FIG. 7, peer database table 736 of independent peer database schema 730 functions as an instantiated peer data registry. Peer database table 736 is a single source of peer data content records for dependent peer database tables 766 and 786 of dependent peer database schemas 760 and 780 respectively, as indicated by peer dataset access path 762 illustrated in FIG. 7. Peer database table 736 contains non-identifying database table columns which the database tables that function as instantiated peer dataset connectors (766 and 786, in this example) do not have. As such, each of the dependent peer database tables 766 and 786 of peer database schemas 760 and 780 respectively, which function as instantiated peer dataset connectors for peer database table 736, can be a substitute peer database table in their database schemas for peer database table 736. The use of instantiated peer dataset connectors removes redundant data, in the form of non-identifying database table columns, from peer database schemas 760 and 780 as illustrated in FIG. 7. Removing redundant data reduces data management costs and removes data content record inconsistency issues.

Independent peer database table 736 of independent peer database schema 730, can be used in place of substitute dependent peer database tables 766 or 786, when retrieving data content records from peer database schemas 760 and 780 as depicted in FIG. 7. If the address latitude and longitude data values stored in database table columns 750 and 752, respectively of peer database table 736 in peer database schema 730, need to be shared into peer database schema 780 for example, independent peer database table 736 is referenced directly instead of referencing its substitute dependent peer database table 786 as illustrated in FIG. 7.

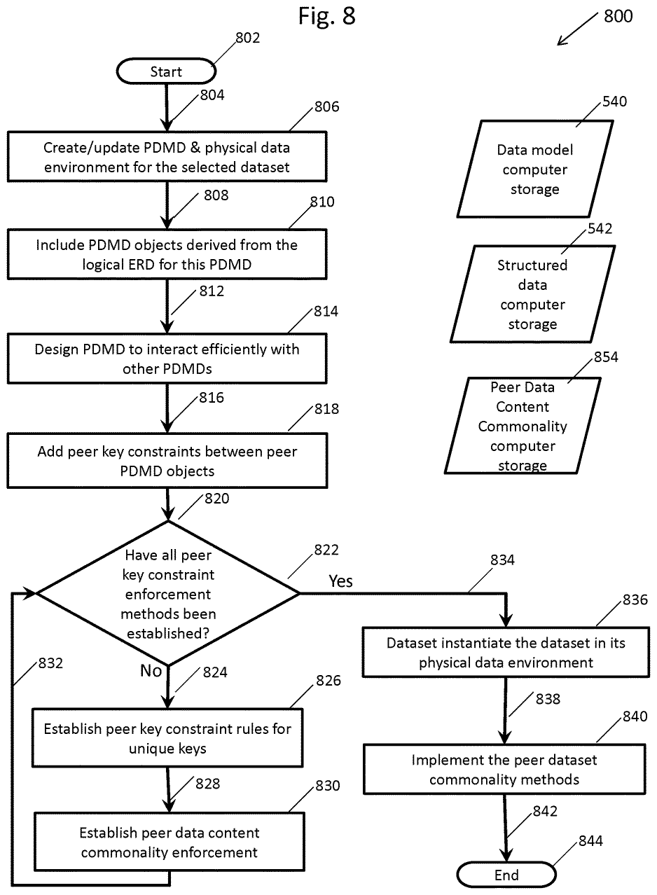

FIG. 8 depicts flow chart 800 of a method used to define and configure PDMDs within a data architecture model, such as PDMDs 630, 660, and 680 within data architecture model 600, from a single data entity of an antecedent logical ERD, such as antecedent logical ERD 602 also of data architecture model 600, as illustrated in FIG. 6.

Flow chart 800 contains flow chart initiator 802, flow chart processes 806, 810, 814, 818, 826, 830, 836, and 840, and flow chart decisions 822, along with flow chart terminator 846. In addition, flow chart 800 depicts flow chart flows 804, 808, 812, 816, 820, 824, 828, 832, 834, 838, and 842, along with computer storage areas 540, 542, and 854.

Flow chart 800 is, at least in part, a more detailed depiction of flow chart processes 516 and 520 of flow chart 500 shown in FIG. 5. Flow chart 800 depicts the additional flow chart processes needed to form PDMDs and their peer datasets with enforced peer dataset commonality. Flow chart 800 normally begins after the antecedent logical ERD has been created or updated as illustrated in flow chart process 512 of flow chart 500 shown in FIG. 5. Flow chart processes 806, 810, 814, 818, 826, and 830 for flow chart 800 are flow chart processes performed within flow chart process 516 of flow chart 500. Flow chart processes 836, and 840 of flow chart 800 are flow chart processes performed within flow chart process 520 of flow chart 500.

In flow chart 800, flow chart processes 806, 810, 814, and 818 ensure that peer identifying metadata commonality is supported for peer datasets. In addition, flow chart processes 826, 830, and 840 ensure peer dataset content commonality is supported for these same peer datasets.

Computer storage areas, such as computer storage area 540, are storage areas that would be implemented in a computer memory such as computer memory 8 of apparatus 100 depicted in FIG. 1. These computer storage areas may also be accessible from other computers using a computer network such as computer network 10 depicted in apparatus 100 shown in FIG. 1. Computer storage area 540 of flow chart 800 depicted in FIG. 8, is the same computer storage area as computer storage area 540 of flow chart 500, as depicted in FIG. 5. Computer storage area 540, represents a storage area of the repository of metadata for one or more data architecture models along with their logical ERDs and PDMDs.

Computer storage area 542 of flow chart 800 depicted in FIG. 8, represents a computer storage area of structured data storage that may be used for database schema structures and for the data system dataset files of one or more data systems, for example. Access to computer storage area 542 for database schema structures could be controlled by a DBMS software program executing on computer processor 4 also of apparatus 100 depicted in FIG. 1. Access to computer storage area 542 for data system data files of a specific data system would normally be controlled by computer software programmed specifically for that data system. Computer storage area 542 of flow chart 800 is the same computer storage area as computer storage area 542 of flow chart 500 as depicted in FIG. 5.

Computer storage area 854 of flow chart 800 depicted in FIG. 8, represents a computer storage area of peer dataset commonality-related data and software programs. The data stored in this area is used to enforce peer dataset commonality across peer datasets, such as peer key constraint rules, and unique data content records as a single-source instantiated peer data registry. Access to computer storage area 854 for peer dataset commonality data and software could be controlled by software programs executing on computer processor 4 of apparatus 100 depicted in FIG. 1.

Flow chart 800 of FIG. 8 begins at flow chart initiator 802 and follows flow chart flow 804 to flow chart process 806. In flow chart process 806, the computer user employs a data architecture modeling software program executing on a computer processor, such as computer processor 4 of apparatus 100 depicted in FIG. 1, to create or update a selected PDMD and uniquely define its physical data environment specification. If needed, logical ERD and PDMD data of a data architecture model are retrieved from computer storage area 540. Any new PDMDs will be associated with the antecedent logical ERD of the same data architecture model such as PDMD 630 is associated with logical ERD 602 of data architecture model 600 as illustrated in FIG. 6. The physical data environment specification, such as physical data environment specification 632 of PDMD 630, is uniquely defined as the actual physical data environment into which the PDMD objects will be dataset instantiated. Computer storage area 540 will then be updated to reflect the architect work done on the analog PDMDs. Once the metadata and data have been created or updated in computer storage area 540, flow chart control 808 is followed to flow chart process 810.

In flow chart process 810 of flow chart 800 as shown in FIG. 8, the computer user generates a select set of PDMD objects from the antecedent logical ERD to be included in the analog PDMD. To begin flow chart process 810, both the logical ERD and the analog PDMD are retrieved from computer storage area 540, such as logical ERD 602 and PDMD 630 of data architecture model 600 as depicted in FIG. 6. The data entities and entity relationships from the logical ERD are then selected by the user to have their analog data table representations and foreign key constraint representations included in the selected PDMD. For example, the user could select to include data entity 606 from logical ERD 602 of data architecture model 600shown in FIG. 6. After the selection is made, the computer under software program control of the data architecture modeling software program, would create or update the analog PDMD. In continuing the previous example, data entity 606 of logical ERD 602 would be used to derive data table representation 636 of PDMD 630 as depicted in FIG. 6. Once the analog PDMD is computer generated, the user continues adding details to the PDMD as needed to complete the representation of the PDMD. Once the user decides to finish, the logical ERD and PDMD information is stored in computer storage area 540, and flow chart control is passed to flow chart flow 812 which transfers flow chart control to flow chart process 814 as depicted in flow chart 800 of FIG. 8.

Flow chart process 814 of flow chart 800 illustrated in FIG. 8, depicts the process of architecting PDMDs to function efficiently. The process begins when the data architect retrieves a logical ERD and its associated analog PDMDs from computer storage area 540 using the data architecture modeling software program. The data architect can then remove data redundancies, add peer dataset connector representations, configure peer datasets that resolve dataset granularity conflicts, and provide a single source of unique data content records for independent peer datasets. For example, peer dataset connector representation 666 was derived from the data entity 606 in logical ERD 602 of data architecture model 600. However, the non-identifying data attributes 618, 620, and 622 of data entity 606 were not used for the derivation as depicted in FIG. 6. The same was done for peer dataset connector representation 686 in PDMD 680 as shown in FIG. 6. Once the data architect decides to finish, the logical ERD and associated PDMDs are stored in computer storage area 540. Then, flow chart control is passed to flow chart flow 816 which transfers flow chart control to flow chart process 818 as depicted in flow chart 800 of FIG. 8.

Flow chart process 818 of flow chart 800 as shown in FIG. 8, represents the process of adding peer key constraints to peer data table representations and peer dataset connector representations in the peer PDMDs such as adding peer key constraint 678 to peer data table representation 636 along with peer dataset connector representations 666 and 686 of peer PDMDs 630, 660, and 680, respectively, as shown in FIG. 6. The peer key constraints, such as peer key constraint 678 shown in FIG. 6, join related peer data table representations and peer dataset connector representations from multiple peer PDMDs. First, the peer PDMD to be updated is retrieved from computer storage area 540 along with any peer dataset content commonality information needed from computer storage area 854. At this point, a computer user can select the data table representation to designate as a peer data table representation by adding a first peer key constraint. The computer, under program control, could then search the peer PDMDs in computer storage area 540 to determine which data table representations in the peer PDMDs have the same antecedent data entity from the antecedent logical ERD. For example, if the computer user selected to designate data table representation 636 as a peer data table representation from peer PDMD 630, the computer would calculate that the antecedent data entity is data entity 606 of logical ERD 602 shown in FIG. 6. The computer could also calculate that peer dataset connector representations 666 and 686 of peer PDMDs 660 and 680 respectively have the same antecedent data entity 606 of logical ERD 602. Therefore, the first peer key constraint would now be associated with peer data table representation 636 along with peer dataset connector representations 660 and 686 of peer PDMDs 630, 660, and 680 respectively. This first peer key constraint 678 is shown in data architecture model 600 of FIG. 6. This flow chart process 818 is repeated for each peer key constraint the user adds to the peer PDMD. The updated peer PDMDs would then be stored in computer storage area 540, and the appropriate peer key constraint data would be stored in computer storage area 854. Once the information has been stored, flow chart process 818 then follows flow chart flow 820 to flow chart decision 822 as illustrated in FIG. 8.

In flow chart decision 822 of flow chart 800 as shown in FIG. 8, it is determined if peer key constraint methods have been established for all peer key constraints associated with the selected peer PDMD. Under program control, computer storage area 854 is accessed to determine that each peer key constraint of the selected peer PDMD has a peer key constraint enforcement method established. For example, computer storage area 854 would be accessed to ensure that peer key constraint 678, which is associated with peer PDMD 630 shown in data architecture model 600, has a peer key constraint enforcement method established. If the appropriate peer dataset content commonality information is not found, flow chart flow 824 is followed to flow chart process 826 as shown in flow chart 800 of FIG. 8. If the proper peer dataset content commonality enforcement information is found for all peer key constraints associated with the peer PDMD of interest, flow chart flow 834 is followed to flow chart process 836.

In flow chart process 826 of flow chart 800 of FIG. 8, the computer user establishes peer key constraint rules for unique keys using a computer software program. To begin, any existing peer key constraint rules for the peer key constraint of interest may be retrieved from computer storage area 854. The peer key constraint can use a single unique key or a combination of unique keys to provide peer dataset commonality for peer key constraints. As illustrated in FIG. 6, peer key constraint 678 constrains data table representation 636 along with peer dataset connector representations 666 and 686 of peer PDMDs 630, 660, and 680 respectively. Data table representation 636 is designated by the data architect as the single source peer data registry representation for peer key constraint 678. The data architect has indicated that both the primary key and the first alternate key will be coupled for peer key constraint 678 shown in FIG. 6. For this reason, peer dataset connector representations 666 and 686 of dependent peer PDMDs 660 and 680 show data table columns for both the primary key and the first alternate key.

When peer PDMDs 630, 660, and 680 are dataset instantiated, data table representation 636 along with peer dataset connector representations 666 and 686 of FIG. 6 become peer database tables 736, 766, and 786 respectively as shown in FIG. 7. In peer database tables 736, 766, and 786, the primary key index values are coupled with the first alternate key index values across these three database tables as shown in FIG. 7.

Once the user selects the peer key constraint rules for that specific peer key constraint, the information is stored in computer storage area 854 by the data architecture modeling software program executing on the computer. Flow chart flow 828 is then followed to flow chart process 830.

Flow chart process 830 of flow chart 800 as shown in FIG. 8, allows the computer user to create or update peer dataset content commonality enforcement information. In at least one embodiment of this invention, peer dataset content commonality may be enforced using an instantiated peer data registry representationed specifically to store a unique set of data content records while conforming with identifying metadata of the peer data table representation and the peer key constraint rules related by that peer key constraint. For example, independent peer database table 736 of data architecture schema 700 as shown in FIG. 7, could be an instantiated peer data registry for the dependent peer database tables 766 and 786 also depicted in FIG. 7. Both database tables 766 and 786 are architected as and function as instantiated peer dataset connectors with a coupled primary key index and first alternate key index in each dependent peer database table. Peer dataset content commonality enforcement would not allow instantiated peer dataset connectors to contain data content records that are not in the instantiated peer data registry. For example, independent peer database table 736 has three data content records 757, 758, and 759 in the instantiated peer data registry. Therefore, analog dependent peer database tables 766 and 786 may each only contain identifying data content of those three data content records: in data content records 777, 778, and 779 of peer database table 766 and data content records 797, 798, and 799 of peer database table 786. Attempts to add data content records to instantiated peer dataset connectors that are not in the instantiated peer data registry would be rejected by the computer processor 4 in accordance with software programs stored in computer memory 8. Using an instantiated peer data registry is one method of enforcing peer dataset content commonality and external referential data integrity.

In at least one embodiment of this invention, software programs can be implemented to enforce peer dataset content commonality for a set of peer database tables in multiple database schemas. This software program would need to be programmed to check the peer dataset content commonality across the set of peer database tables and reject any attempts to create data content records that do not agree with existing data content records in other peer database tables. For example, a data content record that conflicts with any existing data content record in any of the peer database tables would be rejected by the software program stored in computer memory 8.

Peer dataset content commonality may be enforced with data registries, software programs, a combination of these methods or some other methods not specified here. The computer data architect would determine how to best support peer dataset content commonality for each peer key constraint and enter the required information into the computer. Once the peer dataset content commonality information has been updated, the data architect would store the information in computer storage area 854 as depicted in FIG. 8. Process flow would then follow flow chart flow 832 back to flow chart decision 822. Once all the peer key constraint enforcement methods have been created or updated, flow chart control follows flow chart control 834 to flow chart process 836.

Flow chart process 836 of flow chart 800 as shown in FIG. 8, represents the process of using a PDMD to dataset instantiate the dataset architected in the PDMD into its proper actual physical data environment. This flow chart process is analogous to flow chart process 520 in flow chart 500 of FIG. 5.

Flow chart process 836 begins by retrieving the PDMD of the dataset the computer user wants to dataset instantiate and the physical data environment specification information from computer storage area 540. For example, the user may select to dataset instantiate dependent peer PDMD 680 of data architecture model 600 into physical data environment specification 682 as depicted in FIG. 6. Under the control of the data architecture modeling software program the computer is typically used to generate the appropriate dataset instantiation instructions for its specific actual physical data environment. For example, in the case of dataset instantiating a database dataset, the data architecture modeling software program uses the PDMD information and the physical data environment specification information to create SQL DDL (Data Definition Language) scripts that are executed by the DBMS software program to create or update the dataset instantiated database objects specific to the DBMS actual physical data environment. These dataset-instantiated database objects are typically database tables, database table columns, database table indexes, and instantiated foreign key constraints for example. The dataset instantiated database objects are stored in computer storage area 542. For example, the computer user may dataset instantiate independent peer PDMD 630 into the physical data environment specification 632 from data architecture model 600 as detailed in FIG. 6 resulting in peer database schema 730 as depicted in FIG. 7. Once the dataset has been dataset instantiated, the flow chart process 836 is complete, and flow chart control follows flow chart flow 838 to flow chart process 840 as illustrated in FIG. 8.

Flow chart process 840 of flow chart 800 is shown in FIG. 8. In this flow chart process 840, the peer dataset content commonality enforcement methods are implemented as needed to integrate the peer datasets that were dataset instantiated. For example, independent peer PDMD 630 from data architecture model 600 as shown in FIG. 6 has peer key constraints 678. This peer key constraint will have a peer dataset content commonality enforcement method defined in computer storage area 854.

First, the PDMD is retrieved from computer storage area 540 for the dataset that has been dataset instantiated. A check is made to determine which peer key constraints are associated with the peer data table representations of the PDMD. Any peer dataset content commonality methods need to be implemented before the data content records are stored in the peer dataset.

For each peer key constraint that needs to be implemented, peer dataset content commonality information is retrieved from computer storage area 854. The peer dataset content commonality enforcement method will need to be implemented. Once a peer dataset content commonality enforcement method is defined for peer dataset constraint 678 as shown in FIG. 6 for example, the peer dataset access path 762 shown in FIG. 7 will be supported. Direct dataset interoperability will be supported by peer dataset access path 762 among peer database schemas 730, 760, and 780 as depicted in FIG. 7.

Once all peer dataset content commonality enforcement methods have been implemented, flow chart control is passed to flow chart flow 842 which terminates the entire flow chart at flow chart terminator 846 as shown in FIG. 8.

Flow chart 800 shown in FIG. 8 is a flow chart used to architect and implement peer datasets. In order to generate peer database schemas 730, 760, and 780 respectively shown in FIG. 7, from the three peer PDMDs 630, 660, and 680 of data architecture model 600 shown in FIG. 6, the computer user would need to follow flow chart 800 once for each PDMD; for a total of three passes to implement the three peer datasets. The peer key constraint rules, referenced in flow chart process 826 of flow chart 800 in FIG. 8 for peer key constraint 678 illustrated in FIG. 6, would be established on each pass of the flow chart for implementing peer PDMDs 630, 660, and 680 of FIG. 6. The data architect would select both the primary key and the composite first alternate key to be coupled for peer key constraint 678. In addition, the data architect would select peer data table representation 636 of independent peer PDMD 630 as depicted in FIG. 6 as the peer data registry representation for peer data content commonality enforcement at flow chart process 830 of flow chart 800 as shown in FIG. 8.

In accordance with at least one embodiment of the present invention, a method is provided, which can be called a “method of defining and implementing multiple PDMDs from a single logical ERD” in computer memory 8. This method is used to architect, implement, and maintain PDMDs in computer memory.

FIG. 9 depicts a data architecture model 900 with a single logical ERD 902. Data architecture model 900 is a repository of metadata that can also contain multiple logical ERDs. Each logical ERD may be the precursor of multiple PDMDs. When a logical ERD is the antecedent of multiple PDMDs, the data architecture model is often referred to as an enterprise data model. An enterprise logical ERD often contains hundreds or thousands of data entity representations and their related data entity relationships. The enterprise logical ERD can have tens of derived analog PDMDs.

Logical ERD 902 depicts data entities (908, 912, 916, 920, 924, 926, 932, 936, 958, 966, and 970) along with data entity relationships (910, 914, 918, 922, 928, 930, 934, 956, 960, 962, 964, 968, and 972). For each data entity relationship, a parent data entity is related to a child data entity denoted by the filled circle end of the data entity relationship. For example, in logical ERD 902, parent data entity 908 is related to child data entity 912 by data entity relationship 910. It is the child data entities that inherit foreign key data attributes from a data architect selected unique key of their related parent data entities as shown previously in FIG. 2.

In any logical ERD, several of the data entities are border data entities. The logical ERD data architect can designate a data entity as a border data entity and associate a master data domain with that border data entity. Independent border data entities typically do not inherit foreign key data attributes from any other non-border data entities. These independent border data entities are important as the ultimate parent data entities as all other data entities in the logical ERD are dependent upon them. Independent border data entities are data entities that encapsulate the logical ERD and typically become peer data table representations in the PDMDs.

In logical ERD 902 as shown in FIG. 9, data entity 908, with the data entity name “CUST”, is an independent border data entity architected to contain customer-related master data. Data entity 916, with the data entity name “CAL”, is an independent border data entity architected to contain calendar-related master data such as years, months, and dates. Data entity 936, with the data entity name “DLR”, is an independent border data entity architected to contain car dealer-related master information and can be associated with the master data domain for organizations. Data entity 920, with the data entity name “CMPNY”, is an independent border data entity architected to contain car manufacturing company-related product master information.

Data entities 912, 924, and 966 could be classified as dependent border data entities as they define master data and are only directly related to one independent border data entity. For example, data entity 912 is directly related as a child data entity to only independent border data entity 908 as depicted in logical ERD 902 of FIG. 9. Data entity 912, with the data entity name of “CUST ADDR”, is a dependent border data entity architected to contain address related master data.

Dependent data entity 924, with the data entity name “MDL”, is directly related as a child data entity to independent border data entity 920 which makes data entity 924 a dependent border data entity. Data entity 924 is architected to contain car model and trim-level related master information as it relates to the car manufacturing company by entity-relationship 922. Lastly, data entity 966, with the data entity name “VHCL”, is architected to contain master data of a car vehicle such as the vehicle identification number, as well as the vehicle's model and trim level by relationship as shown by entity-relationship 964. Data entity 966 is only the child data entity of dependent border data entity 924, which makes data entity 966 a dependent border data entity as well. Data entities 920, 924, and 966 can be considered a hierarchical data entity structure as each data entity defines a different level of data granularity within the same master data domain of product information.

The header data entities of logical ERD 902 are data entities 958, and 926 since they are directly related as children of two or more border data entities. For example, header data entity 926 is directly related as a child data entity to border data entities 912 and 916 via entity relationships 914 and 918 respectively as illustrated in logical ERD 902.

Header data entity 958, with the data entity name “SHPMNT”, contains shipment header information such as the company ordering the shipment, which is inherited via entity relationship 960, and shipment date which is inherited via entity relationship 956 as illustrated in FIG. 9.

Header data entity 926 with the data entity name SLS ORD contains sales order header information such as customer name and address which is inherited via entity relationship 914, and sales order date which is inherited via entity relationship 918, and the dealer information inherited via entity relationship 934 as shown in FIG. 9.

The facts and measures data entities in logical ERD 902 are data entities 932 and 970. Facts and measures data entities are typically directly related as children to a combination of header data entities and border data entities. For example, in FIG. 9 facts and measures data entity 932, with the data entity name “SLS DTL”, is a child data entity of header data entity 926 and of border data entity 924 as indicated by entity relationships 928 and 930 respectively.

Facts and measures data entity 970, with the data entity name “SHP DTL”, contains shipment detail information such as the actual car vehicle being shipped, which is inherited via entity relationship 968, and shipment header information which is inherited via entity relationship 962 as shown in FIG. 9.

In at least one embodiment of the present invention, multiple PDMDs are derived from a single logical ERD where the data entities of the logical ERD are the antecedents of the peer data table representations in each of the analog PDMDs. Peer key constraints are added among the analog PDMDs to form peer PDMDs. Each peer key constraint will join copies of the same data table representations where each copy of the data table representation is in a single peer PDMD.

When the peer PDMDs are dataset instantiated, the resulting peer datasets will have direct dataset interoperability provided the proper peer dataset commonality has been established. In addition to identifying metadata commonality and peer dataset content commonality, a common unit of measure type, such as the metric system of measures, must be established for all peer PDMDs. The peer datasets, that result from dataset instantiation of the peer PDMDs, must be mathematically consistent such that mathematical calculations can be made without data value conversions due to unmatched units of measures. When peer datasets are mathematically consistent and share peer dataset commonality, the peer datasets will exhibit direct dataset interoperability.

FIG. 10 depicts data architecture model 1000 along with two peer PDMDs 1002 and 1050 that were derived from antecedent logical ERD 902 of FIG. 9. Data architecture model 900 together with data architecture model 1000 makes up a combined data architecture model that contains logical ERD 902 along with peer PDMDs 1002 and 1050. PDMDs 1002 and 1050 are the initial set of analog PDMDs formed from logical ERD 902. Typically, the data architecture modeling software program is used to convert the logical ERD to one or more analog PDMDs. PDMDs 1002 and 1050 of FIG. 10 will be enhanced, by the data architect using the data architecture modeling software program, to improve their dataset representations, with these enhancements shown in FIGS. 11 and 12.

Peer PDMD 1002, shown in FIG. 10, is associated with physical data environment specification 1004 with physical data environment name 1006 “AA” and peer dataset domain 1007 “Sales”, while peer PDMD 1050 is associated with physical data environment specification 1052 with physical data environment name 1054 “BB” and peer dataset domain 1055 “Shipping”.

Peer PDMD 1002 of FIG. 10 was architected from its antecedent logical ERD 902 of FIG. 9. In peer PDMD 1002, data table representations 1008, 1012, 1016a, 1020a, 1024a, 1026, 1032, and 1036a were formed from data entities 908, 912, 916, 920, 924, 926, 932, and 936, respectively, of logical ERD 902 shown in FIG. 9. In peer PDMD 1002, foreign key constraint representations 1010, 1014, 1018, 1022a, 1028, 1030, and 1034, shown in FIG. 10 were derived from data entity relationships 910, 914, 918, 922, 928 930, and 934 respectively of logical ERD 902 from data architecture model 900 shown in FIG. 9.

Peer PDMD 1050 of FIG. 10 was also derived from logical ERD 902 of data architecture model 900 of FIG. 9. In peer PDMD 1050, data table representations 1016b, 1020b, 1024b, 1036b, 1058,1066, and 1070 shown in FIG. 10, were derived from data entities 916, 920, 924, 936, 958, 966, and 970, respectively, of logical ERD 902 shown in FIG. 9. In peer PDMD 1050, foreign key constraint representations 1022b, 1056, 1060, 1062, 1064, 1068, and 1072 shown in FIG. 10, were derived from data entity relationships 922, 956, 960, 962, 964, 968, and 972 respectively, of logical ERD 902 shown in FIG. 9. Please note that foreign key constraint representations 1022a and 1022b of PDMDs 1002 and 1150, respectively, are both analogs of antecedent data entity relationship 922.

In FIG. 10, peer PDMDs 1002 and 1050 contain balanced peer key constraints 1038, 1040, 1042, and 1044. In this case, each border data table representation, common to both PDMDs 1002 and 1050, is related by a peer key constraint. Border data table representations 1008 and 1012 of peer PDMD 1002 are not peer data table representations because analog data table representations are not used in peer PDMD 1050.

When a data architect wishes to integrate two or more peer PDMDs, the data architect adds peer key constraints to each PDMD, such as shown in peer PDMD 1002 and 1050 of FIG. 10. Each peer key constraint indicates enforcement of peer dataset commonality between two or more peer data table representations, such as peer data table representations 1016a and 1016b that are related by peer key constraint 1038 as shown in FIG. 10. Each peer key constraint, such as peer key constraint 1038, supports direct dataset interoperability when dataset instantiated to form a peer dataset access path. By design, each peer key constraint supports direct dataset interoperability. With direct dataset interoperability, any data instances, in an peer PDMD, that are accessible by a peer key constraint, are directly interoperable with any other data instances in connected peer PDMDs providing those data instances are also accessible using the same peer key constraint. For example, using peer key constraint 1038 with peer PDMDs 1002 and 1050 shown in FIG. 10, and a combination of foreign key constraint representations, data instances in data table representations 1026 and 1032 of peer PDMD 1002 and data instances in data table representations 1058 and 1070 of peer PDMD 1050 are directly interoperable.

All peer key constraints, such as peer key constraint 1038 illustrated in FIG. 10, include a method for enforcing the peer dataset content commonality for the peer data table representations connected by the peer key constraint. Typically, peer dataset content commonality can be enforced by software programs, by an instantiated peer data registry, or a combination of both. In the case of residential address data content records, an external address data validator, using an address data registry, can be used as the single source of data content records. Currently, address validation services are available from several organizations. Data content validation services are also commonly available for organization-related and individual-related data content records. Instantiated peer data registries can also be developed and maintained in-house as needed.

Sometimes, peer data table representations are also connected by foreign key constraint representations as well as peer key constraints. Such is the case of data table representations 1020a and 1024a, which are related by foreign key constraint representation 1022a in peer PDMD 1002, and peer data table representations 1020b, and 1024b which are related by foreign key constraint representation 1022b in peer PDMD 1050 as represented in FIG. 10. Peer data table representations 1020a and 1020b are related by peer key constraint 1040 while peer data table representations 1024a and 1024b are related by peer key constraint 1042 in data architecture model 1000 as shown in FIG. 10. In this case, data table representation 1024a has a foreign key dependency on parent data table representation 1020a by foreign key constraint representation 1022a and data table representation 1024b has a foreign key dependency on parent data table representation 1020b by foreign key constraint representation 1022b.

The peer dataset content commonality must be enforced on the parent data table representations before the peer dataset content commonality is enforced on the dependent data table representations by computer processor 4 in accordance with computer programming in computer memory 8. Therefore, in this example, for each new data content record created, the peer dataset content commonality must be enforced on parent peer data table representations 1020a and 1020b before the peer dataset content commonality is enforced on the dependent peer data table representations 1024a and 1024b.

In at least one embodiment of the present invention, a dataset granularity conflict can occur when the data granularity is at different levels when comparing facts and measures from one peer PDMD to another peer PDMD. For example, fact and measures data table representation 1032 is at the dependent border data table representation 1024a level of detail in peer PDMD 1002, while facts and measures data table representation 1070 is at the dependent border data table representation 1066 level of detail which is more granular than the data table representation 1024b of peer PDMD 1050 as shown in FIG. 10. The sales order detail data documents orders for cars at the model and trim-level of data granularity, while the cars that fulfill the sales orders are at the vehicle level of data granularity. As there are many car vehicles of a specific model and trim level, and a specific vehicle is of a single model and trim level, the vehicle data is more detailed or granular. To make the connection between the car being ordered by the car dealer in data table representation 1032, and the vehicle being delivered to the car dealer in data table representation 1070, foreign key constraint representation 1068, and the change of data granularity foreign key constraint representation 1064 must be used in addition to the peer key constraint 1042 and the foreign key constraint representation 1030.

Flow chart 800 shown in FIG. 8 would be used to dataset instantiate peer PDMDs 1002 and 1050 depicted in FIG. 10. Flow chart 800 would be used to first dataset instantiate peer PDMD 1002, and then used a second time to dataset instantiate peer PDMD 1050. Peer key constraints 1038, 1040, 1042, and 1044 shown in FIG. 10 would have their peer key constraint rules established in flow chart process 826, and their peer dataset content commonality enforcement established in flow chart process 828, as illustrated in flow chart 800 shown in FIG. 8.

Peer PDMD 1002, when dataset instantiated, will form a complete dataset because peer PDMD 1002 does not contain peer dataset connector representations. Likewise, dataset instantiation of peer PDMD 1050 results in a complete dataset since peer PDMD 1050 does not contain a peer dataset connector representation.

Once both peer PDMDs 1002 and 1050 have each been dataset instantiated to form a first and a second peer dataset, retrieving data content records combined from both the first and the second peer datasets involves the use of at least one peer dataset access path which was dataset instantiated from a peer key constraint. The peer PDMDs can be used to determine a method to retrieve data content records from the peer datasets. For example, as shown in FIG. 10, peer key constraint 1044 would be needed to determine how many cars ordered by a dealer were shipped to that dealer. According to the peer PDMD 1002, the number of cars ordered by a dealer would be determined from data table representation 1032 in combination with data table representation 1026 which is joined by foreign key constraint representation 1028, and data table representation 1036a which is joined by foreign key constraint representation 1034 as depicted in peer PDMD 1002 of FIG. 10. As seen in peer PDMD 1050 of FIG. 10, the number of cars shipped to a dealer would be determined using data table representation 1070 in combination with data table representation 1036b using foreign key constraint representation 1072. Finally, peer key constraint 1044, shown in data architecture model 1000 in FIG. 10 would be needed to compare the number of cars ordered to the number of cars shipped.

Dataset instantiated peer dataset access paths, that are established from peer key constraints of the peer PDMDs, can be used in combinations to retrieve combined data content records from the first and second peer datasets. For example, as shown in FIG. 10, peer key constraints 1044 and 1042 would be needed to determine how many cars of a specific model ordered by a dealer were shipped to that dealer.

Upon analyzing the PDMDs of FIG. 10, the data architect has determined that the peer data table representations contain redundant data instances. For example, the peer database tables dataset instantiated from peer data table representations 1020a and 1020b would contain redundant data content records. The same is true for peer data table representations 1024a and 1024b, and peer data table representations 1036a and 1036b. The data architect has updated PDMDs 1002 and 1050 as shown in FIG. 10, to become PDMDs 1102, 1150, and 1180 of FIG. 11.

FIG. 11 depicts data architecture model 1100 along with peer PDMDs 1102, 1150, and 1180 that represents an enhancement of peer PDMDs 1002 and 1050 from FIG. 10. Now, a combined data architecture model including 900 of FIG. 9, and 1100 of FIG. 11 contains logical ERD 902 along with peer PDMDs 1102, 1150, and 1180. PDMDs 1002 and 1050 of FIG. 10 which were the initial peer PDMDs, have now been replaced by the peer PDMDs of FIG. 11 in the combined data architecture model.

PDMDs 1102 and 1150 of FIG. 11 are dependent peer PDMDs as they both contain peer dataset connector representations 1120, 1124, and 1166. PDMD 1180 is an independent peer PDMD shared by both dependent peer PDMDs 1102 and 1150. An independent peer PDMD may be shared with an unlimited number of dependent peer PDMDs. A dependent peer PDMD may be related by peer key constraints to several independent peer PDMDs. When the PDMDs have been dataset instantiated, the independent peer PDMDs become the independent peer datasets and the dependent peer PDMDs become dependent peer datasets. These dependent peer datasets are dependent on their independent peer datasets as their instantiated peer data registries.

Dependent peer PDMD 1102, shown in FIG. 11, is associated with physical data environment specification 1104 with name 1006 with metadata value “AA” and peer dataset domain 1007 with metadata value “Sales”, while peer PDMD 1150 is associated with physical data environment specification 1152 with name 1054 with metadata value “BB” and peer dataset domain 1055 with metadata value “Shipping”. The physical data environment specifications 1104 and 1152 depicted in FIG. 11 are enhancements of physical data environment specifications 1004 and 1052 respectively shown in FIG. 10. Independent peer PDMD 1180 depicted in FIG. 11 is associated with physical data environment specification 1182 with name 1184 with metadata value “CC” and peer dataset domain 1185 with metadata value “Product”.

Dependent peer PDMD 1102 of FIG. 11 was an update of peer PDMD 1002 of FIG. 10. In dependent peer PDMD 1102, data table representations 1008, 1012, 1016a, 1026, 1032, and 1036a are the same data table representations as found in peer PDMD 1002 of FIG. 10. Data table representation 1024a found in peer PDMD 1002 of FIG. 10 was converted to peer dataset connector representation 1124 in dependent peer PDMD 1102 of FIG. 11 by removing its non-identifying data table columns. In dependent peer PDMD 1102 shown in FIG. 11, foreign key constraint representations 1010, 1014, 1018, 1028, 1030, and 1034 are the same foreign key constraint representations in peer PDMD 1002 shown in FIG. 10. When dependent peer PDMD 1102 is dataset instantiated, the result will be a dependent peer dataset since dependent peer PDMD 1102 contains a peer dataset connector representation, peer dataset connector representation 1124.

Dependent peer PDMD 1150 of FIG. 11 was an update of peer PDMD 1050 of FIG. 10. In dependent peer PDMD 1150, data table representations 1016b, 1058, 1070, and 1036b are the same data table representations shown in peer PDMD 1050 of FIG. 10. However, data table representations 1020b and 1066 from peer PDMD 1050 were converted to peer dataset connector representations 1120 and 1166, respectively, of dependent peer PDMD 1150 by removing their non-identifying data table columns from each data table representation. In dependent peer PDMD 1150, foreign key constraint representations 1056, 1060, 1062, 1068, and 1072 are the same foreign key constraint representations in peer PDMD 1050 shown in FIG. 10. When dependent peer PDMD 1150 is dataset instantiated, the result will be a dependent peer dataset since dependent peer PDMD 1150 contains peer dataset connector representations 1120 and 1166.

Independent peer PDMD 1180 of FIG. 11 is comprised of border data table representations 1020b, 1024b, and 1066 that are the same border data table representations 1020b, 1024b, and 1066 respectively of peer PDMD 1050 shown in FIG. 10. Foreign key constraint representations 1022b and 1064 of independent peer PDMD 1180 shown in FIG. 11 are the same foreign key constraint representations 1022b and 1064 of peer PDMD 1050, respectively, shown in FIG. 10. When independent peer PDMD 1180 is dataset instantiated, the result will be an independent peer dataset since independent peer PDMD 1180 does not contain a peer dataset connector representation.

FIG. 11 also shows peer key constraints 1038, 1044, 1145, 1146, and 1147. Balanced peer key constraints 1038, and 1044 of FIG. 11 are the same peer key constraints as balanced peer key constraints 1038 and 1044 of FIG. 10. Peer key constraint 1145 of FIG. 11 is a new unbalanced peer key constraint that constrains peer dataset connector representation 1124 of dependent peer PDMD 1102 and peer data table representation 1024b of independent peer PDMD 1180 as illustrated in FIG. 11. Peer key constraint 1146 of FIG. 11 is a new unbalanced peer key constraint that constrains peer dataset connector representation 1120 of dependent peer PDMD 1150 and peer data table representation 1020b of independent peer PDMD 1180 as illustrated in FIG. 11. Peer key constraint 1147 of FIG. 11 is a new unbalanced peer key constraint that constrains peer dataset connector representation 1166 of dependent peer PDMD 1150 and peer data table representation 1066 of independent peer PDMD 1180 as illustrated in FIG. 11.

In at least one embodiment of the present invention, an independent peer PDMD can be formed to remove data redundancy from multiple peer PDMDs. For example, independent peer PDMD 1180 was formed to remove data redundancy from dependent peer PDMDs 1102 and 1150 as illustrated in FIG. 11. Instead of storing copies of the same data content records in multiple peer datasets, the goal is to store the data content records in a single peer dataset and share the data content records with the other peer datasets that require that data content.

In peer PDMDs 1002 and 1050 illustrated in FIG. 10, a cluster of data table representations was selected by the data architect as redundant data table representations. Data table representations 1020a and 1024a and foreign key constraint representation 1022a of peer PDMD 1002 were selected as redundant with data table representations 1020b and 1024b and foreign key constraint representation 1022b of peer PDMD 1050. So, in peer PDMDs 1102 and 1150, these redundant data table representations were removed and placed in independent peer PDMD 1180 as shown in FIG. 11. In peer PDMD 1050 of FIG. 10, data table representation 1066 and foreign key constraint representation 1064 were also selected for removal by the PDMD data architect and placed in independent peer PDMD 1180 as shown in FIG. 11.

In at least one embodiment of the present invention, identifying metadata, in the form of peer dataset connector representations, is used to enforce peer dataset commonality among multiple peer PDMDs and the peer datasets that are dataset instantiated from these peer PDMDs. Peer dataset connector representations are substitutes for peer data table representations used to enforce foreign key constraint representations within a dependent peer PDMD while also supporting peer key constraints among dependent peer PDMDs and their independent peer PDMDs.

In enhancing peer PDMD 1002 of FIG. 10 to form dependent peer PDMD 1102 of FIG. 11, peer data table representations 1020a and 1024a and foreign key constraint representation 1022a were removed from peer PDMD 1002 because it was redundant with peer data table representations 1020b and 1024b and entity relationship 1022b. When peer data table representations 1020a and 1024a were removed, peer key constraints 1040 and 1042 were also removed. When data table representation 1024a was removed from peer PDMD 1002 of FIG. 10, foreign key constraint representation 1030 no longer had a parent data table representation. Peer dataset connector representation 1124 was then created as a substitute for data table representation 1024a as shown in FIG. 11. Data table representation 1024a of FIG. 10 and peer dataset connector representation 1124 of FIG. 11 are both analogs of data entity 924 shown in logical ERD 902 of FIG. 9. However, peer dataset connector representation 1124 only contains the unique identifying data table columns while data table representation 1024a contained both unique identifying data table columns and non-identifying data table columns. In the case of peer dataset connector representations, it is only identifying data table columns that are needed to enforce foreign key constraint representations, such as foreign key constraint representation 1030 of dependent peer PDMD 1102, and unbalanced peer key constraints such as peer key constraint 1145 as illustrated in FIG. 11.

In enhancing peer PDMD 1050 of FIG. 10 to form dependent peer PDMD 1150 of FIG. 11, data table representations 1020b, 1024b, and 1066 along with foreign key constraint representations 1022b and 1064 were removed from dependent peer PDMD 1050 and added to newly created independent peer PDMD 1180 as shown in FIG. 11. However, with their removal, data table representations 1020b and 1066 left foreign key constants 1060 and 1068 respectively without parent data table representations. Therefore, peer dataset connector representations 1120 and 1166 were added to dependent peer PDMD 1150 to function as the parent data table representations of foreign key constraint representations 1060 and 1068 respectively as shown in FIG. 11. In FIG. 11, peer dataset connector representation 1120 of dependent peer PDMD 1150 and peer data table representation 1020b of independent peer PDMD 1180 are both analogs of data entity 920 of logical ERD 902 shown in FIG. 9. Also, in FIG. 11, peer dataset connector representation 1166 and data table representation 1066 are both analogs of data entity 966 of logical ERD 902 as shown in FIG. 9.

In FIG. 11, unbalanced peer key constraint 1145 was added to constrain peer data table representation 1024b of independent peer PDMD 1180 and peer dataset connector representation 1124 of dependent peer PDMD 1102. Unbalanced peer key constraint 1146 was also added to constrain peer data table representation 1020b of independent peer PDMD 1180 and peer dataset connector representation 1120 of dependent peer PDMD 1150. Lastly, unbalanced peer key constraint 1147 was added to constrain peer data table representation 1066 of independent peer PDMD 1180 and peer dataset connector representation 1166 of dependent peer PDMD 1150 as shown in FIG. 11.

Peer dataset connector representations 1120 and 1166 shown in dependent peer PDMD 1150 of FIG. 11, contain only data table columns associated with foreign key constraint representations and peer key constraints. For example, peer dataset connector representation 1120 needs the data table columns for the primary key to support foreign key constraint representation 1060 and the data table columns for any unique keys needed to support the peer key constraint 1146 as shown in FIG. 11. On the other hand, peer dataset connector representation 1166 needs the data table columns for the primary key to support foreign key constraint representation 1068 and the data table columns for any unique keys needed to support the peer key constraint 1147 as shown in FIG. 11.

Unfortunately, with the peer PDMDs architected in FIG. 11, peer key constraints 1145, 1146, or 1147 do not provide direct dataset interoperability between dependent peer PDMDs 1102 and 1150, as specified in computer memory 8 and implemented by computer processor 4, because to join dependent peer PDMDs 1102 and 1150 using peer key constraints 1145, 1146, and 1147, the peer data table representations of independent peer PDMD 1180 must be used to make the joins. For example, to join data table representation 1032 in dependent peer PDMD 1102 with data table representation 1070 in dependent peer PDMD 1150, using peer key constraints 1145 and 1147, data table representations 1024b and 1066 of independent peer PDMD 1180 must be used.

Peer datasets will often have facts and measures at different levels of data granularity relative to a master data domain. Dataset granularity conflicts are encountered when a first set of data content records are retrieved at a first level of data granularity from a first peer dataset while a second set of data content records are retrieved at a different level of data granularity from the second peer dataset. Any dataset granularity conflicts need to be resolved before the first set of data content records can be properly combined or mathematically processed with the second set of data content records. It is also unfortunate that the change in data granularity between peer dataset connector representation 1124 of dependent peer PDMD 1102 and peer dataset connector representation 1166 of dependent peer PDMD 1150, requires foreign key constraint representation 1064 that is found in independent peer PDMD 1180 as shown in FIG. 11. For these reasons, the lack of direct dataset interoperability between dependent peer PDMDs 1102 and 1150 and the dataset granularity conflicts, that the peer PDMDs of data architecture model 1100 shown in FIG. 11 were addressed in the peer PDMDs of data architecture model 1200 as shown in FIG. 12.

FIG. 12 depicts data architecture model 1200 with the final peer PDMDs representations illustrated in peer PDMDs 1202, 1250, 1280, and 1294 which represents an enhancement from PDMDs 1102, 1150, and 1180 shown in FIG. 11. Data architecture model 900 of FIG. 9 together with data architecture model 1200 of FIG. 12 make up a combined data architecture model that contains logical ERD 902 along with the final peer PDMDs representations.

In FIG. 12, peer PDMDs 1280 and 1294 are both independent peer PDMDs while PDMDs 1202 and 1250 are dependent peer PDMDs. In data architecture model 1200, peer PDMDs 1280, 1294, 1202, and 1250 are given the peer dataset domains “Product”, “Organization”, “Sales”, and “Shipping”, respectively. These peer dataset domains are used in peer dataset architecture maps such as shown in FIGS. 14 and 15. The peer dataset domains are stored in the metadata associated with each PDMS for the data architecture model.

Each independent peer PDMD constrains both dependent peer PDMDs and both dependent peer PDMDs are dependent on both independent peer PDMDs. However, independent peer PDMDs, such as independent peer PDMD 1280, can constrain many dependent peer PDMDs, and a dependent peer PDMD, such as dependent peer PDMD 1202, may be dependent on multiple independent peer PDMDs.

Dependent peer PDMD 1202, shown in FIG. 12, is associated with physical data environment specification 1204 with name 1006, while dependent peer PDMD 1250 is associated with physical data environment specification 1252 with name 1054. Physical data environment specifications 1204, 1252, and 1282 depicted in FIG. 12 are enhancements of physical data environment specifications 1104, 1152, and 1182 shown in FIG. 11. Independent peer PDMD 1294 in FIG. 12 is a new peer PDMD associated with physical data environment specification 1296 with name 1298 “DD”.

Dependent peer PDMD 1202 of FIG. 12 is an enhancement of dependent peer PDMD 1102 of FIG. 11. In dependent peer PDMD 1202 of FIG. 12, data table representations 1008, 1012, 1016a, and 1026 are the same data table representations as found in dependent peer PDMD 1002 of FIG. 10 and in dependent peer PDMD 1102 of FIG. 11. Peer dataset connector representation 1124 of dependent peer PDMD 1102 seen in FIG. 11 has been replaced by peer dataset connector representation 1286a in dependent peer PDMD 1202 as shown in FIG. 12. Peer data table representation 1036a in FIG. 10 and FIG. 11 has also been replaced by its substitute, peer dataset connector representation 1236a in dependent peer PDMD 1202 FIG. 12. In dependent peer PDMD 1202 shown in FIG. 12, foreign key constraint representations 1010, 1014, 1018, 1028, and 1034 are the same foreign key constraint representations in peer PDMD 1002 shown in FIG. 10 and as in dependent peer PDMD 1102 shown in FIG. 11. However, foreign key constraint representation 1230 of FIG. 12 has replaced foreign key constraint representation 1030 from FIGS. 10 and 11. Since the new peer dataset connector representation 1286a can have new unique key data table columns, the foreign key constraint representation 1230 can be different from its predecessor foreign key constraint representation 1030 of FIGS. 10 and 11. Also, data table representation 1232, which inherits foreign key constraint data table columns from foreign key constraint representation 1230, will also be enhanced from its previous form of data table representation 1032 shown in FIGS. 10 and 11.

Dependent peer PDMD 1250 of FIG. 12 is an enhancement of dependent peer PDMD 1150 shown in FIG. 11. In dependent peer PDMD 1250, data table representation 1016b is the same as data table representation 1016b shown in peer PDMD 1050 of FIG. 10 and in dependent peer PDMD 1150 shown in FIG. 11. Peer dataset connector representations 1120 and 1166 of dependent peer PDMD 1150 depicted in FIG. 11, have both been replaced by a single peer dataset connector representation 1286b in dependent peer PDMD 1250 of FIG. 12. In dependent peer PDMD 1250 depicted in FIG. 12, foreign key constraint representations 1056, 1062, and 1072 are the same foreign key constraint representations as in peer PDMD 1050 shown in FIG. 10 and in dependent peer PDMD 1150 illustrated in FIG. 11.

Since the new peer dataset connector representation 1286b can have new unique key data table columns, the foreign key constraint representations 1260 and 1268 can be different from their predecessors'foreign key constraint representations 1030 and 1068 respectively of FIGS. 10 and 11. Data table representation 1258 which inherits foreign key constraint data table columns from foreign key constraint representation 1260, will also be enhanced from its previous form of data table representation 1058 shown in FIGS. 10 and 11. Also, data table representation 1270 which inherits foreign key constraint data table columns from foreign key constraint representation 1268, will also be enhanced from its previous form of data table representation 1070 shown in FIGS. 10 and 11.

In at least one embodiment of the present invention, a peer dataset connector representation can be architected, and dataset instantiated, to support direct dataset interoperability between peer datasets while supporting changes in data granularity among datasets.

Independent peer PDMD 1280 of FIG. 12 was enhanced from independent peer PDMD 1180 of FIG. 11. Independent peer PDMD 1280 is comprised of data table representations 1288, 1290, and 1292 which were originally updated from data table representations 1020b, 1024b, and 1066 respectively, shown in independent peer PDMD 1180 of FIG. 11. Peer dataset connector representations 1286a, 1286b, and 1286c of peer PDMDs 1202, 1250, and 1280 respectively as shown in FIG. 12, are specifically architected by the PDMD data architect to incorporate the hierarchical data from peer data table representations 1020b, 1024b, and 1066 and foreign key constraint representations 1022b and 1064 shown in independent peer PDMD 1180 of FIG. 11. Foreign key constraint representations 1287, 1289, and 1291 are new foreign key constraint representations added to relate the data table representations 1288, 1290, and 1292 directly with peer data connector representation 1286c. After foreign key constraint representations 1287, 1289, and 1291 were added to independent peer PDMD 1280, data table representations 1287, 1289, and 1291 each gained foreign key data table columns inherited from the primary key of new peer dataset connector representation 1286c as shown in FIG. 12.

In FIG. 11, independent peer PDMD 1180 was always required to join dataset instances from dependent peer PDMDs 1102 and 1150 when peer data connector representations 1120, 1124, and 1166 were involved in the dataset join. Now, in FIG. 12 for the same dataset join, peer dataset connector representations 1286a and 1286b can be used to directly join data table representations from dependent peer PDMDs 1202 and 1250 while also supporting the change in data granularity between data table representations 1232 and 1270. As an example of peer dataset joins using instantiated peer dataset connectors, instantiated peer dataset connectors 766 and 786 in FIG. 7 can be joined based on their database tables'primary key index equal data values. When database table 766 has a primary key index data value of “1” in data content record 777, data content record 777 would join with data content record 797 in database table 786 with a primary key index data value also of “1”. Likewise, in FIG. 12, peer dataset connector representations 1268a and 1268b are architected to provide direct dataset interoperability among dependent peer PDMDs 1202 and 1250. Since peer dataset connector representations 1268a, and 1268b have the hierarchical identifying metadata incorporated, dataset granularity conflicts are also resolved.

Data table representation 1236c, of independent peer PDMD 1294 shown in FIG. 12, was architected by the data architect to remove master data redundancy from data table representations 1036a and 1036b of PDMDs 1102 and 1150 respectively as shown in FIG. 11. As architected in FIG. 11, peer data table representations 1036a and 1036b can contain multiple equivalent non-identifying data table columns that represent redundant data content. The PDMD data architect derived data table representation 1236c of FIG. 12 from data entity 936 of logical ERD 902 shown in FIG. 9, which is the same antecedent data entity as used for peer dataset connector representations 1236a and 1236b of FIG. 12. The data architect had removed the non-identifying data table columns from both data table representations 1236a and 1236b of peer PDMDs 1102 and 1150 respectively of FIG. 11 to have them both function as peer dataset connector representations in dependent peer PDMDs 1202 and 1250 respectively as shown in FIG. 12.

FIG. 12 also contains peer key constraints 1038, 1244, and 1248. Balanced peer key constraint 1038 of FIG. 12 is the same peer key constraint as balanced peer key constraint 1038 of FIG. 11 and FIG. 10. Unbalanced peer key constraint 1244 of FIG. 12 is enhanced from balanced peer key constraint 1044 from FIG. 11 and FIG. 10 with the addition of data table representation 1236c, and independent peer PDMD 1294 to FIG. 12. Unbalanced peer key constraint 1244 now constrains peer dataset connector representations 1236a and 1236b along with peer data table representation 1236c of peer PDMDs 1202, 1250, and 1294 respectively of FIG. 12. Complex peer key constraint 1248 of FIG. 12 replaces unbalanced peer key constraints 1145, 1146, and 1147 shown in FIG. 11.

In one or more embodiments of this present invention, independent peer PDMDs are architected to be the single source for the set of unique data content records of a specific master data domain. For example, the independent peer PDMD 1294 is the peer data registry representation for the set of unique data content records that represent specific car dealers. Peer data table representation 1236c of independent peer PDMD 1294 contains both the unique identifying data table columns as well as the non-identifying data table columns that provide each car dealer's profile information.

Peer data table representation 1288 of independent peer PDMD 1280 is the peer data registry representation for car manufacturers'profile data content. Peer data table representation 1290 of independent peer PDMD 1280 is the peer data registry representation for a manufacturer's car models and their trim lines offered for sale. Peer data table representation 1292 is the peer data registry representation for each vehicle of a particular manufacturer's car model and trim line. Each independent peer PDMD is intended for use by two or more dependent peer PDMDs that each contain peer dataset connector representations. For example, the independent peer PDMD 1294 shown in FIG. 12 is architected to be used by both dependent peer PDMDs 1202 and 1250 which contain peer dataset connector representations 1236a and 1236b respectively. Peer dataset connector representations 1236a and 1236b are the peer dataset connector representations associated with peer data table representation 1236c of independent peer PDMD 1294 shown in FIG. 12.

To dataset instantiate PDMDs 1202, 1250, 1280, and 1294, shown in FIG. 12, flow chart 800 shown in FIG. 8, would need to be executed one time for each peer PDMD dataset instantiated. Independent peer PDMDs 1280 and 1294 should be dataset instantiated before dependent peer PDMDs 1202 and 1250 as the dependent peer PDMDs are dependent on the independent peer PDMDs for their peer data registry representations.

FIG. 13 depicts dataset instantiated data architecture schema 1300 that contains peer database schemas 1302, 1350, 1380, and 1394 which were dataset instantiated from PDMDs 1202, 1250, 1280, and 1294, respectively of data architecture model 1200 as depicted in FIG. 12. Each peer database schema is encapsulated within a dotted rectangle that signifies the actual physical data environment into which the peer database schema has been dataset instantiated. These peer database schemas can be dataset instantiated by the data architect using the forward-engineering process of the data architecture modeling software program in conjunction with the DBMS software program that manages each of the actual physical data environments and their database schemas.

In FIG. 13, peer database schemas 1380 and 1394 are instantiated independent peer database schemas while peer database schemas 1302 and 1350 are instantiated dependent peer database schemas. However, instantiated independent peer database schemas are reusable and can constrain two or many more instantiated dependent peer database schemas. Likewise, instantiated dependent peer database schemas are usually dependent on several different instantiated independent peer database schemas.

Dependent peer database schema 1302, shown in FIG. 13, is dataset instantiated in actual physical data environment 1304 with actual physical data environment name 1306, which is “AA”. Dependent peer database schema 1302, as depicted in FIG. 13, contains database tables 1308, 1312, 1316a, 1326, 1332, 1336a, and 1386a. These database tables were dataset instantiated from data table representations 1008, 1012, 1016a, 1026, and 1232, along with peer dataset connector representations 1236a, and 1286a respectively of dependent peer PDMD 1202 depicted in FIG. 12. Instantiated foreign key constraints 1310, 1314, 1318, 1328, 1330, and 1334 of dependent peer database schema 1302 are dataset instantiated from foreign key constraint representations 1010, 1014, 1018, 1028, 1230, and 1034 respectively shown in dependent peer PDMD 1202 shown in FIG. 12.

Dependent peer database schema 1350, shown in FIG. 13, is dataset instantiated in the actual physical data environment 1352 as architected in dependent peer PDMD 1250 for physical data environment specification 1252 with name 1354, which is “BB” as shown in FIG. 12. Dependent peer database schema 1350, as depicted in FIG. 13, contains database tables 1316b, 1358, 1370, 1336b, and 1386b, which were dataset instantiated from data table representations 1016b, 1058, and 1270, along with peer dataset connector representations 1236b, and 1286b, respectively of dependent peer PDMD 1250 shown in FIG. 12. Instantiated foreign key constraints 1356, 1360, 1362, 1368, and 1372 of dependent peer database schema 1350 are dataset instantiated from foreign key constraint representations 1056, 1260, 1062, 1268, and 1072 respectively as shown in dependent peer PDMD 1250 shown in FIG. 12.

Independent peer database schema 1380 of FIG. 13 was dataset instantiated in actual physical data environment 1382 with actual physical data environment name 1384 “CC” as architected from independent peer PDMD 1280 shown in FIG. 12 by the data architect using a data architecture modeling software program. Independent peer database schema 1380, illustrated in FIG. 13 as a part of data architecture schema 1300, is comprised of database tables 1386c, 1388, 1390, and 1392 that were dataset instantiated from peer dataset connector representation 1286c, along with data table representations 1288, 1290, and 1292 respectively of independent peer PDMD 1280 as shown in FIG. 12. Instantiated foreign key constraints 1387, 1389, and 1391 of independent peer database schema 1380 were dataset instantiated from foreign key constraint representations 1287, 1289, and 1291 respectively of independent peer PDMD 1280 depicted in FIG. 12.

Independent peer database schema 1394 of FIG. 13 was dataset instantiated in actual physical data environment 1396 with actual physical data environment name 1398 “DD” as architected in independent peer PDMD 1294 shown in FIG. 12 by the data architect using the data architecture modeling software program. Independent peer database schema 1394, depicted in FIG. 13 as part of data architecture schema 1300, is comprised of database table 1336c. Database table 1336c of independent peer database 1394 was dataset instantiated from data table representation 1236c of independent peer PDMD 1294 illustrated in FIG. 12.

Peer dataset access paths 1338, 1344, and 1348 of data architecture schema 1300 as depicted in FIG. 13, are dataset instantiated from peer key constraints 1038, 1244, and 1248 respectively shown in FIG. 12. By design, each peer dataset access path supports direct dataset interoperability. Any data content records in an instantiated peer dataset that are directly or indirectly accessible to a peer dataset access path are directly interoperable with any other data content records in connected instantiated peer datasets.

Peer database tables 1316a of database schema 1302 and database table 1316b of dependent peer database schema 1350 are connected by balanced peer dataset access path 1338 as illustrated in FIG. 13. Both peer database tables 1316a and 1316b are populated with a unique set of data content records from a single data file to ensure peer dataset content commonality.

Instantiated peer database tables 1336a, 1336b, and 1336c are connected by unbalanced peer dataset access path 1344 as depicted in FIG. 13. Instantiated peer database table 1336c of independent peer database schema 1394, is the instantiated peer data registry for peer database tables 1336a, and 1336b, which function as instantiated peer dataset connectors for dependent peer database schemas 1302 and 1350, respectively as shown in data architecture schema 1300 of FIG. 13. As the peer data registry, instantiated peer database table 1336c contains the unique identifying database table columns as well as the non-identifying database table columns and ensures direct dataset interoperability of unbalanced peer dataset access path 1344. Peer database tables 1336a and 1336b of dependent peer database schemas 1302 and 1350, respectively, function as instantiated peer dataset connectors to enforce internal referential data integrity for instantiated foreign key constraints in their respective dependent peer database schemas. For example, peer database table 1336a functions as the parent database table for instantiated foreign key constraint 1334 of dependent database schema 1302 as shown in FIG. 13.

Peer database tables 1386a, 1386b, and 1386c of peer database schemas 1302, 1350, and 1380 respectively, are connected by complex peer dataset access path 1348 shown in FIG. 13. In this case, peer database tables 1386a, 1386b, and 1386c all function as peer dataset connector database tables that can also resolve dataset granularity conflicts. Peer database table 1386c in peer database schema 1380 is the instantiated peer data registry for the peer database tables related by complex peer dataset access path 1348. Peer database table 1386c also functions as the parent database table for instantiated foreign key constraints 1387, 1389, and 1391 in independent peer database schema 1380 shown in FIG. 13. In peer database schema 1302, peer database table 1386a functions as the parent database table for instantiated foreign key constraint 1330. In peer database schema 1350, peer database table 1386b functions as the parent database table for instantiated foreign key constraints 1360 and 1368.

In data architecture schema 1300, data content records can be retrieved and combined from both dependent peer database schemas 1302 and 1350 using one or more peer dataset access paths 1338, 1344, and 1348 as depicted in FIG. 13. Additionally, data content records can be retrieved as needed from both independent peer database schemas 1380 and 1394 using peer dataset access paths 1348 and 1344 respectively.

When balanced peer dataset access path 1338 is used to retrieve data content records from dependent peer database schemas 1302 and 1350, peer database tables 1316a and 1316b are used. Since peer database tables 1316a and 1316b have the same database table columns, have the same primary key indexes, and are both populated with data content records from a single source of unique data content records, either peer database table 1316a or 1316b can be employed in data retrieval.

When unbalanced peer dataset access path 1344 is employed to retrieve data content records from both dependent peer database schemas 1302 and 1350, peer database table 1336c is often the most useful since it contains the non-identifying profile data content as well as the unique identifying data content. Each instantiated peer data registry database table is directly interoperable with any database tables related to the instantiated peer data registry's substitute database tables. For example, instantiated peer data registry database table 1336c has two substitute database tables 1336a and 1336b. Database tables 1326 and 1370 are child database tables of substitute database tables 1336a and 1336b respectively as shown in FIG. 13. Therefore, instantiated peer data registry database table 1336c can be directly joined with database tables 1326 and 1368 as illustrated in FIG. 13. Also, either or both peer dataset connector database tables 1336a and 1336b can be employed to retrieve data content records from dependent peer database schemas 1302 and 1350 when only the instantiated peer dataset connector database table's identifying data content is needed.

When complex peer dataset access path 1348 is used to retrieve data content records from both dependent peer database schemas 1302 and 1350, any of the instantiated peer dataset connector database tables can be used, such as peer database tables 1386a, 1386b, or 1386c as shown in FIG. 13. Since peer database tables 1386a, 1386b, and 1386c function as instantiated peer dataset connector database tables, any one of these peer database tables can be used to directly join dependent peer database schemas 1302 and 1350. When a change of data granularity is needed to join dependent peer database schemas 1302 and 1350, any one of the peer database tables 1386a, 1386b, or 1386c can be employed. However, when non-identifying profile data is needed, database tables 1388, 1390, and 1392 will be used in conjunction with a peer database table, such as peer database tables 1386a, 1386b, or 1386c as depicted in data architecture schema 1300 of FIG. 13.

One or more embodiments of the present invention include methods of combining multiple datasets having direct dataset interoperability, that are all populated with data content records into a single dataset that is populated with the data content records combined from the original directly interoperable datasets. The single dataset result will also remain directly interoperable with source datasets in that peer dataset commonality between the source datasets and the results dataset will be maintained.

The importance of the peer dataset connector representations is that for data retrieval, the peer data table representation can be directly joined to any child data table representation of the substitute peer dataset connector representation. For example, in dataset instantiated data architecture schema 700 of FIG. 7, peer database tables 766 and 786 function as instantiated peer dataset connectors for peer database table 736. In all three database tables, 736, 766, and 786 the unique key database table columns have the same data content record values as guaranteed by peer dataset access path 762. For example, the primary key index columns 740, 770, and 790 of the database tables 736, 766, and 786 respectively as depicted in FIG. 7, all contain the same set of data values. As such database table 736 can replace database tables 766 and 786 whenever needed. Since the primary key indexes and the first alternate key indexes are consistently populated with the equivalent data content record data values in the instantiated peer dataset connectors to match the data content record data values of peer database table 736, the peer database table can seamlessly replace the instantiated peer dataset connectors for any data content record retrieval.

In at least one embodiment of the present invention, a method is provided comprising: using a computer processor, such as computer processor 4 in FIG. 1, to access a first data architecture model from a plurality of data architecture models stored in a computer memory, such as computer memory 8; using the computer processor 4 to store a first peer dataset architecture map in the first data architecture model in the computer memory 8; using the computer processor 4 to display the first data architecture map, in accordance with computer software stored in the computer memory 8; wherein the first peer dataset architecture map includes a plurality of high-level PDMD representations, such that each of the plurality of high-level PDMD representations of the first peer dataset architecture map contains at least one peer key constraint that relates two or more high-level PDMD representations of the first peer dataset architecture map of the first data architecture model.

FIG. 14 depicts a peer dataset architecture map 1400 in its federated form. The purpose of the peer dataset architecture map is to show each high-level peer PDMD representation, which represents a named peer dataset domain, and their peer key constraint representations that show dataset interoperability between named peer dataset domains.

Peer dataset architecture map 1400 contains high-level representations of independent peer PDMDs 1401, 1411, 1421, and 1431 and dependent peer PDMDs 1441, 1451, 1461, 1471, 1481, and 1491.

High-level independent peer PDMD representation 1401 depicts peer dataset domain 1404 labeled “Calendar” that includes physical data environment specification 1402 and physical data environment specification name 1403 labeled “IA”. Peer PDMD representation 1401 also includes peer key constraint representations 1501 and 1502 labeled “A” and “B” respectively. Each peer key constraint representation has a label to indicate which peer key constraint representations are the same. For example, any peer key constraint representation with the label “A” is part of the same peer key constraint representation. For peer key constraint representations, the arrowhead pointing away from the peer PDMD, such as arrowheads 1501a and 1502a, indicates that peer PDMD representation 1401 represents an independent peer PDMD and the single source of data content records for both the peer key constraint representations 1501 and 1502.

High-level independent peer PDMD representation 1411 depicts peer dataset domain 1414 labeled “Location” which includes physical data environment specification 1412 and physical data environment specification name 1413 labeled “IB”. Peer PDMD representation 1411 also includes peer key constraint representation 1503 labeled “C”. The arrowhead 1503a pointing away from the peer PDMD representation 1411 indicates that peer PDMD representation 1411 is an independent peer PDMD and the single source of data content records for peer key constraint representation 1503.

High-level independent peer PDMD representation 1421 depicts peer dataset domain 1424 labeled “Product” which includes physical data environment specification 1422 and physical data environment specification name 1423 labeled “CC”. High-level peer PDMD representation 1421 is the high-level representation for independent peer PDMD 1280 shown in data architecture model 1200 of FIG. 12. Peer PDMD representation 1421 also includes peer key constraint representations 1504 and 1501 labeled “D” and “A” respectively. Peer key constraint representation 1504 of FIG. 14 is the high-level representation of peer key constraint 1248 of data architecture model 1200 shown in detail in FIG. 12. The arrowhead 1504a pointing away from peer PDMD representation 1421 for peer key constraint 1504 indicates that peer PDMD representation 1421 is the single source of data content records for peer key constraint representation 1504. The arrowhead 1501b pointing toward peer PDMD representation 1421 for peer key constraint representation 1501 indicates that peer PDMD representation 1421 is not the single source of data content records for peer key constraint representation 1501.

Each high-level peer PDMD representation of peer dataset architecture map 1400 shown in FIG. 14, is a high-level representation of a peer PDMD where the details of the peer PDMD are not shown. For example, in FIG. 14, high-level peer PDMD representations 1421, 1431, 1451, and 1491 are less detailed representations of peer PDMDs 1280, 1294, 1202, and 1250, respectively of data architecture model 1200 shown in FIG. 12. Each high-level peer PDMD representation of peer dataset architecture map 1400, hides the plurality of data table representations, peer dataset connector representations, foreign key constraints, and peer key constraints such as shown in PDMD 1280 of FIG. 12. Each high-level peer PDMD representation (including 1401, 1411, 1421, 1431, 1441, 1451, 1461, 1471, 1481, and 1491) of the peer dataset architecture map is displayed on a computer monitor or display device, such as display device 6 of FIG. 1. Each high-level peer PDMD representation is selectable or clickable, such as through a computer touch screen or computer mouse of interactive device 2 of FIG. 1, by selecting anywhere on a particular high-level peer PDMD representation of 1401, 1411, 1421, 1431, 1441, 1451, 1461, 1471, 1481, or 1491, and display its associated detailed peer PDMD as needed by the computer user. For example, upon clicking on high-level peer PDMD representation 1421 (anywhere inside the box 1422) of FIG. 14, detailed peer PDMD 1280 of FIG. 12 would be displayed on the display device 6, in accordance with computer software stored in computer memory 8 as implemented by computer processor 4.

High-level independent peer PDMD representation 1431 depicts peer dataset domain 1434 labeled “Organization” which includes physical data environment specification 1432 and physical data environment specification name 1433 labeled “DD”. High-level peer PDMD representation 1431 of FIG. 14, is the high-level representation for independent peer PDMD 1294 shown in data architecture model 1200 of FIG. 12. High-level Peer PDMD representation 1431 also includes peer key constraint representation 1505 labeled “E”. Peer key constraint representation 1505 of FIG. 14 is the less detailed representation of peer key constraint 1244 of data architecture model 1200 shown in detail in FIG. 12. In FIG. 14, arrowhead 1505a which is pointing away from the peer PDMD representation 1431 for peer key constraint representation 1505 indicates that peer PDMD representation 1431 is the single source of data content records for peer key constraint representation 1505.

High-level dependent peer PDMD representation 1441 depicts peer dataset domain 1444 labeled “Inventory” which includes physical data environment specification 1442 and physical data environment specification name 1443 labeled “DA”. Peer PDMD representation 1441 also includes peer key constraint representations 1502, 1503, and 1504 labeled “B”, “C”, and “D” respectively. Arrowheads 1502b, 1503b, and 1504b, which are pointing toward peer PDMD representation 1441, indicate that peer PDMD representation 1441 depicts a dependent peer PDMD and not a single source of data content records for peer key constraint representations 1502, 1503, or 1504.

High-level dependent peer PDMD representation 1451 depicts peer dataset domain 1454 labeled “Sales” which includes physical data environment specification 1452 and physical data environment specification name 1453 labeled “AA”. High-level peer PDMD representation 1451 is the high-level representation for dependent peer PDMD 1202 shown in data architecture model 1200 of FIG. 12. High-level Peer PDMD representation 1451 also includes peer key constraint representations 1502, 1504, and 1505 labeled “B”, “D”, and “E”, respectively. Peer key constraint representation 1504 of FIG. 14 is the high-level representation of peer key constraint 1248 of data architecture model 1200 shown in detail in FIG. 12. Peer key constraint representation 1505 of FIG. 14 is the high-level representation of peer key constraint 1244 of data architecture model 1200 shown in detail in FIG. 12. Arrowheads 1502c, 1504c, and 1505c, which are all pointing toward the peer PDMD representation 1451 for peer key constraint representation 1502, 1504, and 1505, respectively, indicates that peer PDMD representation 1451 is not the single source of data content records for peer key constraint representations 1502. 1504, and 1505.

High-level dependent peer PDMD representation 1461 depicts peer dataset domain 1464 labeled “Finance” which includes physical data environment specification 1462 and physical data environment specification name 1463 labeled “DC”. Peer PDMD representation 1461 also includes peer key constraint representations 1502, 1503, 1504, and 1505 labeled “B”, “C”, “D”, and “E”, respectively. Arrowheads 1502d, 1503d, 1504d, and 1505d, which are all pointing toward peer PDMD representation 1461 indicate that peer PDMD representation 1461 depicts a dependent peer PDMD and not a single source of data content records for peer key constraint representations 1502, 1503, 1504, or 1505.

High-level dependent peer PDMD representation 1471 depicts peer dataset domain 1474 labeled “Manufacturing” which includes physical data environment specification 1472 and physical data environment specification name 1473 labeled “DF”. Peer PDMD representation 1471 also includes peer key constraint representations 1502, 1503, and 1504 labeled “B”, “C”, and “D”, respectively.

High-level dependent peer PDMD representation 1481 depicts peer dataset domain 1484 labeled “Procurement” which includes physical data environment specification 1482 and physical data environment specification name 1483 labeled “DE”. Peer PDMD representation 1481 also includes peer key constraint representations 1502, 1503, and 1505 labeled “B”, “C”, and “E”, respectively.

High-level dependent peer PDMD representation 1491 depicts peer dataset domain 1494 labeled “Shipping” which includes physical data environment specification 1492 and physical data environment specification name 1493 labeled “BB”. High-level peer PDMD representation 1491 is the high-level representation for dependent peer PDMD 1250 shown in data architecture model 1200 of FIG. 12. High-level Peer PDMD representation 1491 also includes peer key constraint representations 1502, 1503, 1504, and 1505 labeled “B”, “C”, “D”, and “E”, respectively. Peer key constraint representation 1504 of FIG. 14 is the high-level representation of peer key constraint 1248 of data architecture model 1200 shown in detail in FIG. 12. Peer key constraint representation 1505 of FIG. 14 is the high-level representation of peer key constraint 1244 of data architecture model 1200 shown in detail in FIG. 12.

FIG. 15 depicts a peer dataset architecture map 1600 in a consolidated form derived from peer dataset architecture map 1400 shown in FIG. 14. Peer data architecture map 1600 of FIG. 15 was derived by combining peer PDMD representations 1401, 1411, 1421, 1431, 1451, and 1461 from peer dataset architecture map 1400 of FIG. 14. Peer key constraint representations from peer dataset architecture map 1400 are connected in the consolidated form peer dataset architecture map 1600 to form the joins shown in FIG. 15.

In FIG. 15, high-level independent peer PDMD representation 1401 is the same peer PDMD representation 1401 shown in FIG. 14. In FIG. 15, peer key constraint representations 1501 and 1502 attached to peer PDMD representation 1401 are the same peer key constraint representations 1501 and 1502 attached to peer PDMD representation 1401 shown in FIG. 14.

In FIG. 15, high-level independent peer PDMD representation 1411 is the same peer PDMD representation 1411 shown in FIG. 14. In FIG. 15, peer key constraint representation 1503 attached to peer PDMD representation 1411 is the same peer key constraint representations 1503 attached to peer PDMD representation 1411 shown in FIG. 14.

In FIG. 15, high-level independent peer PDMD representation 1421 is the same peer PDMD representation 1421 shown in FIG. 14. In FIG. 15, peer key constraint representations 1501 and 1504 attached to peer PDMD representation 1421 are the same peer key constraint representations 1501 and 1504 attached to peer PDMD representation 1421 shown in FIG. 14. Peer key constraints representations with equivalent labels attached to the peer PDMD representations form the joins between peer PDMD representations. In FIG. 15, peer key constraint representation 1501, which is attached to peer PDMD representation 1421 with arrow 1501b, joins with peer key constraint representation 1501 attached to peer PDMD representation 1401 with arrow 1501a.

In FIG. 15, high-level independent peer PDMD representation 1431 is the same peer PDMD representation 1431 shown in FIG. 14. In FIG. 15, peer key constraint representations 1505 attached to peer PDMD representation 1431 is the same peer key constraint representations 1505 attached to peer PDMD representation 1431 shown in FIG. 14.

In FIG. 15, high-level dependent peer PDMD representation 1451 is the same peer PDMD representation 1451 shown in FIG. 14. In FIG. 15, peer key constraint representations 1502, 1504, and 1505 attached to peer PDMD representation 1451 are the same peer key constraint representations 1502, 1504, and 1505 attached to peer PDMD representation 1451 shown in FIG. 14. In FIG. 15, peer key constraint representation 1502 attached to peer PDMD representation 1451 by arrow 1502c, joins with peer key constraint representation 1502 attached to peer PDMD representation 1401 by arrow 1502a. Peer key constraint representation 1504 attached to peer PDMD representation 1451 by arrow 1504c, joins with peer key constraint representation 1504 attached to peer PDMD representation 1421 by arrow 1504a. This join is also detailed by peer key constraint 1248 shown in FIG. 14. In FIG. 15, peer key constraint representation 1505 attached to peer PDMD representation 1451 joins with peer key constraint representation 1505 attached to peer PDMD representation 1431. This join is also detailed by peer key constraint 1244 shown in FIG. 14.

In FIG. 15, high-level dependent peer PDMD representation 1461 is the same peer PDMD representation 1461 shown in FIG. 14. In FIG. 15, peer key constraint representations 1502, 1503, 1504, and 1505 attached to peer PDMD representation 1461 are the same peer key constraint representations 1502, 1503, 1504, and 1505 attached to peer PDMD representation 1461 shown in FIG. 14. In FIG. 15, peer key constraint representation 1502 attached to peer PDMD representation 1461 by arrow 1502d joins, with peer key constraint representation 1502 attached to peer PDMD representation 1401 by arrow 1502a, and joins with peer key constraint representation 1502 attached to peer PDMD representation 1451 by arrow 1502c. Peer key constraint representation 1503 attached to peer PDMD representation 1461 by arrow 1503d, joins with peer key constraint representation 1503 attached to peer PDMD representation 1411 by arrow 1503a. Peer key constraint representation 1504 attached to peer PDMD representation 1461 by arrow 1504d, joins with peer key constraint representation 1504 attached to peer PDMD representation 1421 by arrow 1504a, and peer key constraint representation 1504 attached to peer PDMD representation 1451 by arrow 1504c. Peer key constraint representation 1505 attached to peer PDMD representation 1461 by arrow 1505d, joins with peer key constraint representation 1505 attached to peer PDMD representation 1431 by arrow 1505a, and peer key constraint representation 1505 attached to peer PDMD representation 1451 by arrow 1505c.

In at least one embodiment, the peer dataset architecture map 1600 shown in FIG. 15 is displayed on a computer monitor or display device such as display device 6, as programmed by computer software stored in computer memory 8 as implemented by computer processor 4 shown in FIG. 1. Each high-level peer PDMD representation (including 1401, 1411, 1421, 1431, 1451, and 1461) of the peer dataset architecture map 1600 is displayed on a computer monitor or display device, such as display device 6 of FIG. 1, and is selectable or clickable, such as through a computer touch screen or computer mouse of interactive device 2 of FIG. 1, by clicking anywhere on a selected high-level peer PDMD representation (including any of 1401, 1411, 1421, 1431, 1451, and 1461, shown in FIG. 15), and display its associated detailed peer PDMD as needed by the computer user. For example, upon clicking on high-level peer PDMD representation 1451 (anywhere inside the box 1452) of FIG. 15, detailed peer PDMD 1202 of FIG. 12 would be displayed on the display device 6, in accordance with computer software stored in computer memory 8 as implemented by computer processor 4. A peer dataset architecture map, such as peer dataset architecture map 1600 shown in FIG. 15, is used to architect how peer datasets can be reliably joined to retrieve and combine data content records from multiple peer datasets.

I claim:

1. A method comprising:
using a computer processor to execute a data architecture modeling program that accesses a first data architecture model stored in a computer memory;
wherein the first data architecture model contains a first peer dataset architecture map;
wherein the first peer dataset architecture map includes a plurality of peer physical data model diagrams;
wherein each peer physical data model diagram of the plurality of peer physical data model diagrams is uniquely identified within the first peer dataset architecture map;
wherein the first peer dataset architecture map includes a plurality of peer key constraint representations;
wherein each peer key constraint representation of the plurality of peer key constraint representations is uniquely identified within the first peer dataset architecture map;
wherein each peer physical data model diagram of the plurality of peer physical data model diagrams includes one or more peer key constraint representations of the plurality of peer key constraint representations;
wherein each peer key constraint representation of the plurality of peer key constraint representations depicts a connection of two or more peer physical data model diagrams of the plurality of peer physical data model diagrams; and
wherein each peer key constraint representation of the plurality of peer key constraint representations is architected to ensure external referential data integrity among a plurality of peer datasets architected from the two or more peer physical data model diagrams of the plurality of peer physical data model diagrams.

2. The method of claim 1
wherein the first data architecture model contains a plurality of logical entity relationship diagrams;
wherein the first peer dataset architecture map provides a graphical depiction of the plurality of peer physical data model diagrams and the plurality of peer key constraint representations;
wherein each peer physical data model diagram, of the plurality of peer physical data model diagrams, is a derived analog of a logical entity relationship diagram of the plurality of logical entity relationship diagrams; and
wherein any two or more peer physical data model diagrams, of the plurality of peer physical data model diagrams, are configured to be depicted in a consolidated form derived from the first peer dataset architecture map, provided they are connected by one or more peer key constraint representations of the plurality of peer key constraint representations.

3. The method of claim 2
wherein each peer physical data model diagram, of the plurality of peer physical data model diagrams, contains a plurality of data table representations and a plurality of foreign key constraint representations;
wherein each data table representation, of the plurality of data table representations, contains a plurality of data table columns; and
wherein each foreign key constraint representation, of the plurality of foreign key constraint representations, joins one parent data table representation to one child data table representation, of the plurality of data table representations contained within each peer physical data model diagram.

4. The method of claim 3
wherein each logical data entity relationship diagram, of the plurality of logical data entity relationship diagrams, contains a plurality of data entities;
wherein each data entity, of the plurality of data entities contained in each logical data entity relationship diagram, contains a plurality of data attributes;
wherein each logical data entity relationship diagram, of the plurality of logical data entity relationship diagrams, contains a plurality of data entity relationships;
wherein each data entity relationship, of the plurality of data entity relationships contained in a logical data entity relationship diagram, joins one parent data entity and one child data entity from the plurality of data entities contained in the logical data entity relationship diagram;
wherein each data table representation, of the plurality of data table representations of each peer physical data model diagram, is a derived analog of a data entity of the plurality of data entities contained in a logical entity relationship diagram;
wherein each data table column, of the plurality of data table columns of each data table representation of each peer physical data model diagram, is a derived analog of a data attribute of the plurality of data attributes contained in a data entity of the plurality of data entities contained in a logical entity relationship diagram; and
wherein each foreign key constraint representation, of the plurality of foreign key constraint representations of each peer physical data model diagram, is a derived analog of a data entity relationship of the plurality of data entity relationships contained in a logical entity relationship diagram.

5. The method of claim 3
wherein the plurality of peer physical data model diagrams contains a plurality of independent peer physical data model diagrams and a plurality of dependent peer physical data model diagrams;
wherein each peer key constraint representation, of the plurality of peer key constraint representations, constrains one or more dependent peer physical data model diagrams, of the plurality of dependent peer physical data model diagrams, by a single independent peer physical data model diagram of the plurality of independent peer physical data model diagrams;
wherein each peer key constraint representation, of the plurality of peer key constraint representations, is architected to ensure external referential data integrity among a plurality of peer datasets architected in the multiple peer physical data model diagrams of the plurality of peer physical data model diagrams in the first peer dataset architecture map;
wherein each of the plurality of independent peer physical data model diagrams is architected to be shared by two or more of the plurality of dependent peer physical data model diagrams; and
wherein each of the dependent peer physical data model diagrams, of the plurality of dependent peer physical data model diagrams, is constrained by one or more independent peer physical data model diagrams of the plurality of independent peer physical data model diagrams.

6. The method of claim 5
wherein a first independent peer physical data model diagram, of the plurality of independent peer physical data model diagrams, constrains a first dependent peer physical data model diagram of the plurality of dependent peer physical data model diagrams;
wherein the plurality of data table representations, contained within the first independent peer physical data model diagram of the plurality of independent peer physical data model diagrams, includes a first peer data table representation;
wherein the first peer data table representation, of the first independent peer physical data model diagram, contains a first unique key;
wherein the plurality of data table representations contained within the first dependent peer physical data model diagram, of the plurality of dependent peer physical data model diagrams, includes a first copy of the first peer data table representation;
wherein the copy of the first peer data table representation of the first dependent peer physical data model diagram contains a first copy of the first unique key;
wherein a first peer key constraint representation, of the plurality of peer key constraint representations, is architected to join the first independent peer physical data model diagram with the first dependent peer physical data model diagram by depicting a connection of the first unique key, of the first peer data table representation of the first independent peer physical data model diagram, with the first copy of the first unique key, of the first copy of the first peer data table representation of the first dependent peer physical data model diagram; and
wherein the first peer data table representation of the first independent peer physical data model diagram is architected to constrain the first copy of the first peer data table representation of the first dependent peer physical data model diagram to ensure external referential data integrity between the peer datasets architected in the first independent peer physical data model diagram and the first dependent peer physical data model diagram.

7. The method of claim 6
wherein the plurality of dependent peer physical data model diagrams includes a second dependent peer physical data model diagram;
wherein the second dependent peer physical data model diagram contains a plurality of data table representations;
wherein the plurality of data table representations, of the second dependent peer physical data model diagram, includes a second copy of the first peer data table representation;
wherein the second copy of the first peer data table representation of the second dependent peer physical data model diagram contains a second copy of the first unique key;
and further comprising:
modifying the first peer key constraint representation, of the plurality of peer key constraint representations, to also join the first independent peer physical data model diagram with the second dependent peer physical data model diagram by depicting a connection of the first unique key of the first peer data table representation, of the first independent peer physical data model diagram, with the second copy of the first unique key of the second copy of the first peer data table representation, of the second dependent peer physical data model diagram;
wherein the first peer data table representation, of the first independent peer physical data model diagram, is architected to constrain the second copy of the first peer data table representation, of the second dependent peer physical data model diagram, to ensure external referential data integrity between the peer datasets architected in the first independent peer physical data model diagram and the second dependent peer physical data model diagram; and
wherein the first peer data table representation, of the first independent peer physical data model diagram, is architected to ensure external referential data integrity between the peer datasets architected in the first dependent peer physical data model diagram and the second dependent peer physical data model diagram.

8. The method of claim 7
wherein the plurality of independent peer physical data model diagrams includes a second independent peer physical data model diagram;
wherein the second independent peer physical data model diagram contains a plurality of data table representations;
wherein the plurality of data table representations of the second independent peer physical data model diagram includes a second peer data table representation;
wherein the second peer data table representation of the second independent peer physical data model diagram contains a second unique key;
wherein the plurality of data table representations, of the first dependent peer physical data model diagram, contains a first copy of the second peer data table representation;
wherein the first copy of the second peer data table representation, of the first dependent peer physical data model diagram, contains a first copy of the second unique key;
wherein the plurality of data table representations, of the second dependent peer physical data model diagram, contains a second copy of the second peer data table representation;
wherein the second copy of the second peer data table representation, of the second dependent peer physical data model diagram, contains a second copy of the second unique key;
wherein a second peer key constraint representation, of the plurality of peer key constraint representations, is architected to join the second independent peer physical data model diagram with the first dependent peer physical data model diagram by depicting a connection of the second unique key of the second peer data table representation, of the second independent peer physical data model diagram, with the first copy of the second unique key of the first copy of the second peer data table representation, of the first dependent peer physical data model diagram;
wherein the second peer key constraint representation, of the plurality of peer key constraint representations, is architected to join the second independent peer physical data model diagram with the second dependent peer physical data model diagram by depicting a connection of the second unique key of the second peer data table representation, of the second independent peer physical data model diagram, with the second copy of the second unique key of the second copy of the second peer data table representation, of the second dependent peer physical data model diagram;
wherein the second peer data table representation of the second independent peer physical data model diagram is architected to constrain the first copy of the second peer data table representation of the first dependent peer physical data model diagram, to ensure external referential data integrity between the peer datasets architected in the second independent peer physical data model diagram and the first dependent peer physical data model diagram;
wherein the second peer data table representation of the second independent peer physical data model diagram constrains the second copy of the second peer data table representation of the second dependent peer physical data model diagram to ensure external referential data integrity between the peer datasets architected in the second independent peer physical data model diagram and the second dependent peer physical data model diagram; and
wherein the second peer data table representation, of the second independent peer physical data model diagram, is architected to ensure external referential data integrity between the peer datasets architected in the first dependent peer physical data model diagram and the second dependent peer physical data model diagram.

9. A method comprising:
using a computer processor to execute a data architecture modeling program that accesses a first data architecture model stored in a computer memory;
wherein the first data architecture model contains a plurality of peer physical data model diagrams;
wherein a first peer physical data model diagram of the plurality of peer physical data model diagrams contains a first plurality of data table representations and a first plurality of foreign key constraint representations;
wherein each foreign key constraint representation of the first plurality of foreign key constraint representations is architected to join a parent data table representation to a child data table representation of the first plurality of data table representations contained within the first peer physical data model diagram;
wherein a second peer physical data model diagram of the plurality of peer physical data model diagrams contains a second plurality of data table representations and a second plurality of foreign key constraint representations;
wherein each foreign key constraint representation of the second plurality of foreign key constraint representations is architected to join a parent data table representation to a child data table representation of the second plurality of data table representations contained within the second peer physical data model diagram;
wherein the first plurality of data table representations contained in the first peer physical data model diagram contains a first peer data table representation;
wherein the first peer data table representation, of the first plurality of data table representations, contains a first unique key;
wherein the second plurality of data table representations, contained in the second peer physical data model diagram, contains a first copy of the first peer data table representation;
wherein the first copy of the first peer data table representation, of the second plurality of data table representations, contains a first copy of the first unique key;
wherein the first data architecture model contains a plurality of peer key constraint representations;
wherein a first peer key constraint representation, of the plurality of peer key constraint representations, is architected to connect the first unique key, of the first peer data table representation of the first peer physical data model diagram, with the first copy of the first unique key, of the first copy of the first peer data table representation of the second peer physical data model diagram;
wherein the data architecture modeling program includes:
adding a third peer physical data model diagram to the plurality of peer physical data model diagrams of the first data architecture model;
adding a second copy of the first peer data table representation to be contained in the third peer physical data model diagram, after adding the third peer physical data model diagram to the plurality of peer physical data model diagrams of the first data architecture model;
adding a second copy of the first unique key to the second copy of the first peer data table representation of the third peer physical data model diagram, after adding the third peer physical data model diagram to the plurality of peer physical data model diagrams of the first data architecture model;
adding a connection to the first peer key constraint representation of the plurality of peer key constraint representations; and
wherein the first peer key constraint representation of the plurality of peer key constraint representations connects the second copy of the first unique key of the second copy of the first peer data table representation of the third peer physical data model diagram, with the first copy of the first unique key of the first copy of the first peer data table representation of the second peer physical data model diagram, and with the first unique key of the first peer data table representation of the first physical data model diagram.

10. The method of claim 9
wherein the first data architecture model contains a plurality of logical entity relationship diagrams;
wherein the first data architecture model contains a first logical entity relationship diagram of the plurality of logical entity relationship diagrams;
wherein the first logical entity relationship diagram contains a plurality of data entities;
wherein the first logical entity relationship diagram contains a plurality of data entity relationships;
wherein each data entity relationship of the plurality of data entity relationships is architected to relate one parent data entity to one child data entity;
wherein the first peer physical data model diagram is a first analog derived from the first logical entity relationship diagram;
wherein the second peer physical data model diagram is a second analog derived from the first logical entity relationship diagram;
wherein the third peer physical data model diagram is a third analog derived from the first logical entity relationship diagram;
wherein the first logical entity relationship diagram contains a first data entity of the plurality of data entities;
wherein the first data entity of the plurality of data entities contains a first primary key;
wherein the first peer data table representation of the first peer physical data model diagram, the first copy of the first peer data table representation of the second peer physical data model diagram, and the second copy of the first peer data table representation of the third peer physical data model diagram are analogs derived from the first data entity of the plurality of data entities contained in the first logical entity relationship diagram;
wherein the first unique key of the first peer data table representation of the first peer physical data model diagram, the first copy of the first unique key of the first copy of the first peer data table representation of the second peer physical data model diagram, and the second copy of the first unique key of the second copy of the first peer data table representation of the third peer physical data model diagram are analogs derived from the first primary key of the first data entity of the plurality of data entities contained in the first logical entity relationship diagram;
and wherein the first peer key constraint representation of the plurality of peer key constraint representations is architected to join the first, second, and third analogs.

11. The method of claim 9
wherein the first peer key constraint representation has a peer data registry representation;
wherein the second copy of the first peer data table representation of the third peer physical data model diagram is architected as the peer data registry representation for the first peer key constraint representation;
wherein the peer data registry representation is architected as a single source of data content records for the first peer data table representation of the first peer physical data model diagram, and the first copy of the first peer data table representation of the second peer physical data model diagram;
wherein the peer data registry representation is architected to enforce peer dataset content commonality among the first peer data table representation of the first peer physical data model diagram, and the first copy of the first peer data table representation of the second peer physical data model diagram;
wherein the first peer data table representation of the first physical data model diagram is architected to contain a first subset of the single source of data content records; and
wherein the first copy of the first peer data table representation of the second peer physical data model diagram is architected to contain a second subset of the single source of data content records.

12. The method of claim 11
wherein the first unique key of the first peer data table representation of the first physical data model diagram, the first copy of the first unique key of the first copy of the first peer data table representation of the second peer physical data model diagram, and and the second copy of the first unique key of second copy of the first peer data table representation of the third peer physical data model diagram are architected to provide peer identifying metadata commonality within the first data architecture model; and
wherein the first data architecture model is architected to provide direct dataset interoperability.

13. The method of claim 9
wherein the first peer data table representation of the first physical data model diagram contains a first plurality of data table columns;
wherein the first plurality of data table columns contained in the first peer data table representation includes a first plurality of non-identifying data table columns;
wherein the first copy of the first peer data table representation of the second peer physical data model diagram contains a second plurality of data table columns;
wherein the second plurality of data table columns contained in the first copy of the first peer data table representation includes a first copy of the first plurality of non-identifying data table columns;
wherein the second copy of the first peer data table representation of the third peer physical data model diagram contains a third plurality of data table columns;
wherein the third plurality of data table columns contained in the second copy of the first peer data table representation includes a second copy of the first plurality of non-identifying data table columns;
and further comprising modifying the first data architecture model to remove redundant data by:
removing one or more data table columns from the first plurality of non-identifying data table columns from the first peer data table representation of the first peer physical data model diagram; and
removing one or more data table columns from the first copy of the first plurality of non-identifying data table columns of the copy of the first peer data table representation of the second peer physical data model diagram.

14. The method of claim 13
wherein the first peer physical data model diagram is dependent on the third peer physical data model diagram, by the first peer physical data model diagram being architected to share non-identifying data table columns from the second copy of the first plurality of non-identifying data table columns contained in the second copy of the first peer data table representation of the third peer physical data model diagram;
wherein the second peer physical data model diagram is dependent on the third peer physical data model diagram, by the second peer physical data model diagram being architected to share non-identifying data table columns from the second copy of the first plurality of non-identifying data table columns contained in the second copy of the first peer data table representation of the third peer physical data model diagram;
wherein the first peer physical data model diagram and the third peer physical data model diagram are architected to form a first complete dataset, which is a combination of a dependent peer dataset architected in the first peer physical data model diagram and an independent peer dataset architected in the third peer physical data model diagram;
wherein the second peer physical data model diagram and the third peer physical data model diagram are architected to form a second complete dataset, which is a combination of a dependent peer dataset architected in the second peer physical data model diagram and the independent peer dataset architected in the third peer physical data model diagram;
wherein the first peer key constraint representation is architected to form a first peer dataset access path between the dependent peer dataset architected in the first peer physical data model diagram and the independent peer dataset architected in the third peer physical data model diagram;
wherein the first peer key constraint representation is architected to form a second peer dataset access path between the dependent peer dataset architected in the first peer physical data model diagram and the independent peer dataset architected in the third peer physical data model diagram; and
wherein the first peer key constraint representation is architected to form a third peer dataset access path between the dependent peer dataset architected in the first peer physical data model diagram and the dependent peer dataset architected in the second peer physical data model diagram.

15. The method of claim 9
wherein the first peer data table representation of the first peer physical data model diagram contains a second unique key;
wherein the first copy of the first peer data table representation of the second peer physical data model diagram contains a first copy of the second unique key;
wherein the second copy of the first peer data table representation of the third peer physical data model diagram contains a second copy of the second unique key;
and further comprising:
modifying the first peer key constraint representation of the plurality of peer key constraint representations so that the first peer key constraint representation of the plurality of peer key constraint representations connects a first, a second, and a third combination;
wherein the first combination is of the first unique key combined with the second unique key contained in the first peer data table representation of the first physical data model diagram;
the second combination is of the first copy of the first unique key combined with the first copy of the second unique key contained in the first copy of the first peer data table representation of the second peer physical data model diagram;
and the third combination is of the second copy of the first unique key combined with the second copy of the second unique key contained in the second copy of the first peer data table representation of the third peer physical data model diagram;
wherein the first peer key constraint representation constrains the first peer data table representation contained in the first peer physical data model diagram using the first combination;
wherein the first peer key constraint representation constrains the first copy of the first peer data table representation contained in the second peer physical data model diagram using the second combination; and
wherein the first peer key constraint representation constrains the second copy of the first peer data table representation contained in the third peer physical data model diagram using the second combination.

16. The method of claim 15
wherein the first plurality of data table representations in the first peer physical data model diagram contains a first data table representation;
wherein a first foreign key constraint representation, of the first plurality of foreign key constraint representations contained in the first peer physical data model diagram, is architected to relate the first peer data table representation contained in the first peer physical data model diagram, as a parent data table representation, to the first data table representation contained in the first peer physical data model diagram, as a child data table representation;
wherein the data architecture modeling program includes causing the first data table representation, contained in the first peer physical data model diagram, to inherit the first unique key of the first peer data table representation, contained in the first peer physical data model diagram, as a first foreign key of the first data table representation in the first peer physical data model diagram;
wherein the first plurality of data table representations in the second peer physical data model diagram contains a first data table representation;
wherein a first foreign key constraint representation, of the first plurality of foreign key constraint representations contained in the second peer physical data model diagram, is architected to relate the first copy of the first peer data table representation contained in the second peer physical data model diagram, as a parent data table representation, to the first data table representation contained in the second peer physical data model diagram, as a child data table representation; and
wherein the data architecture modeling program includes causing the first data table representation, contained in the second peer physical data model diagram, to inherit the first copy of the second unique key of the first copy of the first peer data table representation, contained in the second peer physical data model diagram, as a first foreign key of the first data table representation in the second peer physical data model diagram.

17. The method of claim 15
wherein the data architecture modeling program includes adding a first data table representation to the third peer physical data model diagram; and adding a first foreign key constraint to the third peer physical data model diagram, after the first data table representation is added to the third peer physical data model diagram;
and wherein the third peer physical data model diagram is architectected to relate the second copy of the first peer data table representation contained in the third peer physical data model diagram, as a parent data table representation, to the first data table representation contained in the third peer physical data model diagram, as a child data table representation;
wherein the data architecture modeling program includes causing the first data table representation, contained in the third peer physical data model diagram, to inherit the second copy of the first unique key of the second copy of the first peer data table representation, contained in the third peer physical data model diagram, combined with the second copy of the second unique key of the second copy of the first peer data table representation, contained in the third peer physical data model diagram, as a first foreign key of the first data table representation, contained in the third peer physical data model diagram.

18. The method of claim 9
wherein the first peer physical data model diagram is architected for a first physical data environment specification that includes a first database schema;
wherein the second peer physical data model diagram is architected for a second physical data environment specification that includes a second database schema; and
wherein the third physical data model diagram is architected for a third physical data environment specification that includes a third database schema.

19. A method comprising:
using a computer processor to execute a data architecture modeling program that accesses a first data architecture model stored in a computer memory;
wherein the first data architecture model contains a plurality of physical data model diagrams;
wherein each physical data model diagram of the plurality of physical data model diagrams is architected to form a disparate dataset;
wherein each physical data model diagram of the plurality of physical data model diagrams contains a plurality of data table representations and a plurality of foreign key constraint representations;
wherein each foreign key constraint representation, of the plurality of foreign key constraint representations contained in each physical data model diagram, joins one parent data table representation of the plurality of data table representations, to one child data table representation of the plurality of data table representations contained within each physical data model diagram;
wherein the one parent data table representation and the one child data table representation, joined by a foreign key constraint representation, are both stored in the computer memory in a single physical data model diagram;
wherein the plurality of physical data model diagrams contained in the first data architecture model includes a first physical data model diagram and a second physical data model diagram;
wherein the first physical data model diagram is architected to form a dataset that includes a first plurality of master data domains;
wherein the first plurality of master data domains of the first physical data model diagram includes a first master data domain;
wherein the second physical data model diagram is architected to form a dataset that includes a second plurality of master data domains;
wherein the second plurality of master data domains of the second physical data model diagram includes the first master data domain;
and wherein the data architecture modeling program includes modifying the first data architecture model to convert the first and second physical data model diagrams, architected to form disparate datasets, to peer physical data model diagrams, architected to form directly interoperable datasets, by:
architecting a first peer dataset connector representation for the first master data domain, wherein the first peer dataset connector representation is reusable in multiple physical data model diagrams of the plurality of physical data model diagrams, wherein the first peer dataset connector representation contains a first unique key;
incorporating the first peer dataset connector representation with a first unique key into the first physical data model diagram, converting the first physical data model diagram into a first peer physical data model diagram;
incorporating a first copy of the first peer dataset connector representation with a first copy of a first unique key into the second physical data model diagram, converting the second physical data model diagram into a second peer physical data model diagram; and
adding a first peer key constraint representation, architected to join the first unique key of the first peer dataset connector representation, contained in the first peer physical data model diagram, with the first copy of the first unique key of the first copy of the first peer dataset connector representation, contained in the second peer physical data model diagram.

20. The method of claim 19
wherein the first unique key of the first peer dataset connector representation uniquely identifies data instances of the first master data domain;
wherein the data architecture modeling program causes the first peer dataset connector representation to be incorporated into the first peer physical data model diagram by:
adding a first foreign key constraint representation to the plurality of foreign key constraint representations in the first peer physical data model diagram;
wherein the data architecture modeling program includes causing a first data table representation, of the plurality of data table representations contained in the first peer physical data model diagram, to inherit the first unique key of the first peer dataset connector representation, of the first peer physical data model diagram, as a foreign key of the first data table representation contained in the first peer physical data model diagram;
wherein the first copy of the first unique key of the first copy of the first peer dataset connector representation uniquely identifies data instances of the first master data domain;
wherein the data architecture modeling program causes the first copy of the first peer dataset connector representation to be incorporated into the second peer physical data model diagram by:
adding a first foreign key constraint representation to the plurality of foreign key constraint representations in the second peer physical data model diagram; and
wherein the data architecture modeling program includes causing a first data table representation of the plurality of data table representations contained in the second peer physical data model diagram to inherit the first copy of the first unique key of the first copy of the first peer dataset connector representation of the second peer physical data model diagram as a foreign key of the first data table representation contained in the second peer physical data model diagram.

21. The method of claim 19
wherein the first data architecture model contains a logical entity relationship diagram;
wherein the logical entity relationship diagram contains a plurality of data entities;
wherein the logical entity relationship diagram contains a plurality of data entity relationships;
wherein each data entity relationship of the plurality of data entity relationships relates one parent data entity to one child data entity;
wherein the first peer physical data model diagram is a first analog derived from the logical entity relationship diagram;
wherein the second peer physical data model diagram is a second analog derived from the logical entity relationship diagram;
wherein a first data entity of the plurality of data entities contains a first primary key;
wherein the first peer dataset connector representation of the first peer physical data model diagram and the first copy of the first peer dataset connector representation of the second peer physical data model diagram are analogs derived from the first data entity of the plurality of data entities contained in the logical entity relationship diagram; and
wherein the first unique key of the first peer dataset connector representation of the first peer physical data model diagram, and the first copy of the first unique key of the first copy of the first dataset connector representation of the second peer physical data model diagram, are analogs derived from the first primary key of the first data entity of the plurality of data entities contained in the logical entity relationship diagram.

22. The method of claim 19
wherein the plurality of physical data model diagrams contained in the first data architecture model includes a third physical data model diagram;
wherein a second copy of the first peer datasets connector representation is incorporated into the third physical data model diagram, converting the third physical data model diagram into a third peer physical data model diagram; wherein the second copy of the first peer dataset connector representation contains a second copy of the first unique key;
and further comprising:
modifying the first peer key constraint representation to join the first unique key of the first peer dataset connector representation, contained in the first peer physical data model diagram, with the first copy of the first unique key of the first copy of the first peer dataset connector representation, contained in the second peer physical data model diagram, and with the second copy of the first unique key of the second copy of the first peer dataset connector representation, contained in the third peer physical data model diagram;
wherein the third peer physical data model diagram is architected to contain a first peer data registry representation;
wherein the first peer data registry representation is architected for the first master data domain;
wherein the first peer data registry representation is architected as a first single source of data content records for the first peer dataset connector representation of the first peer physical data model diagram, and the first copy of the first peer dataset connector representation of the second peer physical data model diagram;
wherein the first peer data registry representation is architected to enforce peer dataset content commonality among the first peer dataset connector representation of the first peer physical data model diagram, the first copy of the first peer dataset connector representation of the second peer physical data model diagram, and the second copy of the first peer dataset connector representation of the third peer physical data model diagram;
wherein the first peer dataset connector representation of the first peer physical data model diagram is architected to contain a first subset of the first single source of data content records; and
wherein the first copy of the first peer dataset connector representation of the second peer physical data model diagram is architected to contain a second subset of the first single source of data content records.

23. The method of claim 22
wherein the plurality of data table representations of the third peer physical data model diagram contains a plurality of non-identifying data table columns for the first master data domain;
wherein the third peer physical data model diagram is an independent peer physical data model diagram architected for the first master data domain;
wherein the first peer physical data model diagram is dependent on the third peer physical data model diagram, by the first peer physical data model diagram being architected to share non-identifying data table columns, from the plurality of non-identifying data table columns, for the first master data domain, wherein the shared non-identifying data table columns are only architected to be contained in the third peer physical data model diagram, and are not permitted to be contained in any other physical data model diagram of the plurality of physical data model diagrams;
wherein the second peer physical data model diagram is dependent on the third peer physical data model diagram, by the second peer physical data model diagram being architected to share non-identifying data table columns from the plurality of non-identifying data table columns for the first master data domain, wherein the shared non-identifying data table columns are only architected to be contained in the third peer physical data model diagram, and are not permitted to be contained in any other physical data model diagram of the plurality of physical data model diagrams;
wherein the first peer physical data model diagram and the third peer physical data model diagram are architected to form a first complete dataset, which is a combination of a dependent dataset architected in the first peer physical data model diagram and an independent dataset architected in the third peer physical data model diagram;
wherein the second peer physical data model diagram and the third peer physical data model diagram are architected to form a second complete dataset, which is a combination of a dependent peer dataset architected in the second peer physical data model diagram and the independent peer dataset architected in the third peer physical data model diagram;
wherein the first peer key constraint representation is architected to form a first peer dataset access path, from the first peer key constraint representation, between the dependent peer dataset architected in the first peer physical data model diagram, and the independent peer dataset architected in the third peer physical data model diagram;
wherein the first peer key constraint representation is architected to form a second peer dataset access path, from the first peer key constraint representation, between the dependent peer dataset architected in the second peer physical data model diagram, and the independent peer dataset architected in the third peer physical data model diagram; and
wherein the first peer key constraint representation is architected to form a third peer dataset access path from the first peer key constraint representation between the dependent peer dataset architected in the first peer physical data model diagram, and the dependent peer dataset architected in the second peer physical data model diagram.

24. The method of claim 23
wherein the first plurality of master data domains of the first peer physical data model diagram includes a second master data domain;
wherein the second plurality of master data domains of the second peer physical data model diagram includes the second master data domain;
and wherein the data architecture modeling program includes adding a second peer dataset connector representation to the first data architecture model by:
architecting a second peer dataset connector representation for the second master data domain, wherein the second peer dataset connector representation is reusable in multiple physical data model diagrams of the plurality of physical data model diagrams, wherein the second peer dataset connector representation contains a first and a second unique key;
wherein the first unique key of the second peer dataset connector representation uniquely identifies data instances of the second master data domain;
wherein the second unique key of the second peer dataset connector representation also uniquely identifies data instances of the second master data domain;
incorporating the second peer dataset connector representation with the first unique key and the second unique key into the first peer physical data model diagram;
incorporating a first copy of the second peer dataset connector representation with a first copy of a first unique key and a first copy of the second unique key into the second peer physical data model diagram; and
adding a second peer key constraint representation to join the first unique key and the second unique key of the second peer dataset connector representation, contained in the first peer physical data model diagram, with the first copy of the first unique key and the first copy of the second unique key of the first copy of the second peer dataset connector representation, contained in the second peer physical data model diagram.

25. The method of claim 24
wherein the plurality of physical data model diagrams contained in the first data architecture model includes a fourth physical data model diagram;
wherein the data architecture modeling program includes converting the fourth physical data model diagram into a fourth peer physical data model diagram by:
incorporating a second copy of the second peer dataset connector representation into the fourth peer physical data model diagram, wherein the second copy of the second peer dataset connector representation contains a second copy of the first unique key and a second copy of the second unique key;
and further comprising:
modifying the second peer key constraint representation to join the first unique key and the second unique key of the second peer dataset connector representation, contained in the first peer physical data model diagram, with the first copy of the first unique key and the first copy of the second unique key of the first copy of the second peer dataset connector representation, contained in the second peer physical data model diagram, and with the second copy of the first unique key and the second copy of the second unique key of the second copy of the second peer dataset connector representation, contained in the fourth peer physical data model diagram;
wherein the fourth peer physical data model diagram is architected to contain a second peer data registry representation;
wherein the second peer data registry representation is architected for the second master data domain;
wherein the second peer data registry representation is architected as a second single source of data content records for the second peer dataset connector representation of the first peer physical data model diagram, and the first copy of the second peer dataset connector representation of the second peer physical data model diagram;
wherein the second peer data registry representation is architected to enforce peer dataset content commonality among the second peer dataset connector representation, of the first peer physical data model diagram, the first copy of the second peer dataset connector representation, of the second peer physical data model diagram, and the second copy of the second peer dataset connector representation, of the fourth peer physical data model diagram;
wherein the second peer dataset connector representation of the first peer physical data model diagram is architected to contain a first subset of the second single source of data content records; and
wherein the first copy of the second peer dataset connector representation of the second peer physical data model diagram is architected to contain a second subset of the second single source of data content records.

26. The method of claim 25
wherein the plurality of data table representations of the fourth peer physical data model diagram contains a plurality of non-identifying data table columns for the second master data domain;
wherein the fourth peer physical data model diagram is an independent peer physical data model diagram architected for the second master data domain;
wherein the first peer physical data model diagram is dependent on the fourth peer physical data model diagram, by the first peer physical data model diagram sharing non-identifying data table columns from the plurality of non-identifying data table columns for the second master data domain, where the shared non-identifying data table columns are only architected to be contained in the fourth peer physical data model diagram;
wherein the second peer physical data model diagram is dependent on the fourth peer physical data model diagram, by the second peer physical data model diagram sharing non-identifying data table columns from the plurality of non-identifying data table columns for the second master data domain, where the shared non-identifying data table columns are only architected to be contained in the fourth peer physical data model diagram;
wherein the data architecture modeling program updates the first complete dataset to include the first peer physical data model diagram, the third peer physical data model diagram, and the fourth peer physical data model diagram, which is a combination of the dependent dataset architected in the first peer physical data model diagram, the independent dataset architected in the third peer physical data model diagram, and an independent dataset architected in the fourth peer physical data model diagram;
wherein the data architecture modeling program updates the second complete dataset to include the second peer physical data model diagram, the third peer physical data model diagram, and the fourth peer physical data model diagram, which is a combination of the dependent peer dataset architected in the second peer physical data model diagram, the independent peer dataset architected in the third peer physical data model diagram, and the independent peer dataset architected in the fourth peer physical data model diagram;
wherein the second peer key constraint representation is architected to form a first peer dataset access path, from the second peer key constraint representation, between the dependent peer dataset architected in the first peer physical data model diagram, and the independent peer dataset architected in the fourth peer physical data model diagram;
wherein the second peer key constraint representation is architected to form a second peer dataset access path, from the second peer key constraint representation, between the dependent peer dataset architected in the second peer physical data model diagram, and the independent peer dataset architected in the fourth peer physical data model diagram; and
wherein the second peer key constraint representation is architected to form a third peer dataset access path from the second peer key constraint representation between the dependent peer dataset architected in the first peer physical data model diagram, and the dependent peer dataset architected in the second peer physical data model diagram.

27. The method of claim 26
wherein the first peer key constraint representation has a first peer key constraint rule, which is stored in a computer memory, and wherein the data architecture modeling program uses the first peer key constraint rule to constrain the first unique key of the first peer dataset connector representations and their copies contained in the first, second, and third peer physical data model diagrams; and
wherein the second peer key constraint representation has a second peer key constraint rule, which is stored in a computer memory, and wherein the data architecture modeling program uses the second peer constraint rule to constrain, as a couple, both the first unique key and the second unique key of the second peer dataset connector representations and their copies contained in the first, second, and fourth peer physical data model diagrams.

28. The method of claim 26
wherein the first peer physical data model diagram is associated with a first physical data environment specification architected for a first database schema;
wherein the second peer physical data model diagram is associated with a second physical data environment specification architected for a second database schema;
wherein the third physical data model diagram is associated with a third physical data environment specification architected for a third database schema; and
wherein the fourth physical data model diagram is associated with a fourth physical data environment specification architected for a fourth database schema.
